(19) United States
(12) Patent Application Publication
(10) Pub. No.: US 2026/0331601 A1
(43) Pub. Date: Oct. 22, 2026

(54) STABILIZED SOLID-STATE ELECTROLYTE

(71) Applicant: BOARD OF REGENTS, THE UNIVERSITY OF TEXAS SYSTEM, Austin, TX (US)

(72) Inventors: David MITLIN, Lago Vista, Texas, TX (US); Hongchang HAO, San Jose, CA (US)

(21) Appl. No.: 19/484,673

(22) PCT Filed: May 17, 2024
(86) PCT No.: PCT/US2024/029911

§ 371 Date: Nov. 14, 2025

Related U.S. Application Data
(60) Provisional application No. 63/502,835, filed on May 17, 2023.
(60) Provisional application No. 63/528,177, filed on Jul. 21, 2023.

(51) Int. Cl. H01M 10/42; H01M 10/0525; H01M 10/0562

(52) U.S. Cl. CPC H01M 10/4235; H01M 10/0525; H01M 10/0562; H01M 2300/008; H01M 2300/0094

(57) ABSTRACT

Disclosed herein is an electrochemical cell comprising an in situ formed intermetallic layer comprising the active metal of the electrodes and one or more metallic elements. The intermetallic layer of the disclosed electrochemical cell is disposed between an electrode and a solid-state electrolyte. Methods of making the same are also disclosed.

### CROSS-REFERENCE TO RELATED APPLICATION

This application claims the benefit of U.S. Provisional Applications 63/502,835, filed May 17, 2023, and 63/528,117, filed Jul. 21, 2023, the contents of each are hereby incorporated in their entirety.

### STATEMENT OF GOVERNMENT SUPPORT

This invention was made with government support under Grant no. DE-SC0023260 awarded by the Department of Energy. The government has certain rights in the invention.

### BACKGROUND

Rechargeable batteries are being widely employed in a broad range of applications ranging from portable electronics to electric vehicles. Lithium metal-based batteries (LMBs) employ a Li-metal anode coupled with a conventional high voltage ceramic cathode. The higher capacity of Li vs. graphite (3861 mAh g⁻¹ vs. 372 mAh g⁻¹) combined with high voltage cathodes results in an over 50% increase in the specific energy versus conventional ion-insertion anodes. All-solid-state batteries (ASSBs) are highly promising and regarded as the next-generation energy storage technology.^{[1]} Employing solid-state electrolytes (SSEs) is a path toward greater battery safety since most inorganic SEs are non-flammable or have much higher ignition temperatures than organic-based electrolytes. All-solid-state batteries can achieve the sought-after high energies when employing cathodes such as LiNi_{0.8}Mn_{0.1}Co_{0.1}O₂ (NMC811) and LiNi_{0.5}Mn_{1.5}O₄.^{[2]} Having the SSEs be as thin as practically possible maximizes the energy density of the cells by both reducing the total weight and achieving voltage window closer to the theoretical limit due to reduced impedance.^{[3]} Likewise, a thin metal anode is sought-after since it reduces the cell weight as well as the risk associated with accidental ignition of the metal. For most ASSB architectures, a relatively thick lithium (e.g., ~500 μm thickness) is employed with the capacity of the metal anode far exceeding the capacity of the cathode. Limiting the amount of lithium is essential to achieving ASSBs with the targeted energy density. However, interfacial side reaction, metal dendrites and voids appear significantly in parallel and can lead to catastrophic failure.

Inorganic solid-state electrolytes (SSEs) based on various sulfides possess room temperature ionic conductivity at or even above 10⁻³ S cm⁻¹, which is comparable to the values for conventional organic liquid electrolytes.^{[4]} Several types of inorganic SSEs with high ionic conductivity have been developed such as Li₆PS₅Cl (LPSCl), Li₁₀GeP₂S₁₂ (LGPS). Unfortunately, all sulfide-based SSEs suffer from poor interfacial compatibility with lithium metal anodes, which restricts their performance for ASSB applications.^{[5]} The interfacial incompatibility arises from the narrow electrochemical stability window of solid electrolytes. Sulfides are thermodynamically unstable when in contact with lithium metal anodes, undergoing reductive decomposition into equilibrium and/or metastable phases.^{[6]} This leads to progressively increasing internal battery resistance since the most decomposition products display poor ionic conductivity but sufficient electrically conducting to keep the reaction propagating.^{[7]} Some Li-SSE interfaces can self-passivate forming a ionically conducting interface (ICI) with not enough electrical conductivity to propagate further. However most metal-sulfide interfaces will continuously deteriorate due to the mixed ionic-electronic conductivity interface (MCI) that results.^{[8]} A parallel major challenge with all SSEs, including with sulfides, is the dendrite and associated pore growth of the Li metal during electrochemical cycling.^{[9]}

Argyrodite-type SSE (LPSCl, Li₆PS₅Cl) stands out due to its high ionic conductivity (>1 mS cm⁻¹ at 298 K), negligible grain boundary resistance, low-temperature processability, and low cost of raw materials.^{[10]} Researchers investigated the interfacial reactions associated with Li₆PS₅Cl, considering factors such as phase formation and the role of stress.^{[9b, 11]} As per the grand potential diagram, the Li₆PS₅Cl solid electrolyte starts to decompose at voltages below 1.7 V versus Li/Li⁺, the terminal reaction products containing Li₃P, Li₂S, as well as LiCl.^{[5c]} Wagemaker's work revealed that the reductive decomposition of Li₆PS₅Cl occurs at around 1.08 V versus Li/Li⁺, where phosphorous serve as the redox active element (P⁵⁺→P⁰-5e⁻).^{[11b]} It was proposed that the decomposition process occurs through an intermediate phase Li₁₁PS₅Cl, rather than directly to the terminal decomposition products. Canepa et al. simulated and investigated the resistance to Li-ion transport at interfaces of the Li metal anode and selected SSE decomposition products (Li₃P, Li₂S and LiCl).^{[12]} It was found that Li metal-Li₃P interface displays facile in-plane Li-ion transport diffusivity (D*) of around 3×10⁻⁶ cm²/s, while the interfaces of Li metal with Li₂S and LiCl are resistive to Li-ion transport (4.86×10⁻⁸ to 1.89×10⁻⁷ cm²/s). Bruce et al. reported the voids would form at the Li—Li₆PS₅Cl interface when Li was stripped faster than it was replenished, and that void filling occurred by creep.^{[13]} These combined effects give the Li metal-Li₆PS₅Cl interface with a highly heterogeneous structure and morphology, promoting dendrite growth in the process.

Several approaches have been employed to stabilize the Li metal-argyrodite SSE interphase.^{[14]} Employing alloy anode can reduce interfacial incompatibility due to a number of factors including enhanced Li diffusivity, improved metal wetting, and incrementally higher voltage that reduces the driving force for reductive decomposition. Examples of such an approach include Li—In,^{[9b, 15]} Li—Sn,^{[15]} Li—Ag,^{[14h]} Li—Zn,^{[16]} and Li—Al alloys^{[17]}. Despite their advantages, it is recognized that alloy anodes reduce the overall cell energy owing to a narrower voltage window and undergo relatively large volumetric changes at every charge/discharge cycle. Approaches based on selective doping of the SSE to promote kinetic (rather than thermodynamic) stability have also been demonstrated. Example modified electrolytes with enhanced stability over their baselines include Li_{6.25}PS_{4.75}N_{0.25}Cl,^{[14i]} Li₆PS_{4.75}ClO_{0.25},^{[18]} Li_{6.3}P_{0.9}Cu_{0.1}S_{4.9}Cl_{1.1,}^{[19]} Li_{6.04}P_{0.98}Bi_{0.02}S_{4.97}O_{0.03}Cl,^{[20]} Li_{5.5}PS_{4.5}Cl_{1.5,}^{[21]} LPSCl_{0.3}F_{0.7},^{[14d]} and Li_{5.6}P_{0.8}Si_{0.8}S_{4.4}Cl_{1.6}^{[22]}. A key design approach for enhanced kinetic stability is that the doping ions will react with the Li anode to form self-limiting interphase layers such as LiCl, Li₃N and LiF. The presence of halide-based decomposition products such as LiCl that kinetically stabilizes the interface.^{[2b, 11b, 11d, 23]} For example, substantially improved ASSB performance has been achieved with “sandwich” structures such as LPSCl/LGPS/LPSC.^{[2b]}

Solving the problem with solid-state batteries, cracking and dendrites would open up vast opportunities in wide-scale commercialization.

### SUMMARY

The exemplary system and method are disclosed to stabilize the electrode—solid-state electrolyte (SSE) interface through the incorporation of a thin intermetallic interlayer containing the active metal ion. This interlayer is formed in-situ when it contacts the anode, the cathode or the SSE, incorporating some of their constituent elements into its structure.

In some aspects, the techniques described herein relate to an electrochemical cell including: a first electrode including one or more monovalent and/or multivalent metal ion; a solid-state electrolyte including the one or more monovalent and/or multivalent metal ion; and an intermetallic layer disposed between the first electrode and the solid-state electrolyte, wherein the intermetallic layer includes the one or more monovalent and/or multivalent metal ion and one or more metallic elements.

In some aspects, the techniques described herein relate to a method of making an electrochemical cell, the method including: (a) providing an intermetallic complex disposed on a first substrate including a monovalent and/or multivalent metal ion, wherein the intermetallic complex includes the one or more monovalent and/or multivalent metal ion of the first substrate; and (b) disposing a second substrate onto the intermetallic complex disposed on the first substrate.

### BRIEF DESCRIPTION OF THE DRAWINGS

The skilled person in the art will understand that the drawings described below are for illustration purposes only.

FIG. 1 shows as-fabricated Li₂Te@Li anode synthesis and microstructure. Schematic illustration of the Li₂Te@Li fabrication process.

FIGS. 2A-2C show TEM and associated SAED pattern of a tellurene flake that was fabricated by hydrothermal synthesis.

FIG. 3 shows AFM imaging and spectrum of an as-fabricated tellurene flake.

FIG. 4 shows an indexed XRD pattern of an as-fabricated tellurene.

FIG. 5 shows an XPS spectrum of the as-prepared tellurene nanosheets.

FIGS. 6A-6B show indexed Raman spectra of the as-prepared tellurene and Li₂Te@Li.

FIGS. 7A-7B show an indexed XRD structure of as-fabricated Li₂Te@Li (FIG. 7A); and a high-resolution Te 3d XPS spectra of Li₂Te@Li (FIG. 7B).

FIGS. 8A-8C show a top-down SEM view of the surface morphology of Li₂Te@Li (FIG. 8A); cross sectional cryo-FIB SEM images and associated EDXS map of Te (FIG. 8B); (the view displays both the Li₂Te coating and the underlying sectioned Li metal), and cross sectional cryo-FIB SEM images and associated EDXS map of Te (FIG. 8C) (the view displays both the Li₂Te coating and the underlying sectioned Li metal).

FIGS. 9A-9B show normalized TOF-SIMS depth profiles mapping the Li₂Te—LiTe₃ bilayer on the Li surface and indicating that it is approximately 0.75 μm thick (FIG. 9A) and a 3D reconstruction of the sputtered volume (FIG. 9B).

FIG. 10 shows TOF-SIMS depth profiles of LiTe₃⁻, LiTe⁻, and Li₂⁻.

FIGS. 11A-11B show an indexed XRD pattern of the Li₆PS₅Cl employed in this work (FIG. 11A) and a Nyquist plot of Li₆PS₅Cl pellet for ionic conduction calculation (FIG. 11B). The Li ionic conductivity was calculated based on the equation σ=L/RS, where L is the thickness of the pressed pellet, S is the area of the surface and R is the resistance.

FIGS. 12A-12D show galvanostatic profiles of symmetric cells based on Li₂Te@Li (blue) and baseline Li (red) at 1 mA cm⁻² with capacity of 3 mAh cm⁻² (FIG. 12A), galvanostatic profiles of symmetric cells based on Li₂Te@Li (blue) and baseline Li (red) at 1.5 mA cm⁻² with capacity of 3 mAh cm⁻² (FIG. 12B), galvanostatic profiles at 0.5 mA cm⁻² with capacities of 1 mAh cm⁻² per cycle (FIG. 12C), and galvanostatic profiles at 0.5 mA cm-2 with capacities of 3 mAh cm⁻² per cycle (FIG. 12D).

FIG. 13 shows galvanostatic profiles of symmetric cells based on Li₂Te@Li (blue) and baseline Li (Red) at 0.5 mA cm-2 and 0.5 mAh cm-2 under a low stack pressure of 7 MPa.

FIGS. 14A-14B show EIS spectra of symmetric cells of Li₂Te@Li (FIG. 14A) and baseline Li before cycling and after 30 cycles at 0.5 mA cm⁻², 0.5 mAh cm⁻² (FIG. 14B).

FIGS. 15A-15E show voltage profiles of a half-cell based on Li₂Te@LPSCl (blue) and baseline LPSCl (Red) at 0.5 mA cm⁻² to 3 mAh cm⁻² (FIG. 15A), Voltage profile of Li₂Te@LPSCl half-cell at cycle 1 (FIG. 15B), Te 3d XPS spectrum of the post-cycle Li₂Te@LPSCl electrolyte pellet (FIG. 15C), galvanostatic plating profiles of halt-cells based on Li₂Te@LPSCl, tested at 0.5 mA cm⁻² (FIG. 15D), and galvanostatic plating profiles of halt-cells based on baseline LPSCl, tested at 0.5 mA cm⁻² (FIG. 15E).

FIGS. 16A-16B show galvanostatic profiles of half-cells based on Li₂Te@LPSCl and baseline LPSCl, tested at 0.5 mA cm-2 to capacity of 0.5 mAh cm⁻² per cycle.

FIGS. 17A-17C shows galvanostatic profiles of Li₂Te@Li-NMC full cells at different C-rates (1 C=1.4 mA cm⁻²) (FIG. 17A), galvanostatic profiles of baseline Li-NMC full cells at different C-rates (1 C=1.4 mA cm⁻²) (FIG. 17B), and rate performance comparison of galvanostatic profiles of Li₂Te@Li-NMC and baseline Li-NMC full cells at different C-rates (1 C=1.4 mA cm⁻²) (FIG. 17C).

FIGS. 18A-18C show galvanostatic profiles of Li₂Te@Li-NMC at different cycle numbers, tested at 0.5 C after an initial activation at 0.1 C for 3 cycles (FIG. 18A), galvanostatic profiles of baseline Li-NMC at different cycle numbers, tested at 0.5 C after an initial activation at 0.1 C for 3 cycles (FIG. 18B), and cyclability comparison of galvanostatic profiles of Li₂Te@Li-NMC and baseline Li-NMC at 0.5 C (FIG. 18C).

FIGS. 19A-19D show EIS spectra and corresponding equivalent circuits of the Li₂Te@Li-NMC full at the 1st charged and the 30th charged states (at 0.2 C) (FIGS. 19A and 19C), and EIS spectra and corresponding equivalent circuits of the Li-NMC full at the 1st charged and the 30th charged states (at 0.2 C) (FIGS. 19B and 19D).

FIGS. 20A-20F show high-resolution S 2p and P 2p XPS spectra of the pristine LPSCl SSE (FIGS. 20A and 20B); high-resolution S 2p and P 2p XPS spectra of the post-cycled Li₂Te@LPSCl SSE (FIGS. 20C and 20D); and analysis for the baseline LPSCl SSE. Baseline LPSCl and Li₂Te@LPSCl pellets were both prepared by having the corresponding Li—Cu half-cells cycled for 2 platting-stripping cycles at 0.5 mA cm⁻² and 1.5 mAh cm⁻² (FIGS. 20E and 20F).

FIGS. 21A-21C show a schematic representation of in-situ XPS test performed by employing electron beam irradiation (FIG. 21A), high-resolution Li 1s XPS spectra of the baseline LPSCl SSE under electron beam irradiation (FIG. 21B) and of Li₂Te@LPSCl (FIG. 21A).

FIGS. 22A-22D show high-resolution S 2p and P 2p XPS spectra of the baseline LPSCl SSE under in-situ XPS test performed by employing electron beam irradiation (FIGS. 22A and 22B), and XPS spectra of Li₂Te@LPSCl (FIGS. 22C and 22D).

FIGS. 23A-23B show overall and selected (375-475 cm⁻¹) Raman spectrum of the as-fabricated LPSCl pellet.

FIGS. 24A-24D show a cross sectional Raman imaging of the Li-LPSCl interface. FIG. 24A shows an optical microscopic image of the interface; the green box frames the Raman scanning area, FIG. 24B shows a centroid spectrum of each cluster within the Raman mapping; FIG. 24C shows a single peak intensity Raman mapping of 427 cm⁻¹ peak (peak A) ascribed to the P—S tetrahedra stretching of LPSCl, and FIG. 24D shows a 418 cm⁻¹ peak (peak B) ascribed to the P—S tetrahedra stretching of the reduced products (such as Li₃PS₄). The color bar scale shows the single peak intensity for each mapping.

FIGS. 25A-25D show a cross sectional Raman imaging of the Li₂Te@Li-LPSCl interface, FIG. 25A shows an optical microscopic image of the Li₂Te@Li-LPSCl Interface, FIGS. 25B and 25C show a centroid spectrum of each cluster within the Raman mapping, and FIG. 25D shows a single peak intensity Raman mapping of 427 cm⁻¹ peak ascribed to the P—S tetrahedra stretching of LPSCl.

FIG. 26 shows cross sectional Raman imaging of the Li-LPSCl interphase, with structural relative distribution indicated by the similarity loading graph for each cluster. The color bar scales with the inverse of the distance between each pixel and the centroid spectrum of the given cluster in Euclidean space.

FIG. 27 shows selected Raman spectrum (375-475 cm⁻¹) from the as-fabricated LPSCl pellet surface after being in contact with Li foil for 30 days.

FIGS. 28A-28C show a top-down Raman imaging of the LPSCl pellet surface after being in contact with Li foil for 30 days. FIG. 28A shows an optical microscopic image of the Li-LPSCl interface. Green box frames the Raman scanning area, with x=28 μm and y=50 um (x is parallel to the interface and y is perpendicular to the interface), step size=1 μm. FIGS. 28B and 28C show a single peak intensity Raman mapping of 418 cm⁻¹ peak (FIG. 28B) and 427 cm⁻¹ peak (FIG. 28C). The color bar scale shows the single peak intensity for each mapping.

FIG. 29 shows cross sectional Raman imaging of the Li₂Te@Li-LPSCl interphase, with structural relative distribution indicated by the similarity loading graph for each cluster. The color bar scales with the inverse of the distance between each pixel and the centroid spectrum of the given cluster in Euclidean space.

FIGS. 30A-30B show a selected Raman spectrum (FIG. 30A shows a spectrum at 375-475 cm-1; FIG. 30B shows a spectrum at 75-175 cm-1) the as-fabricated LPSCl pellet surface after being in contact with Li₂Te@Li for 30 days.

FIGS. 31A-31C shows top-down Raman imaging of the LPSCl pellet surface after being in contact with Li₂Te@Li foil for 30 days. FIG. 31A shows an optical microscopic image of the Li₂Te@Li-LPSCl interface. Green box frames the Raman scanning area, with x=28 μm and y=50 um (x is parallel to the interface and y is perpendicular to the interface), step size=1 um. FIGS. 31B and 31C show a single peak intensity Raman mapping of 418 cm⁻¹ peak (FIG. 31B) and 427 cm⁻¹ peak (FIG. 31C). The color bar scales the single peak intensity for each mapping.

FIGS. 32A-32C shows a baseline Li-LPSCl, cryo-FIB cross-sections after two cycles at 0.5 mA cm⁻², 0.5 mAh cm⁻² (FIG. 32A). FIGS. 32B and 32C show a baseline Li-LPSCl cross-sections and EDXS maps after 50 cycles at 0.5 mA cm⁻², 0.5 mAh cm-2.

FIGS. 33A-33C show a baseline Li₂Te@Li-LPSCl, cryo-FIB cross-sections after two cycles at 0.5 mA cm⁻², 0.5 mAh cm⁻² (FIG. 33A). FIGS. 33B and 33C show a baseline Li₂Te@Li-LPSCl cross-sections and EDXS maps after 50 cycles at 0.5 mA cm⁻², 0.5 mAh cm-2.

FIGS. 34A-34B shows a calculated reaction energy at different interfaces (FIG. 34A); and the PBE and HSE06 bandgaps for Li₂Te and Li₃P (FIG. 34B).

FIG. 35 shows the Li-LPSCl interfacial structures and corresponding interfacial energy (E_{interface}).

FIGS. 36A-36C show a schematic illustration of the Li-LPSCl interface depicting the SEI heterogeneity (FIG. 36A), a model setup to study the effect of SEI heterogeneity on the reaction distribution at the Li-LPSCl interface (FIG. 36B), and a reaction distribution for varying ionic conductivity ratios, θ=κ₁/κ₂, at an applied current density of 1.4 mA/cm² (FIG. 36C).

FIGS. 37A-37C shows an effect of current density and SEI heterogeneity on the reaction profile (described as the ratio of maximum and minimum reaction at the interface) (FIG. 37A), a schematic of the computational domain for evaluating stress distribution at the Li-LPSCl interface (FIG. 37B), and a normal stress along the x-direction for an applied pressure of 14 MPa (FIG. 37C).

FIGS. 38A-38C shows stress profile along the y-direction (σ_{yy}) (FIG. 38A) and shear direction (τ_{xy}) (FIG. 38B) for the morphology shown in (FIG. 36A). The corresponding hydrostatic stress (σ_{hyd}) profile is shown in FIG. 38C.

FIGS. 39A-39G show a schematic illustration for the fabrication process of Mg (top) and W (bottom) coated Cu foil (FIG. 39A), termed Mg/W—Cu; a cross-sectional FIB-SEM image (FIG. 39B); TOF-SIMS depth profile and 3D rendering of Mg₂⁺, W⁺, and Cu₂⁺ fragments (FIGS. 39C and 39D); XRD profile (FIG. 39E), and high-resolution Mg 1s (FIG. 38F) and W 4f (FIG. 39G) spectra of Mg/W—Cu.

FIGS. 40A-40B show top-down SEM images of Mg/W—Cu (FIGS. 40A and 40B).

FIGS. 41A-41F show top-down SEM images of Mg—Cu (FIGS. 41A and 41B) and W—Cu (FIGS. 41D and 41E); and FIB-SEM images with associated EDXS line scan of Mg—Cu (FIG. 41C) and W—Cu (FIG. 41F).

FIGS. 42A-42B show XRD profiles of Mg—Cu (FIG. 42A) and W—Cu (FIG. 42B).

FIGS. 43A-43D show high-resolution XPS spectra of Mg1 s (FIG. 43A) and Cu 2p (FIG. 43B) for Mg—Cu, and W 4f (FIG. 43C) and Cu 2p (FIG. 43D) for W—Cu.

FIGS. 44A-441 show electrochemical characterizations in asymmetric half cells using different current collectors, tested at 1 mA cm⁻² to a fixed electrodeposition capacity of 1 mAh cm⁻²; showing galvanostatic discharge profiles during 1^{st} cycle (FIG. 44A) and 2^{nd} cycle (FIG. 44B); coulombic efficiency (FIG. 44C); overall galvanostatic cycling performance with CE test (FIGS. 44D and 44E); representative galvanostatic profiles (FIGS. 44F-44H); and electrodissolution and electrodeposition overpotentials (FIG. 44I).

FIGS. 45A-45B show initial galvanostatic profiles of Li|SE|Cu and Li|SE|W-Cu cells (FIG. 45A), and Li|SE|Mg/W—Cu and Li|SE|Mg-Cu cells (FIG. 45B) tested between 0 and 1 V at 0.05 mA cm-2.

FIG. 46 shows cycling performance of Li|SE|Mg/W—Cu cell, tested at 1 mA cm⁻² to 1 mAh cm⁻² for 3 cycles followed by 2 mA cm⁻² to 1 mAh cm-2.

FIGS. 47A-47D shows EIS Nyquist plots of asymmetric cells employing Mg/W—Cu (FIG. 47A), Mg—Cu (FIG. 47B), W—Cu (FIG. 47C), and baseline Cu (FIG. 47D) for cycles 1-10, 15, 20, 25, and 30, tested at 1 mA cm⁻² to 1 mAh cm-2.

FIGS. 48A-48B show EIS Nyquist plots of asymmetric cells employing Mg/W—Cu (FIG. 48A) and Mg—Cu (FIG. 48B) at cycle 40 and onward, tested at 1 mA cm⁻² to 1 mAh cm-2.

FIG. 49 shows a summary of the impedance data in the first 30 cycles.

FIG. 50 shows a summary of the impedance data in the first 30 cycles.

FIGS. 51A-51L show cryo-FIB cross-sectional SEM and EDXS of Li|SE|Mg/W—Cu cell, tested at 1 mA cm⁻² for electrodeposition of 1 mAh cm⁻² (FIGS. 51A-51C), electrodeposition of 3 mAh cm⁻² (FIGS. 51D-51F), electrodeposition of 5 mAh cm⁻² (FIGS. 51G-51I), and electrodissolution to 0.2 V (FIGS. 51J-51L) cm⁻². The scale bar is 5 μm.

FIGS. 52A-52D show a cross-sectional EDXS line scan of Li|SE|Mg/W—Cu after electrodeposition of 3 mAh cm⁻² (FIG. 52A), electrodeposition of 5 mAh cm-2 (FIG. 52B), electrodeposition of 5 mAh cm⁻² (FIG. 52C), and electrodissolution to 0.2 V (FIG. 52D). The scale bar is 5 μm.

FIGS. 53A-53I show cryo-FIB cross-sectional SEM and EDXS of Li|SE|Mg-Cu cell, tested at 1 mA cm⁻² for electrodeposition of 1 mAh cm⁻² (FIGS. 53A-53C), electrodeposition of 3 mAh cm⁻² (FIGS. 53D-53F), and electrodissolution to 0.2 V (FIGS. 53G-53I). The scale bar is 5 μm.

FIGS. 54A-54C show a cross-sectional EDXS line scan of Li|SE|Mg-Cu after electrodeposition of 3 mAh cm⁻² (FIG. 54A), electrodeposition of 5 mAh cm-2 (FIG. 54B), and electrodissolution to 0.2 V (FIG. 54C). The scale bar is 5 μm.

FIG. 55 shows binding energies for multiple lithium atoms and lithium clusters on the relevant surfaces.

FIG. 56 shows reaction energy between LixMg and LPSCl SE, obtained from Interface Reactions by Materials Project.

FIGS. 57A-57L show cryo-FIB cross-sectional SEM and linear EDXS analysis of asymmetric cells at the fully electrodissolved state after cycling at 1 mA cm⁻² to 1 mAh cm⁻² for Li|SE|Mg/W—Cu cell after 200 cycles (FIGS. 57A-57C), Li|SE|Mg-Cu cell after 200 cycles (FIGS. 57D-57F), Li|SE|W-Cu cell after 30 cycles (FIGS. 57G-57I), and Li|SE|Cu cell after 30 cycles (FIGS. 57J-57L). The scale bar is 5 μm.

FIGS. 58A-58F show cryo-FIB cross-sectional SEM and linear EDXS analysis of Li|SE|Mg-Cu cells at different states after cycling at 1 mA cm⁻² to 1 mAh cm⁻² after 30 cycles (FIGS. 58A and 58B), after 300 cycles (FIGS. 58C and 58D), and after 300 cycles (FIGS. 58E and 58F). The scale bar is 5 μm.

FIGS. 59A-59F show digital photographs of baseline Cu contacting LPSCl SE for 1 day (FIGS. 59A and 59D), 4 days (FIGS. 59B and 59E), and 7 days (FIGS. 59C and 59F) at room temperature and at 60° C.

FIGS. 60A-60C show digital photographs of W—Cu contacting LPSCl SE for 1 day (FIG. 60A), 4 days (FIG. 60B), and 7 days (FIG. 60C) at 60° C.

FIGS. 61A-61F show top-down and cross-sectional SEM images of baseline Cu after contacting LPSCl SE for 1 day (FIGS. 61A and 61D), 4 days (FIGS. 61B and 61E), and 7 days (FIGS. 61C and 61F) at room temperature.

FIGS. 62A-62C show cross-sectional EDXS line scan of baseline Cu after contacting LPSCl SE for 1 day (FIG. 62A), 4 days (FIG. 62B), and 7 days (FIG. 62C) at room temperature.

FIGS. 63A-63F show top-down and cross-sectional SEM images of baseline Cu after contacting LPSCl SE for 1 day (FIGS. 63A and 63D), 4 days (FIGS. 63B and 63E), and 7 days (FIGS. 63C and 63F) at 60° C.

FIGS. 64A-64C show cross-sectional EDXS line scan of baseline Cu after contacting LPSCl SE for 1 day (FIG. 64A), 4 days (FIG. 64B), and 7 days (FIG. 64C) at 60° C.

FIGS. 65A-65E show top-down and cross-sectional SEM images of W—Cu after contacting LPSCl SE for 1 day (FIGS. 65A and 65D), 4 days (FIGS. 65B and 65E), and 7 days (FIGS. 65C and 65F) at 60° C.

FIGS. 66A-66B show cross-sectional EDXS line scan of W—Cu after contacting LPSCl SE for 4 days (FIG. 66A) and 7 days (FIG. 66B) at 60° C.

FIGS. 67A-67B show average thickness of corrosion layer of Cu after contacting LPSCl at 60° C. (FIG. 67A) and room temperature (FIG. 67B).

FIGS. 68A-68D show current-time profiles of Mg/W-Cu|SE|Mg/W—Cu, Mg-Cu|SE|Mg—Cu, W—Cu|SE|W-Cu, and Cu|SE|Cu cells holding at a constant voltage of 4.2 V for 100 hours (FIG. 68A), 10 hours (FIG. 68B), 50 hours (FIG. 68C), and 90 hours (FIG. 68D).

FIGS. 69A-69C shows S 2p (FIG. 69A) and Li 1s (FIG. 69B) XPS spectra of Mg—Cu, W—Cu, and baseline Cu cells after resting for 48 hours; and S2p spectra (FIG. 69C) of Mg—Cu, W—Cu, and baseline Cu cells after 1^{st} cycle at 1 mA cm⁻² to 1 mAh cm-2.

FIGS. 70A-70D shows cycling performance of NMC full cells (FIG. 70A), tested at 0.33 C after initial 3 cycles at 0.1 C; galvanostatic profiles at 1^{st} cycle at 0.1 C (FIG. 70B); rate capability of Mg/W-Cu|SE|NMC cell (FIG. 70C); and cycling performance of Mg/W-Cu|SE|NMC cell with high NMC mass-loading at 0.2 C (FIG. 70D).

FIGS. 71A-71D shows galvanostatic profiles of anode-free full cells during cycling for Mg/W-Cu|SE|NMC cell (FIG. 71A), Mg-Cu|SE|NMC cell (FIG. 71B), W-Cu|SE|NMC cell (FIG. 71C), and Cu|SE|NMC cell (FIG. 71D).

FIG. 72 shows rate capability of Mg/W-Cu|SE|NMC cell.

FIG. 73 shows cycling performance of Mg/W-Cu|SE|NMC cell at 0.5 C after initial 3 cycles at 0.1 C.

FIGS. 74A-74B shows XRD profile (FIG. 74A) and Nyquist plot (FIG. 74B) of the argyrodite Li₆PS₅Cl electrolyte after milling for 24 hours.

### DETAILED SPECIFICATION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “an element” includes two or more such elements, and a reference to “a battery” includes two or more such batteries and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as,” and grammatical equivalences thereof, the phrase “and without limitation” is understood to follow unless explicitly stated otherwise.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell,” refers to a reference composition, article, or an electrochemical cell comprising substantially identical components and wherein an inventive component is substituted with a common in the art component.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

An exemplary system and method to stabilize the electrode—solid-state electrolyte (SSE) interface through the incorporation of a thin intermetallic interlayer containing an active metal, which may be one or more monovalent and/or multivalent metal, is disclosed herein. The interlayer is formed when it contacts the anode, the cathode or the SSE, incorporating some of their constituent elements into its structure. The thin intermetallic layer allows active ion transport but prevents deleterious parasitic reactions between the anode and the SSE and between the cathode and the SSE. The intermetallic layer may be formed in situ or ex situ.

The intermetallic layer can have a single structure—composition or may be a multilayer consisting of several structures and compositions. Intermetallic compounds are defined as solid phases involving at least one metallic element atomically bonded to at least one other metallic element, semi-metallic element, or covalently bonded element, with an ordered structure and a defined stoichiometry. The intermetallic-based layer promotes chemical, electrochemical, and mechanical stability by bonding with the electrode and SSE materials and minimizing interfacial reactions between the electrode and SSE.

In one aspect, an electrochemical cell contains a first electrode of an active metal, an SSE containing the same active metal, and the intermetallic layer between the first electrode and the SSE. In some aspects, the active metal may be one or more monovalent and/or multivalent active metals and the SSE may contain the same one or more monovalent and/or multivalent active metals. In yet other aspects, the intermetallic layer is formed in situ or ex situ and comprises the active metal and one or more metallic elements. It is contemplated that the electrochemical cell may form a half-cell or a full cell battery.

In one embodiment, the intermetallic layer may be formed from an intermetallic precursor, the intermetallic precursor comprising one or more metallic elements. For example, the one or more metallic elements comprise chalcogens, chalcogenides, transition metals, semiconductors, halogens, cluster cations, cluster anions, polyatomic ions, hydrides, borohydrides, super-atomic cluster anions (SACA), cluster substituted sulfides, intermetallics, including BF₄, BH₄, F, Cl, Br, Te, Se, Bi, Sn, Sb, Pb, Al, or Ge, Ag, Cu₂Te, or a combinations thereof.

In one example, the one or more metallic elements may be monolithic Te, Se, Bi, Sn, Sb, Pb, Al, or Ge, or combinations thereof. For example, the intermetallic precursor may be a bimetallic precursor TeₓSe_{y}, TeₓBi_{y}, TeₓSn_{y}, TeₓPb_{y}, TeₓAl_{y}, TeₓGe_{y}, SeₓBi_{y}, SeₓSn_{y}, SeₓSb_{y}, SeₓPb_{y}, SeₓAl_{y}, SeₓGe_{y}, BiₓSn_{y}, BiₓSb_{y}, BiₓPb_{y}, BiₓAl_{y}, BiₓGe_{y}, SnₓSb_{y}, SnₓPb_{y}, SnₓAl_{y}, SnₓGe_{y}, SbₓPb_{y}, SbₓAl_{y}, SbₓGe_{y}, PbₓAl_{y}, PbₓGe_{y}, or AlₓGe_{y}, where x, y are relevant stoichiometric amounts that form stable crystalline structures. The intermetallic precursor may be a combination of three or metallic elements in relevant stoichiometric amounts that form stable crystalline structures.

In another example, the one or more metallic elements may be hydrides, such as MgH2, borohydrides such as LiBH4, super-atomic cluster anions (SACA) such as BH₄⁻¹, cluster substituted sulfides such as Li6PS5(BH4), Li6PS5(BF4), Li6PS5(CN). SACA anions may be chosen from the list in Table 1.

The intermetallic precursor may be formed by first disposing the one or more metallic elements onto the first electrode, the solid-state electrolyte, or a sacrificial substrate by mechanical pressing, rolling, spraying, slurry deposition, vacuum-based deposition such as PVD and CVD, or through a sacrificial templating.

The active metal may be a metal used in electrochemical cells, for example, the active metal may be one of Li, Na, K, Zn, Mg, Al, and Ca. The intermetallic layer may be a thermodynamically stable structure, a metastable structure, or a combination of equilibrium and metastable structures and compositions formed by the endothermic reaction of the intermetallic precursor and the active metal.

The intermetallic layer can have any desired thickness. In some aspects, the intermetallic layer can have a thickness of about 0.1 nm to about 500 nm. For example, the intermetallic layer thickness may be about 0.5 nm, about 5 nm, about 50 nm, about 100 nm, about 150 nm, about 200 nm, about 250 nm, about 300 nm, about 350 nm, about 400 nm, or about 450 nm.

TABLE 1
Stable gas-phase mono-anions.

| Mono-anion | Radius (A) | EA (eV) |
|---|---|---|
| Cl⁻ | 1.81 | 3.62 |
| Br⁻ | 1.96 | 3.36 |
| I⁻ | 2.20 | 3.06 |
| OH⁻ | 1.31 | 1.83 |
| CN⁻ | 1.40 | 4.10 |
| SCN⁻ | 3.08 | 3.50 |
| ClO₄⁻ | 2.90 | 5.36 |
| BH₄⁻ | 2.24 | 3.42 |
| BF₄⁻ | 2.75 | 7.33 |
| BCl₄⁻ | 3.69 | 5.01 |
| B₅H₅⁻ | 3.52 | 2.40 |
| B₆H₆⁻ | 3.44 | 3.03 |
| B₇H₇⁻ | 3.38 | 2.25 |
| B₈H₈⁻ | 3.50 | 3.15 |
| B₉H₉⁻ | 3.54 | 3.23 |
| B₁₀H₁₀⁻ | 4.05 | 3.68 |
| CB₄H₅⁻ | 3.35 | 2.90 |
| CB₅H₆⁻ | 3.40 | 3.74 |
| CB₆H₇⁻ | 3.35 | 3.73 |
| CB₇H₈⁻ | 3.45 | 3.44 |
| CB₈H₉⁻ | 3.56 | 3.67 |
| CB₉H₁₀⁻ | 3.90 | 4.45 |
| CB₁₁H₁₂⁻ | 3.75 | 5.37 |

In other embodiments, the electrochemical cell may contain the first electrode of an active metal, the SSE containing the same active metal, the intermetallic layer between the first electrode and the SSE, and further contain a second electrode. It is contemplated that the electrochemical cell of this embodiment forms a full cell. For example, an electrochemical cell, wherein the first electrode is an anode, and the second electrode is a cathode. Alternatively, the electrochemical cell, wherein the first electrode is a cathode, and the second electrode is an anode.

In the electrochemical cell, the anode may comprise Li, Na, K, Zn, Mg, Al, Ca, Li alloys, Li intermetallics, Li compounds, Na alloys, Na intermetallics, Na compounds, K alloys, K intermetallics, K compounds or any combination thereof.

In some aspects, the cathode may comprise copper, carbon, graphite, sodium, potassium, lithium, magnesium, calcium, aluminum, layered oxides, vanadium-based cathode, sulfur-based cathode, spinels, olivines, or any combination thereof.

In some aspects SSE may comprise at least one of sulfide compounds, LPSCLi, LPSB, LPSF, lithium thiophosphases, lithium thiosulfides, halides, garnet structure oxides, LISICON-type solids, NASICON- or KSICON-type phosphate glass ceramics, perovskite-type and anti-perovskite type compounds, nitrides, oxynitrides, argyrodite-type, or polymer-based electrolytes, or any combination thereof. In one unlimiting example, the SSE is an argyrodite-type electrolyte comprised of M₆PS₅Cl, wherein M is a metal.

In the above embodiment, the anode, the cathode, and the SSE contain the same active metal. The intermetallic layer of the embodied electrochemical cell is an intermetallic layer of the common active metal and the one or more elements forming the intermetallic precursor. For example, the intermetallic layer may have a composition of LiₓTe_{y}, LiₓSe_{y}, LiₓBi_{y}, LiₓSn_{y}, LiₓPb_{y}, LiₓAl_{y}, LiₓGe_{y}, NaₓTe_{y}, NaₓSe_{y}, NaₓBi_{y}, NaₓSn_{y}, NaₓPb_{y}, NaₓAl_{y}, NaₓGe_{y}, KₓTe_{y}, KₓSe_{y}, KₓBi_{y}, KₓSn_{y}, KₓPb_{y}, KₓAl_{y}, KₓGe_{y}, ZnₓTe_{y}, ZnₓSe_{y}, ZnₓBi_{y}, ZnₓSn_{y}, ZnₓPb_{y}, ZnₓAl_{y}, ZnₓGe_{y}, AlₓTe_{y}, AlₓSe_{y}, AlₓBi_{y}, AlₓSn_{y}, AlₓPb_{y}, AlₓGe_{y}, CaₓTe_{y}, CaₓSe_{y}, CaₓBi_{y}, CaₓSn_{y}, CaₓPb_{y}, CaₓAl_{y}, or CaₓGe_{y}, where x, y are relevant stoichiometric amounts.

The electrochemical cell of any of the above embodiments or examples may exhibit reversible capacity for about 2-5000 or more cycles at about 0.1-10 mA/cm². For example, the electrochemical cell may exhibit reversible capacity of about 100 cycles at about 0.5 mA/cm², about 100 cycles at about 5 mA/cm², about 500 cycles at about 0.5 mA/cm², about 500 cycles at about 5 mA/cm², about 1000 cycles at about 0.5 mA/cm², about 1000 cycles at about 5 mA/cm², about 2000 cycles at about 0.5 mA/cm², about 2000 cycles at about 5 mA/cm², about 3000 cycles at about 0.5 mA/cm², about 3000 cycles at about 5 mA/cm², about 4000 cycles at about 0.5 mA/cm², or about 4000 cycles at about 5 mA/cm².

The electrochemical cell of any of the above embodiments or examples may exhibit continuous plating of about 0.01-20 mAh/cm² at about 0.01-20 mA/cm². For example, the electrochemical cell may exhibit continuous plating of about 0.5 mAh/cm² at about 0.5 mA/cm², about 0.5 mAh/cm² at about 5 mA/cm², about 5 mAh/cm² at about 0.5 mA/cm², about 5 mAh/cm² at about 5 mA/cm², about 1.0 mAh/cm² at about 0.5 mA/cm², about 1.0 mAh/cm² at about 5 mA/cm², about 15 mAh/cm² at about 1.0 mA/cm², or about 15 mAh/cm² at about 15 mA/cm².

The electrochemical cell of any of the above embodiments or examples may exhibit coulombic efficiency of greater than about 70% to 100%, greater than about 75%, greater than about 80%, greater than about 85%, greater than about 90%, greater than about 95%, or greater than about 99%.

A method of making an electrochemical cell is described herein. The method may comprise forming an intermetallic complex by providing an intermetallic precursor onto a first substrate comprising an active metal, and then disposing a second substrate onto the intermetallic complex disposed on the first substrate. The reaction of the intermetallic precursor with the active metal of the first substrate is an endothermic reaction and pressure may be applied during deposition of the intermetallic precursor onto the first substrate. For example, the intermetallic precursor may be mechanically pressed, rolled, sprayed, slurry deposited, vacuum-based deposited such as PVD and CVD, or through a sacrificial templating.

In some aspects, the intermetallic layer is formed in situ on the first substrate by applying pressure to an intermetallic precursor disposed on the first substrate. The intermetallic precursor may comprise one or more metallic elements disposed on a separator. The separator may be a polypropylene separator, a nylon separator, a cellulose base separator, or any combination thereof. The method may further comprise removing the separator from the in situ formed intermetallic layer formed on the first substrate before disposing the intermetallic layer on the second substrate. In other aspects, the intermetallic layer is formed ex situ.

The intermetallic precursor used in the formation of an intermetallic complex may comprise one or more metallic elements. For example, the one or more metallic elements comprise chalcogens, chalcogenides, transition metals, semiconductors, halogens, cluster cations, cluster anions, polyatomic ions, hydrides, borohydrides, super-atomic cluster anions (SACA), cluster substituted sulfides, intermetallics, including BF₄, BH₄, F, Cl, Br, Te, Se, Bi, Sn, Sb, Pb, Al, or Ge, Ag, Cu₂Te, or a combinations thereof.

In one example, the one or more metallic elements may be monolithic Te, Se, Bi, Sn, Sb, Pb, Al, or Ge, or combinations thereof. For example, the intermetallic precursor may be a bimetallic precursor TeₓSe_{y}, TeₓBi_{y}, TeₓSn_{y}, TeₓPb_{y}, TeₓAl_{y}, TeₓGe_{y}, SeₓBi_{y}, SeₓSn_{y}, SeₓSb_{y}, SeₓPb_{y}, SeₓAl_{y}, SeₓGe_{y}, BiₓSn_{y}, BiₓSb_{y}, BiₓPb_{y}, BiₓAl_{y}, BiₓGe_{y}, SnₓSb_{y}, SnₓPb_{y}, SnₓAl_{y}, SnₓGe_{y}, SbₓPb_{y}, SbₓAl_{y}, SbₓGe_{y}, PbₓAl_{y}, PbₓGe_{y}, or AlₓGe_{y}, where x, y are relevant stoichiometric amounts that form stable crystalline structures. The intermetallic precursor may be a combination of three or metallic elements in relevant stoichiometric amounts that form stable crystalline structures.

In another example, the one or more metallic elements may be hydrides, such as MgH2, borohydrides such as LiBH4, super-atomic cluster anions (SACA) such as BH₄⁻¹, cluster substituted sulfides such as Li6PS5(BH4), Li6PS5(BF4), Li6PS5(CN). SACA anions may be chosen from the list in Table 1.

The intermetallic precursor may be prepared by disposing about 0.0001 mg/cm² to about 1000 mg/cm² of the one or more metallic elements on the separator. In other examples, about 0.0001 mg/cm² to about 100 mg/cm² of one or more metallic elements may be disposed on the separator; about 0.0001 mg/cm² to about 1 mg/cm²; about 0.0001 mg/cm² to about 0.1 mg/cm²; about 0.0001 mg/cm² to about 0.01 mg/cm²; about 0.0001 mg/cm² to about 0.001 mg/cm²; about 0.001 mg/cm² to about 10 mg/cm²; about 0.001 mg/cm² to about 1 mg/cm²; about 0.001 mg/cm² to about 0.1 mg/cm²; about 0.001 mg/cm² to about 0.01 mg/cm²; about 0.01 mg/cm² to about 10 mg/cm²; 0.01 mg/cm² to about 1 mg/cm²; about 0.01 mg/cm² to about 0.1 mg/cm²; 0.1 mg/cm² to about 10 mg/cm²; about 0.1 mg/cm² to about 1 mg/cm²; or about 1 mg/cm² to about 10 mg/cm². In certain aspects, the one or more metallic elements may be loaded on the separate at about 0.005 mg/cm², about 0.05 mg/cm², about 0.5 mg/cm², about 5 mg/cm², about 50 mg/cm², or about 500 mg/cm².

In certain aspects, the intermetallic precursor may comprise a layer of one or more metallic elements on the separator, the layer having a thickness of about 0.1 nm to about 500 nm. For example, the layer thickness may be about 0.5 nm, about 5 nm, about 50 nm, about 100 nm, about 150 nm, about 200 nm, about 250 nm, about 300 nm, about 350 nm, about 400 nm, or about 450 nm. In other examples, the intermetallic precursor comprises a monolayer of the one or more metallic elements.

In certain aspects, the one or more metallic elements may be disposed on a separator, which is then applied to the first substrate for deposition of the intermetallic precursor. In some aspects, after the intermetallic complex is formed, the separator may be removed from the first substrate/intermetallic complex.

In some aspects, the method may include steps of disposing a third substrate onto the first substrate. Also disclosed are aspects, wherein alternatively, the third substrate may be disposed onto the second substrate.

The substrates may be disposed using any number of known methods. For example, disposing may include mechanical pressing, rolling, spraying, slurry deposition, vacuum-based deposition such as PVD and CVD, through a sacrificial templating, or any combination thereof.

In the disclosed method, the active metal may be a metal used in electrochemical cells, for example, the active metal may be one of Li, Na, K, Zn, Mg, Al, and Ca. The first substrate may be an anode, a cathode, or SSE. The second substrate may be an anode, a cathode, or SSE. The third substrate may be an anode, a cathode, or SSE.

It is contemplated that the electrochemical cell of this embodiment forms a half cell. In one example, the first substrate used in the method may be an SSE, the second substrate may be a cathode. In another example, the first substrate may be an SSE, the second substrate may be an anode. In another example, the first substrate may be an anode, the second substrate may be an SSE. In yet another example, the first substrate may be a cathode, the second substrate may be an SSE.

It is contemplated that the electrochemical cell of this embodiment forms a full cell. In one example, the first substrate used in the method may be an SSE, the second substrate may be a cathode, and the third may be an anode. In another example, the first substrate may be an SSE, the second substrate may be an anode, and the third may be a cathode. In another example, the first substrate may be an anode, the second substrate may be an SSE, and the third may be a cathode. In yet another example, the first substrate may be a cathode, the second substrate may be an SSE, and the third may be an anode.

In the disclosed method, the first substrate, second substrate comprise the same active metal, and the intermetallic layer between the first substrate and the second substrate. In some embodiments, a third substrate may be disposed on the second or first substrate and comprises the same active metal as the first and second substrate.

In some aspects, the anode used in the method may comprise Li, Na, K, Zn, Mg, Al, Ca, Li alloys, Li intermetallics, Li compounds, Na alloys, Na intermetallics, Na compounds, K alloys, K intermetallics, K compounds or any combination thereof.

The cathode may be a metal cathode, a ceramic cathode, or a composite cathode. The cathode may comprise copper, carbon, graphite, sodium, potassium, lithium, magnesium, calcium, aluminum, layered oxides, vanadium-based cathode, sulfur-based cathode, spinels, olivines, or any combination thereof.

The SSE may comprise at least one of sulfide compounds, LPSCLi, LPSB, LPSF, lithium thiophosphases, lithium thiosulfides, halides, garnet structure oxides, LISICON-type solids, NASICON- or KSICON-type phosphate glass ceramics, perovskite-type and anti-perovskite type compounds, nitrides, oxynitrides, argyrodite-type, or polymer-based electrolytes, or any combination thereof. In one example, the SSE is an argyrodite-type electrolyte comprised of M₆PS₅Cl, wherein M is a metal.

In the above embodiments, the anode, the cathode, and the SSE contain the same active metal. The intermetallic layer of the embodied electrochemical cell is an intermetallic layer of the common active metal and the one or more elements forming the intermetallic precursor. For example, the intermetallic layer may have a composition of LiₓTe_{y}, LiₓSe_{y}, LiₓBi_{y}, LiₓSn_{y}, LiₓPb_{y}, LiₓAl_{y}, LiₓGe_{y}, NaₓTe_{y}, NaₓSe_{y}, NaₓBi_{y}, NaₓSn_{y}, NaₓPb_{y}, NaₓAl_{y}, NaₓGe_{y}, KₓTe_{y}, KₓSe_{y}, KₓBi_{y}, KₓSn_{y}, KₓPb_{y}, KₓAl_{y}, KₓGe_{y}, ZnₓTe_{y}, ZnₓSe_{y}, ZnₓBi_{y}, ZnₓSn_{y}, ZnₓPb_{y}, ZnₓAl_{y}, ZnₓGe_{y}, AlₓTe_{y}, AlₓSe_{y}, AlₓBi_{y}, AlₓSn_{y}, AlₓPb_{y}, AlₓGe_{y}, CaₓTe_{y}, CaₓSe_{y}, CaₓBi_{y}, CaₓSn_{y}, CaₓPb_{y}, CaₓAl_{y}, or CaₓGe_{y}, where x, y are relevant stoichiometric amounts.

In other embodiments, the electrochemical cell may contain a first substrate, the SSE including an active metal, and an intermetallic bilayer between the first substrate and the SSE. The first substrate may be a current collector and include a conductive metal; thus, forming an anode-less half cell. The electrochemical cell may contain a second substrate, the second substrate being a cathode; thus, forming an anode-less full cell.

The intermetallic bilayer comprises a first metallic layer and a second metallic layer, wherein the first metallic layer is adjacent to the first substrate and the second metallic layer is adjacent to the SSE. In the context of the intermetallic bilayer, the first metallic layer prevents the current collector from corroding and the second metallic layer reversibly alloys with the active material, subsequently increasing wettability at the surface of the first substrate.

In some aspects, the first metallic layer includes tungsten.

In some aspects, the second metallic layer includes magnesium, gold, silver, aluminum, platinum, zinc, tin, copper, nickel, titanium, or a combination thereof. In certain implementations the second metallic layer is magnesium, aluminum, or zinc. In some implementations the second metallic layer is magnesium.

In the electrochemical cell, the current collector may include any conductive metal. In some aspects, the conductive metal is copper, silver, gold, iron, steel, including stainless steel, platinum, lithium, aluminum, or a combination thereof. In some implementations, the conductive metal is copper, aluminum, or stainless steel.

In some implementations, the first substrate includes copper, the intermetallic bilayer includes a first metallic layer of tungsten and a second metallic layer of magnesium, and a sulfur-containing SSE, wherein the first metallic layer is adjacent to the first substrate and the second metallic layer is adjacent to the SSE.

In some implementations, the first metallic layer is provided at a thickness from 1-500 nm, from 1-250 nm, from 1-100 nm, form 1-75 nm, from 1-50 nm, from 1-25 nm, from 1-10 nm, from 5-25 nm, from 10-50 nm, or from 50-100 nm. In some implementations the first metallic layer in the intermetallic bilayer includes tungsten at a thickness from 1-500 nm, from 1-250 nm, from 1-100 nm, form 1-75 nm, from 1-50 nm, from 1-25 nm, from 1-10 nm, from 5-25 nm, from 10-50 nm, or from 50-100 nm.

In some implementations, the second metallic layer has a thickness from 1-1,000 nm, from 1-100 nm, from 100-1,000 nm, from 500-1,000 nm, from 100-500 nm, from 100-250 nm, from 250-500 nm, from 50-150 nm, from 200-300 nm, or from 150-300 nm. In some implementations, the second metallic layer in the intermetallic bilayer includes magnesium, aluminum, or zinc, and is provided at a thickness from 1-1,000 nm, from 1-100 nm, from 100-1,000 nm, from 500-1,000 nm, from 100-500 nm, from 100-250 nm, from 250-500 nm, from 50-150 nm, from 200-300 nm, or from 150-300 nm.

In certain implementations the second metallic layer is a crystalline layer. In certain implementations the second metallic layer is a crystalline layer exhibiting a hexagonal grains. In certain implementations the hexagonal grains have a lateral dimensions from 10-500 nm, from 10-100 nm, from 50-500 nm, from 100-500 nm, from 100-250 nm, from 100-300 nm, from 150-300 nm, from 200-400 nm, from 250-500 nm, or from 300-500 nm.

In some aspects, the cathode may include sodium, potassium, lithium, magnesium, calcium, aluminum, layered oxides, vanadium-based cathode, sulfur-based cathode, spinels, olivines, or any combination thereof.

In yet still further aspects, the cathode can include a LiFePO₄ composite cathode, a LiNi_{0.8}Co_{0.15}Al_{0.05}O₂, a LiNi_{1/3}Mn_{1/3}Co_{1/3}O₂, a LiNi_{0.4}Mn_{0.3}Co_{0.3}O₂, a LiNi_{0.5}Mn_{0.3}Co_{0.2}O₂, a LiNi_{0.6}Mn_{0.2}Co_{0.2}O₂, a LiNi_{0.8}Mn_{0.1}Co_{0.102} composite cathode. In still further aspects, the cathode can include KFe^{II}Fe^{III}(CN)₆, NaFe^{II}Fe^{III}(CN)₆, Na₃V₂(PO₄)₃, LiFePO₄, Li(NiCoMn)O₂, or any combination thereof. In yet still further aspects, the cathode material can also include a poly(ethylene oxide), cellulose, carboxymethylcellulose (CMC), a polytetrafluoroethylene (PTFE), styrene-butadiene rubber (SBR), or a polyvinylidene fluoride binder.

In some aspects the SSE may include at least one of sulfide compounds, LPSCLi, LPSB, LPSF, lithium thiophosphases, lithium thiosulfides, halides, garnet structure oxides, LISICON-type solids, NASICON- or KSICON-type phosphate glass ceramics, perovskite-type and anti-perovskite type compounds, nitrides, oxynitrides, argyrodite-type, or polymer-based electrolytes, or any combination thereof. In one unlimiting example, the SSE is an argyrodite-type electrolyte comprised of M₆PS₅Cl, wherein M is an active metal chosen from Li, Na, K, An, Al, or Ca.

In still further aspects, the SSE can further include a lithium germanium phosphorous sulfide electrolyte, a lithium phosphorus oxynitride electrolyte, a lithium phosphorous sulfide electrolyte, lithium lanthanum zirconium oxide, lithium lanthanum titanium oxide, lithium aluminum germanium phosphate, lithium nitride, or any combination thereof. While in other aspects, if the anode material is K or Na, the solid electrolytes disclosed above can comprise Na or K incorporated within. For example, and without limitations, it can be a sodium phosphorus sulfide electrolyte or a potassium phosphorus sulfide electrolyte.

In the above embodiment, the second substrate and the SSE contain the same active metal. The first metallic layer of the intermetallic bilayer includes the common active metal and the one or more elements forming the second intermetallic bilayer. For example, the second intermetallic layer may have a composition of LiₓM_{y}, NaₓM_{y}, KₓM_{y}, ZnₓM_{y}, AlₓM_{y}, or CaₓM_{y}, where x, y are relevant stoichiometric amounts.

The electrochemical cell of any of the above embodiments or examples may exhibit reversible capacity for about 2-5000 or more cycles at about 0.1-10 mA/cm². For example, the electrochemical cell may exhibit reversible capacity of about 100 cycles at about 0.5 mA/cm², about 100 cycles at about 5 mA/cm², about 500 cycles at about 0.5 mA/cm², about 500 cycles at about 5 mA/cm², about 1000 cycles at about 0.5 mA/cm², about 1000 cycles at about 5 mA/cm², about 2000 cycles at about 0.5 mA/cm², about 2000 cycles at about 5 mA/cm², about 3000 cycles at about 0.5 mA/cm², about 3000 cycles at about 5 mA/cm², about 4000 cycles at about 0.5 mA/cm², or about 4000 cycles at about 5 mA/cm².

The electrochemical cell of any of the above embodiments or examples may exhibit continuous plating of about 0.01-20 mAh/cm² at about 0.01-20 mA/cm². For example, the electrochemical cell may exhibit continuous plating of about 0.5 mAh/cm² at about 0.5 mA/cm², about 0.5 mAh/cm² at about 5 mA/cm², about 5 mAh/cm² at about 0.5 mA/cm², about 5 mAh/cm² at about 5 mA/cm², about 1.0 mAh/cm² at about 0.5 mA/cm², about 1.0 mAh/cm² at about 5 mA/cm², about 15 mAh/cm² at about 1.0 mA/cm², or about 15 mAh/cm² at about 15 mA/cm².

The electrochemical cell of any of the above embodiments or examples may exhibit coulombic efficiency of greater than about 70% to 100%, greater than about 75%, greater than about 80%, greater than about 85%, greater than about 90%, greater than about 95%, or greater than about 99%.

In another embodiment, a method of making the electrochemical cell is described herein. The method may comprise forming a metallic bilayer by providing a first metal onto a first substrate, and then disposing a second metal onto the first metal disposed on the first substrate. For example, the first and second metals may be mechanically pressed, rolled, sprayed, slurry deposited, vacuum-based deposited such as PVD and CVD, or through a sacrificial templating in sequence on to the first substrate. Finally, the SSE is disposed on the metallic bilayer adjected to the second metal, subsequently forming an intermetallic layer comprising the second metal of the metallic bilayer and the active metal of the SSE. The reaction of the second metal with the active metal of the SSE is an endothermic reaction and pressure may be applied during deposition of the SSE.

### EXAMPLES

### Example 1. Reactive Tellurene Stabilizes the Interphase of Lithium Metal and an Argyrodite Solid-State Electrolyte

In one example, a thin intermetallic Li₂Te—LiTe₃ bilayer (0.75 m total) derived from 2D tellurene stabilized the solid electrolyte interphase (SEI) of Li metal and argyrodite (LPSCl, Li₆PS₅Cl) solid-state electrolyte (SSE). Tellurene was loaded onto a standard battery separator and reacted with Li through single-pass mechanical rolling or transferred directly to SSE surface by pressing. State-of-the-art electrochemical performance was achieved, e.g. symmetric cell stable for 200 cycles (1200 hours) at 1 mA cm⁻² and 3 mAh cm⁻² (25% DOD, 60 μm foil). Continuous plating of 12 mAh cm⁻² on empty current collector was demonstrated at 0.5 mA cm⁻². All-solid-state battery (ASSB) with NMC811 cathode (9.5 mg cm⁻²) with capacity 153 mAh g⁻¹ at 0.5 C, had 95.3% retention after 200 cycles. Cryo-FIB sectioning and Raman mapping demonstrated that tellurene-enabled SEI significantly impeded SSE decomposition and prevented Li void formation. The unmodified interphase was unstable, with a geometrically non-uniform Li-SSE reaction layer extending deep into electrolyte and Li metal containing large voids. There was little evidence of pristine Li metal filaments (classical dendrites) extending into the SSE, implying that short-circuits originated from the composite reaction layer having sufficient electrical conductivity. The concomitant large voids in the Li metal also suggested reactivity as the source of Li depletion. It was demonstrated that enhanced thermodynamic stability and reduced electrical conductivity of the Li₂Te-LPSCl interphase greatly improves cell performance.

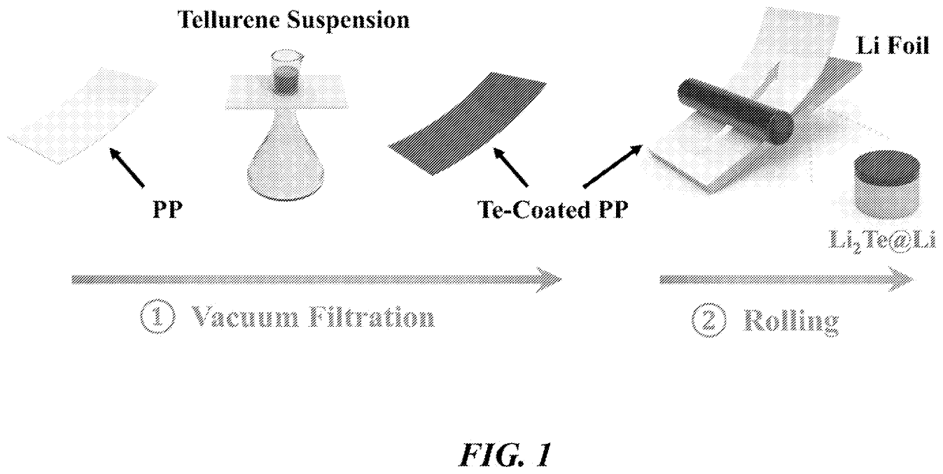

FIG. 1A illustrates the synthesis procedure used for coating a Li anode with a layer of tellurene. Due to the material's morphology, a self-standing film was obtained by filtering a dispersed tellurene suspension through the commercial polypropylene (PP) separator, using a mass loading of 2 mg/cm². During the process, the 2D sheets spontaneously assembled into a laminar structure without the use of a binder. During the consequent rolling coupled with in-situ reaction procedures, the tellurene layer reacted with the Li metal surface. With one rolling pass, the tellurene reacted to form a bilayer of thermodynamically stable Li₂Te intermetallic having an fcc antifluoride crystal structure in contact with the Li and LiTe₃ layer on its outside. When the foil was removed, the unreacted tellurene remained on the separator. It was estimated that 60% of the tellurene was reacted, giving an approximate mass loading of 1.3 mg/cm². For brevity, the specimens with the LiTe₃—Li₂Te—Li specimens are labeled “Li₂Te@Li” with the baseline unmodified Li anodes labeled simply “baseline Li”. Both Li₂Te@Li and baseline Li were rolled to a thickness of approximately 60 μm prior to being electrochemically tested.

Synthesis of Tellurene. A hydrothermal method was used for synthesizing tellurene.^{[35]} The tellurene flakes were synthesized by a facile one-step hydrothermal route. In a typical procedure, 200 mg of Na₂TeO₃ was first dissolved into 66 mL distilled water, followed by the addition of 690 mg of polyvinyl pyrrolidone (PVP, k17). The solution was magnetically stirred at room temperature for about 10 minutes, and then mixed with 2 mL hydrazine hydrate (85%, wt/wt %) and 4 mL aqueous ammonia solution (25%, wt/wt %). The above mixture was transferred into a 100 mL Teflon-lined stainless-steel autoclave which was then heated at 180° C. for 40 hours. After the reaction, the resulting solid, silver-grey products were first washed with distilled water several times to remove ion contaminants. Afterwards the materials were dispersed in an acetone/ethanol mixture and kept at temperature for 24 hours, through which the PVP molecules adsorbed on tellurene surface could be further removed. The solution was then washed with distilled water and ethanol several times to obtain purified tellurene, which was finally dried at 80° C. overnight.

Preparation of Li₂Te-Protected Li Metal Anode (Li₂Te@Li). The obtained tellurene powder was dispersed into ethyl alcohol under an ultrasonic condition for at least 1 hour and then was vacuum-filtered using a piece of commercial polypropylene (PP) separator. During the vacuum filtration process, the 2D tellurene assembled as an ultrathin film attaching onto the PP separator, and the loading amount was controlled to be about 2 mg cm⁻². Then the as-prepared separator was dried in a drying oven under 50° C. for 12 hours.

The transfer of the 2D film from the composite separator to Li metal anode was done in an Ar-filled glovebox (<1 ppm of 02). Then the composite separator was pressed against the Li sheet surface with the 2D tellurene film side in contact with the Li metal. The contiguous Li sheet and Te-based separator were continuously rolled for ten minutes, followed by being pressed under a 20 kg weight for 24 hours. During this process, the interfacial tellurene layer in contact with lithium was reduced and transformed to the close-packed Li₂Te interphase. Then the separator with unreduced tellurene was peeled away from the lithium substrate, leaving the Li₂Te passivation film tightly adhered to the surface of Li foil (termed Li₂Te@Li), achieving “in situ transferring” from separator onto lithium substrate.

Battery Assembly and Electrochemical Measurements. To assemble all-solid-state symmetric cell, 160 mg of Li₆PS₅Cl powder was first pressed under 150 MPa in a poly(aryl-ether-ether-ketone) (PEEK) mold with a diameter of 12 mm. Two pieces of Li₂Te@Li foils or Li foils were pressed onto both sides of the electrolyte pellets. An external pressure of approximately 13 or 7 MPa was applied to stack the cells by tightening screws to an appropriate torque using a torque wrench. For the baseline cell, Li foil was rolled to a thickness of about 50-70 μm before being used as anodes.

To fabricate Li|Li₂Te@LPSCl|Cu asymmetric cell, 150 mg of Li₆PS₅Cl powder was first pressed in the PEEK mold under approximately 100 MPa. Then the PP separator with 0.75 mg cm⁻² of tellurene coating was put on one side of the electrolyte, which was pressed under 25 MPa and then peeled away to obtain an electrolyte pellet coated with tellurene. The Cu current collector was attached to the coating side and Li anode was attached to the opposite side. The laminated battery was then pressed under 225 MPa and finally mounted with a stack pressure of 13 MPa for consequent electrochemical measurements. The fabrication of baseline Li|LPSCl|Cu asymmetric cell followed the same assembly process as Li|Li₂Te@LPSCl|Cu cell, except for skipping the coating step.

For fabrication of cathode composite electrodes, Li(Ni_{0.8}Mn_{0.1} Co_{0.1})O₂ (NMC811) powder was ground together with Li₆PS₅Cl powder at a weight ratio of 7:3 without any carbon being added. When assembling the all-solid-state full cell, 150 mg of Li₆PS₅Cl powder was first pressed in the PEEK mold under approximately 50 MPa. Then about 5 to 6 mg cathode powder was uniformly dispersed on one side of the electrolyte (0.5 to 0.6 cm⁻²), which was then pressed under 225 MPa to obtain an electrolyte pellet in close contact with cathode layer. Finally, the Li₂Te@Li anode (or Li anode) was attached to the other side of electrolyte pellet by pressing under 20 MPa. The laminated battery was finally mounted with a stack pressure of 13 MPa for consequent electrochemical measurements.

The Li plating/stripping measurements of symmetric as well as asymmetric cells, and the galvanostatic charge/discharge profiles of full cells were recorded on the battery testing system (Wuhan LANDCT2001A battery testers) at room temperature (20-25° C.). The voltage window was 2.8-4.3 V for full cells test. The EIS Nyquist plots of symmetric and full cells were collected on a Princeton PARSTAT MC electrochemical workstation, with a perturbation voltage of 10 mV from 1 MHz to 0.1 Hz. To analyze the ionic conductivity of the employed solid electrolyte, about 300 mg of Li₆PS₅Cl powder was pressed in PEEK mold under 225 MPa, and then mounted to the cell holder with a stack pressure of 13 MPa. The corresponding AC impedance measurement was performed on Gamry Reference 600+ potentiostatic with a perturbation voltage of 10 mV in the frequency range of 5 MHz to 1 Hz.

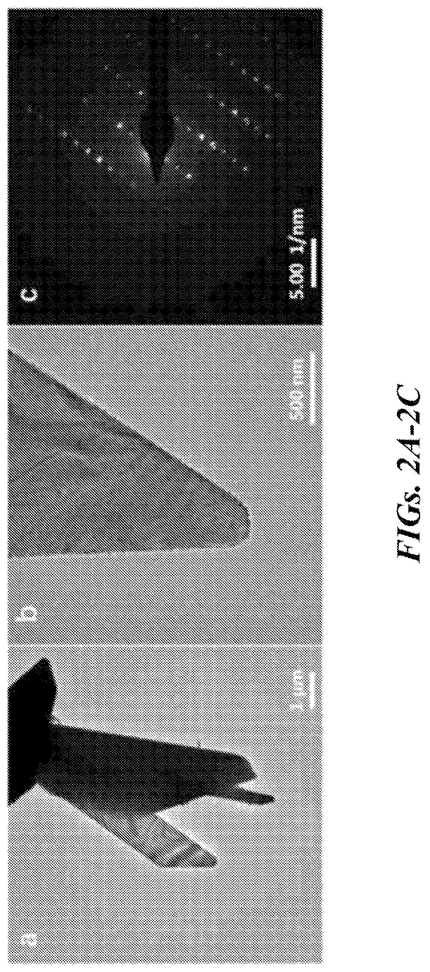

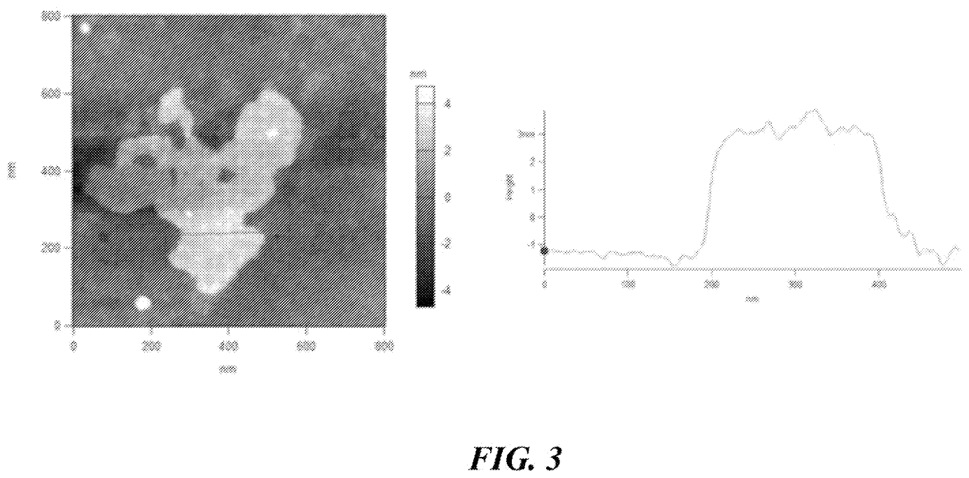

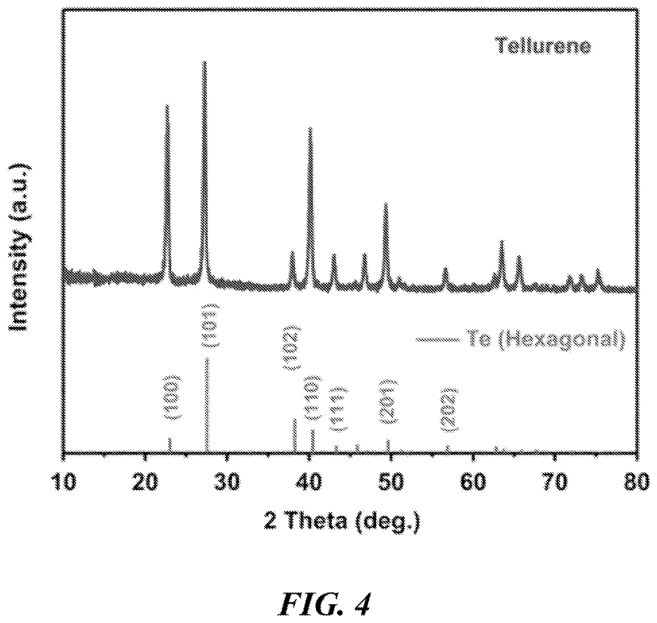

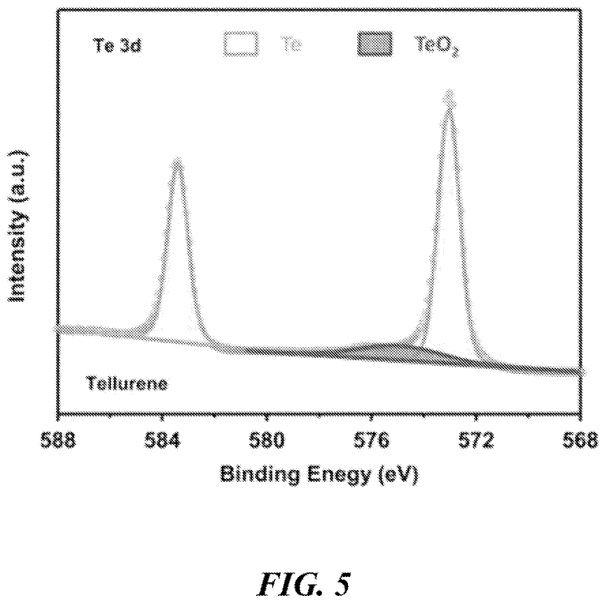

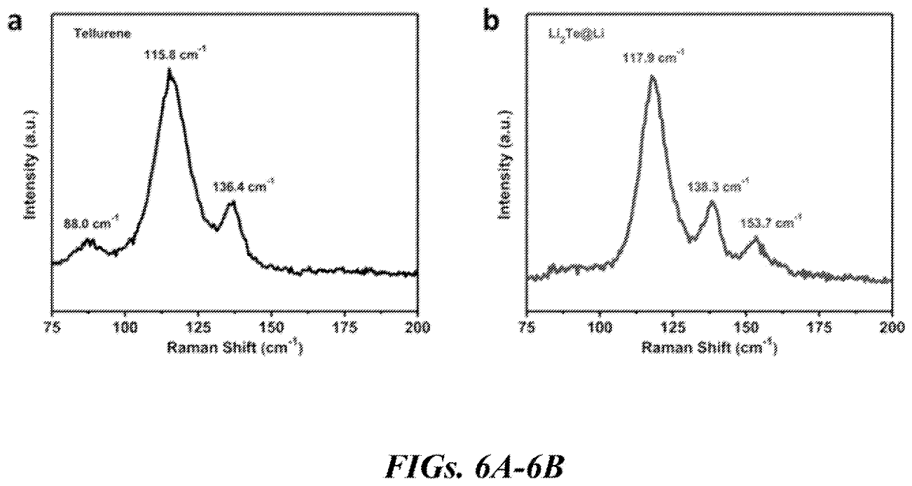

Materials Characterizations. Analytical characterization of tellurene was performed using transmission electron microscopy (TEM) and atomic force microscopy (AFM). TEM and selected area diffraction pattern (SAED) results shown in FIGS. 2A-2C confirm the single crystal sheet-like structure. The typical thickness of a tellurene sheet is about 4 nm, as per the atomic force microscopy image shown in FIG. 3. Per FIG. 4 X-ray diffraction (XRD) confirms that the as-prepared material is hexagonal. X-ray photoelectron spectroscopy (XPS) was utilized to investigate the chemical states of tellurene; the de-convoluted XPS spectrum is shown in FIG. 5. A major peak doublet located at around 573.0 and 583.4 eV was ascribed to the 3d_{5/2} and 3d_{3/2} spin orbital doublet of elemental tellurium, respectively. A small broad peak appearing at approximately 575.3 eV corresponds to the Te—O bond (Te⁴⁺, TeO₂) which originates from minor surface oxidation of tellurene during the hydrothermal process. FIG. 6A displays the Raman spectrum of tellurene, which includes three vibration modes: E1 mode (approximately 88.0 cm⁻¹), Al mode (approximately 115.8 cm⁻¹), and E2 mode (approximately 136.4 cm⁻¹).

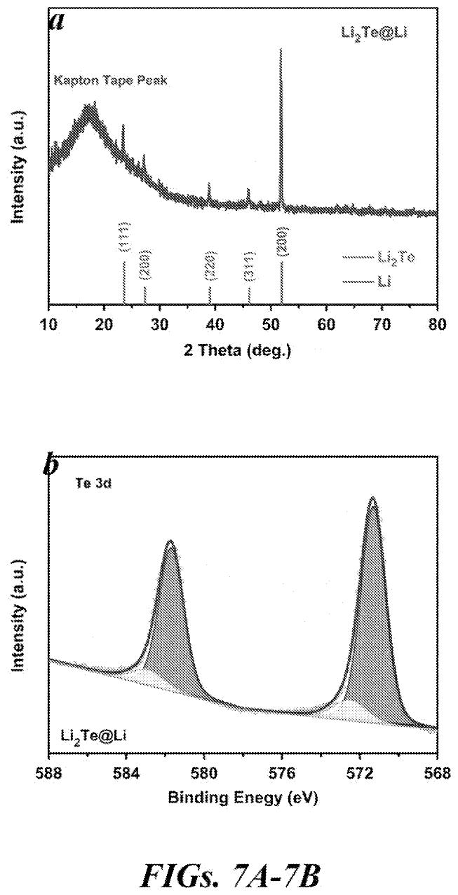

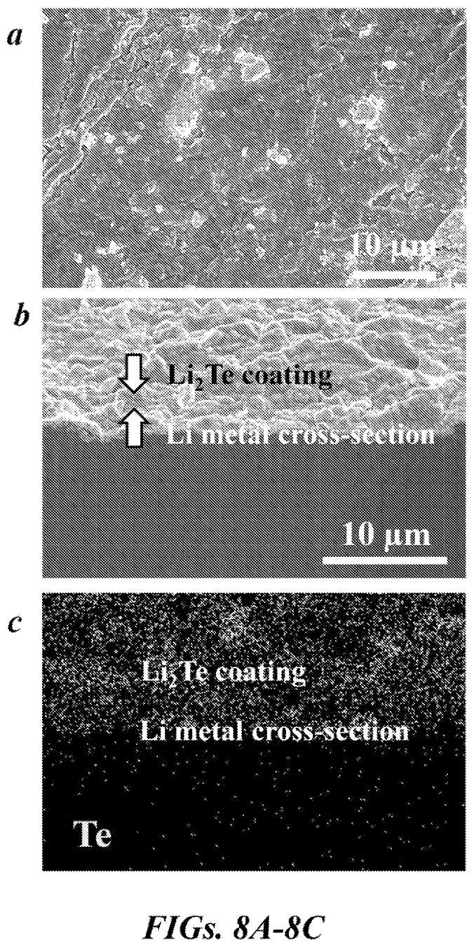

Analytical characterization of Li₂Te@Li was performed using XRD, XPS, and scanning electron microscopy (SEM). The XRD results shown in FIG. 7A presents four distinct peaks that correspond to (111), (200), (220) and (311) reflections of Li₂Te, apart from a residual strong (200) Li peak at 51.92°. The high-resolution Te 3d XPS spectrum was analyzed. As shown in FIG. 7B the Li₂Te@Li presents two strong peaks at approximately 571.3 and approximately 581.7 eV were assigned to Te 3p_{5/2} and Te 3p_{3/2} of Te²⁻, respectively. Two other small Te 3d peaks at approximately 572.5 and 582.9 eV were observed as well, which correspond to minor amount of LiTe₃ on the outside of the Li₂Te. FIG. 6B presents the Raman spectrum of Li₂Te@Li, where three Raman vibration band at 117.9 cm⁻¹, 138.3 cm⁻¹ and 153.7 cm⁻¹ were ascribed to Li₂Te. FIG. 8A-8C show top-view and cross-sectional FIB SEM images of the as-synthesized Li₂Te@Li, and the associated EDXS map of Te. After lithiation, the tellurene was transformed to a dense and continuous intermetallic layer, without cracks or voids being detected.

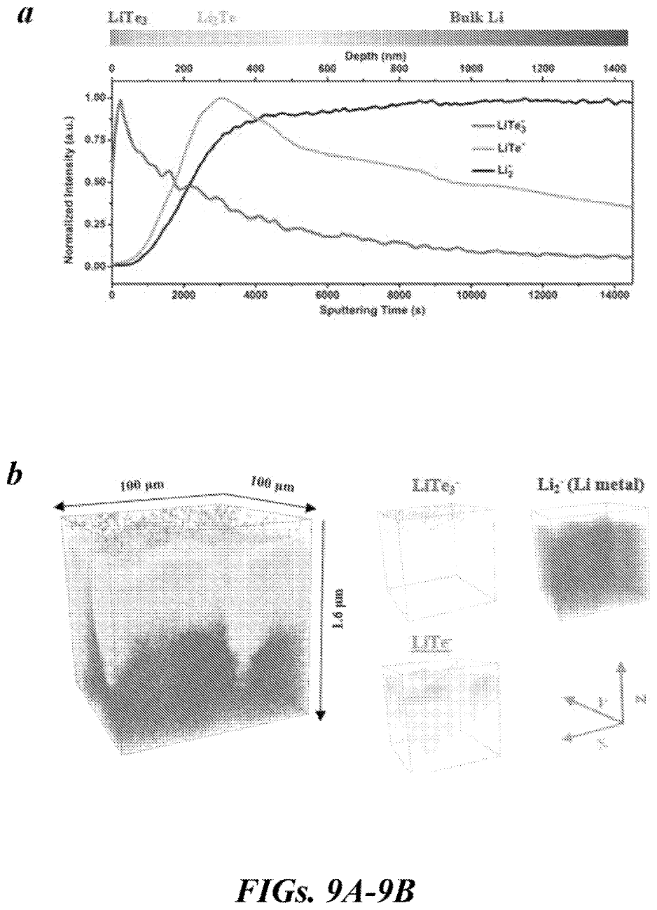

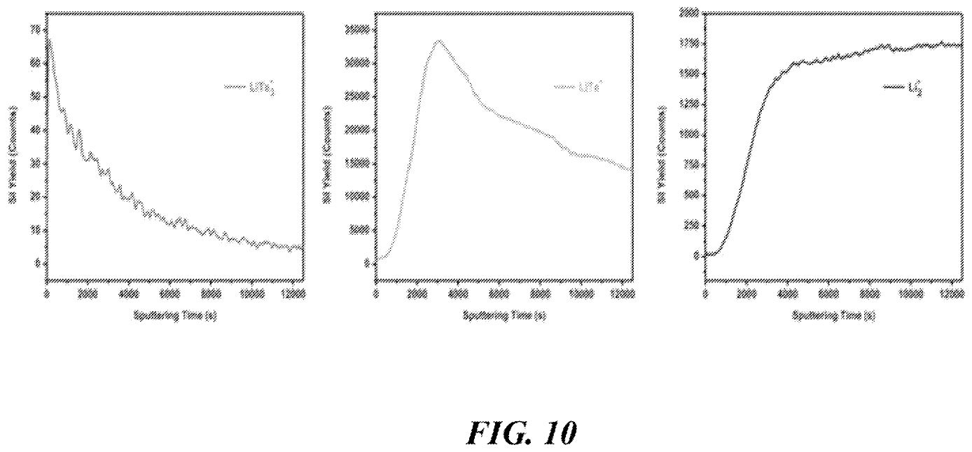

FIG. 9A-9B and FIG. 10 present the TOF-SIMS top-down depth profiling of the intermetallic-covered lithium surface. As was observed, the intermetallic layer was a bilayer of Li₂Te adjacent to the Li metal and LiTe₃ on its outside. The profile revealed the evolution of several fragments (LiTe₃⁻, LiTe⁻, and Li₂⁻) as the sputtering proceeded at a rate of 0.1 nm s⁻¹. The LiTe₃⁻ fragment and the Li₂⁻ fragment represented LiTe₃ and metallic lithium, respectively, while LiTe⁻ fragments were arising from the equilibrium Li₂Te intermetallic interlayer. The signal intensity of LiTe₃⁻ remains high over only the first 200 seconds of Cs⁺ sputtering, indicating LiTe₃ was present on the outer surface of the sample. The LiTe⁻ fragment displayed an intensity peak after 3000 seconds of Cs⁺ sputtering. A Li₂⁻ fragment initially appeared as a weak signal but then increased almost in parallel over the entire later sputter time, demonstrating that bulk lithium was covered by a bilayer of tellurene-derived intermetallic. The three-dimensional views of the sputtered volume of Li₂Te@Li from the depth profile are shown in FIG. 9B that directly visualize the deposited LiTe₃ and Li₂Te on the surface of the bulk lithium. Per the normalized TOF-SIMS depth profiles, the bilayer layer was approximately 0.75 m thick which was consistent with the cross-sectional FIB-SEM image.

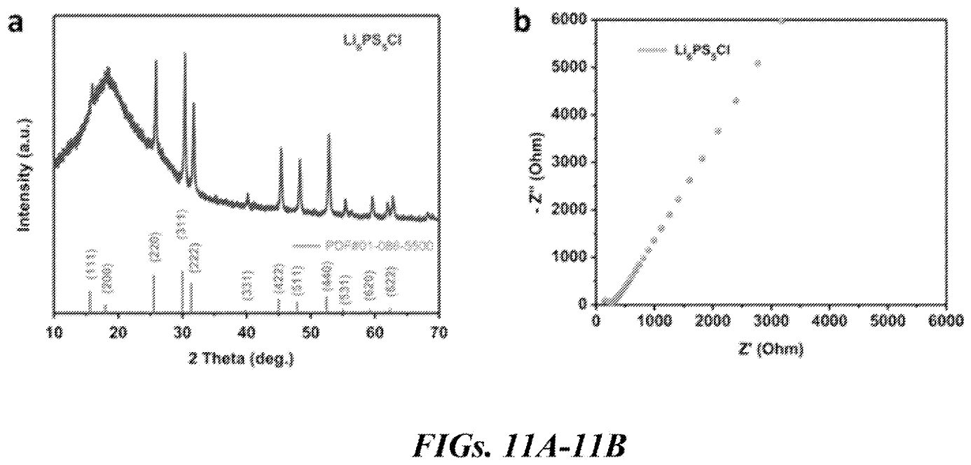

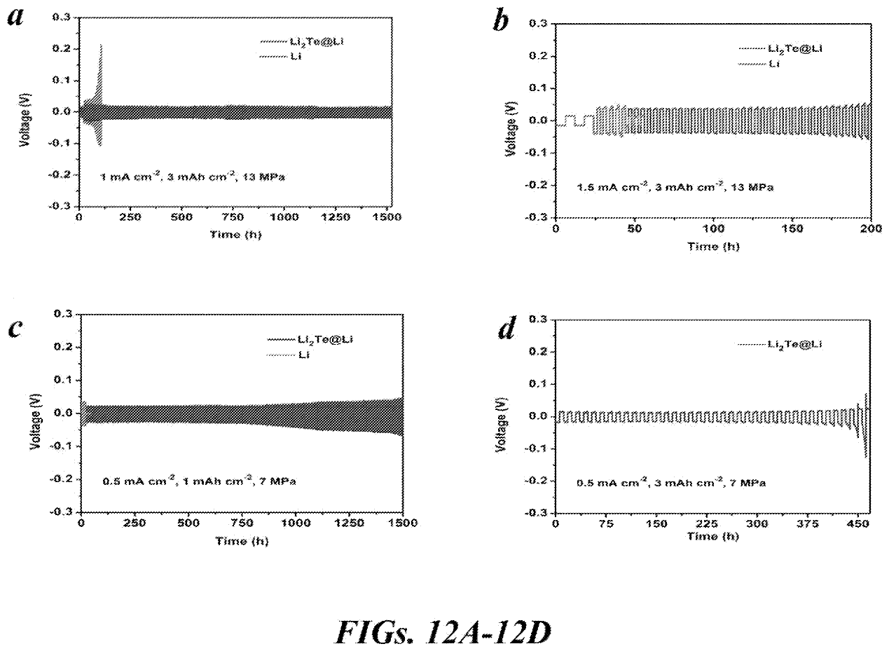

To compare the interfacial stability of Li₂Te@Li and baseline Li anodes, the electrochemical performance of symmetric PEEK cells was investigated using commercial Li₆PS₅Cl (LPSCl) as the SSE. FIG. 11A displays the XRD pattern of the Li₆PS₅Cl electrolyte. Per FIG. 11B, the corresponding ionic conductivity was 2.6×10⁻³ S cm⁻¹. As indicated previously, Li₂Te@Li and baseline Li were rolled to a thickness of about 60 μm. First, a moderate stack pressure of 13 MPa was employed for the testing. At this pressure the currents employed were 1 mA cm⁻² and 1.5 mA cm⁻², with a capacity of 3 mAh cm⁻² per cycle. Areal capacity of 3 mAh cm⁻² corresponds to 15 μm of plated/stripped lithium and a depth-of-discharge (DOD) of 25% per cycle. FIGS. 12A and 12B display the plating/stripping voltage profiles of the cells employing Li₂Te@Li and baseline Li. Both tests started with a two-cycle regiment of 0.5 mA cm⁻², 3 mAh cm⁻² that was employed for stabilizing the interphase, and at which point the higher currents were used for the remainder of the experiment. Per FIG. 12A, at 1 mA cm⁻² the first cycle overpotentials for Li₂Te@Li and baseline Li were 24 mV and 32 mV, respectively. As cycling proceeded, the overpotentials in the two architectures began to substantially diverge. The baseline Li overpotentials progressively increased up to 214 mV at the 14^{th} cycle (108 hours), followed by a short-circuit. Such electrochemical behavior had been attributed to a continuous interfacial side reaction between Li₆PS₅Cl and the lithium anode, the formation of interfacial voids, as well growth of dendrites that ultimately shorts the two electrodes together.^{[36]} In contrast, the cell with Li₂Te@Li was stable at 220^{th} cycle (1320 hours) with the overpotential maintained at 18 mV. This corresponds to a cumulative capacity of 1320 mAh cm⁻² and a cumulative plating/stripping thickness of 6600 microns. As shown in FIG. 12B, at 1.5 mA cm⁻² the Li₂Te@Li cell was stable over 45 cycles (180 hours), with a cumulative capacity of 270 mAh cm⁻² (1350 microns). The baseline Li cycled only four times before it short-circuited.

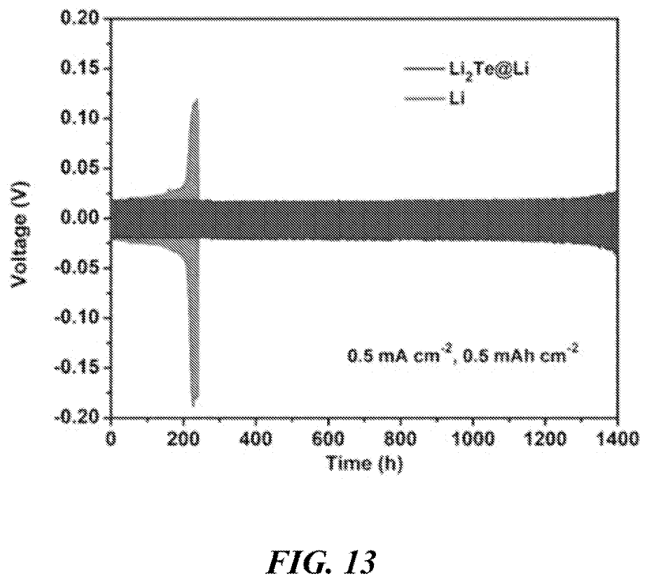

In the subsequent symmetric cell electrochemical tests, a lower cell stack pressure of 7 MPa was used. At this pressure the current employed was 0.5 mA cm-2. FIG. 13 presents cycling results with a capacity of 0.5 mAh cm⁻² per cycle. The Li₂Te@Li cell achieved 700 cycles (1400 hours) with stable voltage output. This corresponded to a cumulative capacity of 700 mAh cm⁻² (3500 microns). The baseline Li cell displayed progressive polarization with significant fluctuations incurred by the 100^{th} cycle (200 hours) and a consequent short-circuit at the 125^{th} cycle (250 hours). FIG. 12C presents cycling results at 0.5 mA cm⁻² with a capacity of 1 mAh cm⁻² per cycle. The Li₂Te@Li cell achieved 375 cycles (1500 hours) and 750 mAh cm⁻² cumulative capacity (3750 microns) without short-circuiting. In contrast, a short-circuit occurred on the sixth cycle (20 hours) with baseline Li. FIG. 12D shows Li₂Te@Li tested at 0.5 mA cm⁻² and 3 mAh cm⁻² per cycle. The baseline Li cell was not shown as it was not able to survive a single cycle at such capacity. The Li₂Te@Li cell performs a stable operation over 38 cycles (456 hours) corresponding to a cumulative capacity of 228 mAh cm⁻² (1140 microns). After this point the overpotentials also began to increase, indicating a deteriorating interphase. Table 2 presents a comparison of the Li₂Te@Li cyclability versus state-of-the-art prior publications. It was observed that the durability of Li₂Te@Li was among the most favorable, especially considering the high capacity and associated DOD employed for the testing.

TABLE 2
A comparison of Li2Te@Li electrochemical performance with state-of-the-art literature
on the Li6PS5Cl-based symmetric cells employing different metal electrodes.

| | Plating | Plating | | Pressing | | | |
|---|---|---|---|---|---|---|---|
| | current | specific | Cumulative | Pressure of | Stack | | |
| Anode | density, | capacity, | capacity, | Electrolyte, | Pressure, | Test | |
| structure | mA cm⁻² | mA h cm⁻² | mAh cm⁻² | MPa | MPa | temperature | Reference |
| Li₂Te@Li | 0.5 | 1 | 750 | 150 | 7 | RT | This work |
| Li₂Te@Li | 1 | 3 | 1200 | 150 | 13 | RT | This work |
| Li₂Te@Li | 1.5 | 3 | 270 | 150 | 13 | RT | This work |
| LiPFG@Li | 0.05 | 0.05 | 45 | NA | NA | 60 °C | ^{[16′]} |
| Li—Ag | 0.1 | 1 | 200 | 370 | 5 | 25 °C | ^{[17′]} |
| PC@Li | 0.5 | 0.1 | 110 | 200 | NA | RT | ^{[18′]} |
| PPC@Li | 0.5 | 0.1 | 150 | 200 | NA | RT | ^{[18′]} |
| NPO—Li | 1 | 1 | 200 | 240 | NA | RT | ^{[19′]} |
| Si@Li | 0.5 | 0.31 | 298 | 300 | 20 | 25 °C | ^{[20′]} |
| ZnO | 0.5 | 0.1 | 140 | 300 | 40 | RT | ^{[21′]} |
| NRs/Li | | | | | | | |
| In/LiₓIn@Li | 1 | 1 | 540 | 520 | 30 | 60 °C | ^{[22′]} |
| Li/Li₂Se—NR | 0.5 | 1 | 100 | 50 | 50 | RT | ^{[23′]} |
| Li—Al alloy | 1 | 1 | 1500 | 400 | 100 | RT | ^{[24′]} |
| Ag—Li alloy | 0.5 | 1 | 300 | NA | NA | RT | ^{[25′]} |

Time-resolved EIS of symmetric cells was performed, testing in the frequency range from 1 MHz to 100 mHz with an amplitude of 10 mV. FIGS. 14A and B) present the EIS spectra for symmetric cells of Li₂Te@Li and baseline Li, respectively. Two sets of data are shown per figure, prior to cycling and after 30 cycles at 0.5 mA cm⁻², 0.5 mAh cm⁻². The EIS spectra of the as-fabricated cells consisted of two semicircles: The semicircle at the high frequency range corresponds to grain boundary resistance (R_{gb}) of the electrolyte and should be equivalent for both specimens and relatively invariant with cycling. As expected, prior to cycling the R_{gb} and the Ohmic resistance (highest frequency intercept of x-axis) of the two architectures are on par: For Li₂Te@Li those values are 103Ω and 56Ω, while for baseline Li they are 101Ω and 73Ω.

The semicircle at the lower frequency range corresponded to a combination of solid electrolyte interphase (SEI) resistance RSDI and interfacial charge transfer resistance R_{ct} which included a contribution due to voiding and otherwise poor contact. This was the resistance value that was expected to increase with cycling induced interphase degradation, voiding and dendrite growth. Prior to cycling, the R_{ct} and R_{SEI} overlap, with the single semicircle being termed R_{ct-SEI}. After 30 cycles, however, it was possible to deconvolve the two effects. Prior to cycling the R_{ct-SEI} values for Li₂Te@Li and baseline Li were 112Ω and 149Ω. After the baseline Li underwent 30 cycles, three distinct semicircles became present. The highest frequency semicircle was R_{gb}, the intermediate frequency semicircle was R_{SEI} at 65Ω, while the lowest frequency semicircle was Rot at 303Ω. The SEI resistance originated from the interfacial side reaction between lithium anode and the LPSCl electrolyte leading to compounds such as Li₂S, Li₃P, LiCl.^{[37]} The jump in the charge transfer resistance was likely due to void formation at the interface and reduced contact area.^{[17]} For the identically cycled Li₂Te@Li cell, a third semicircle did not emerge, with R_{ct-SEI} value being 135Ω. The R_{gb} and the Ohmic resistance of the two architectures did not change appreciably with cycling. For Li₂Te@Li those values were 114Ω and 60Ω, while for baseline Li they were 130Ω and 75Ω.

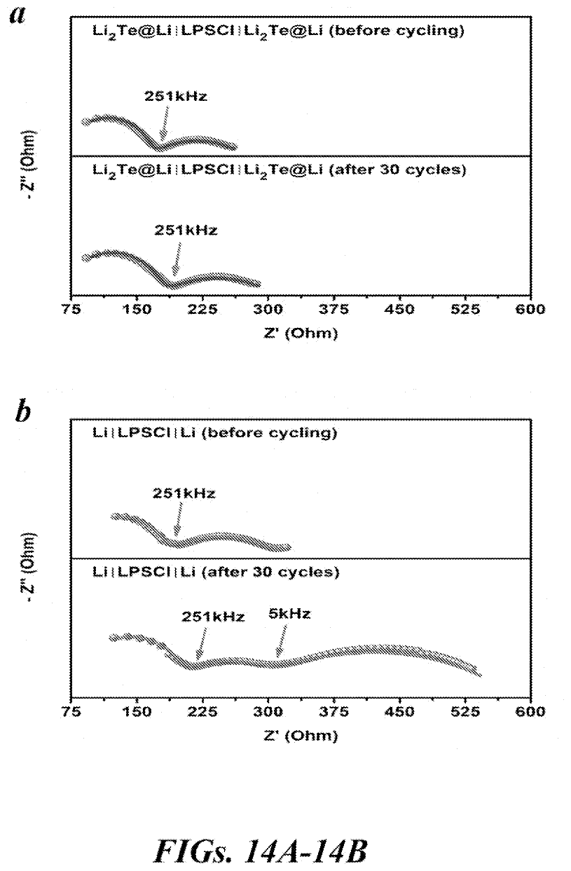

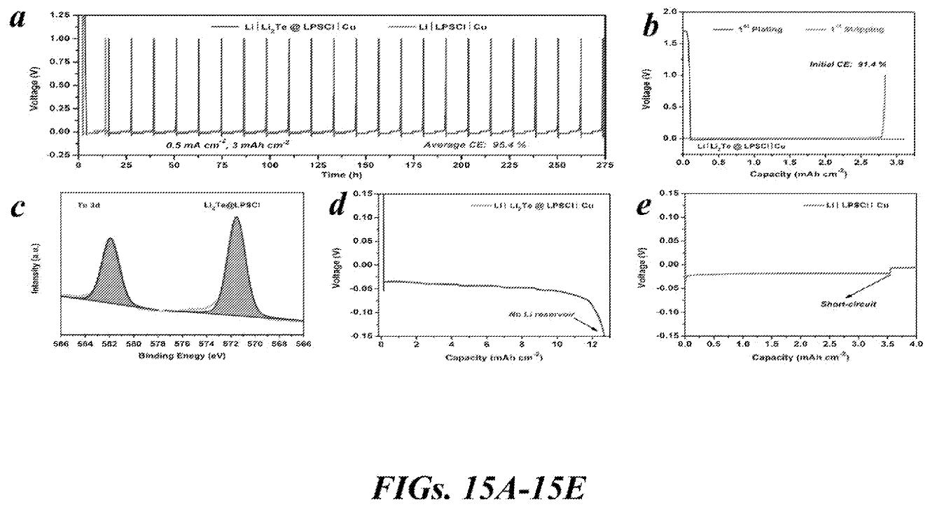

In another set of experiments, the tellurene was directly transferred from PP separator onto the LPSCl pellet surface. In such an asymmetric half-cell, tellurene layer faced the Cu foil current collector, while the counter/reference electrode was an unmodified Li foil. This architecture was labeled “Li₂Te@LPSCl” to distinguish the fabrication route. A separator with 0.75 mg cm⁻² mass loading of tellurene was mechanically compressing against the SSE at 25 MPa pressure. The amount of transferred tellurene was about 0.3 mg cm⁻², the rest remained on the separator after the single pressing step. FIG. 15B displays the first cycle voltage profile of Li₂Te@LPSCl half-cell at 0.5 mA cm⁻², 3 mAh cm⁻². FIG. 15C displays the fitted Te 3d XPS spectrum of the Li₂Te@LPSCl surface after the 1^{st} platting/stripping cycle, showing the two characteristic peaks at 571.4 eV and 581.8 eV assigned to Li₂Te. Per the XPS results, at the first cycle, the tellurene underwent an irreversible in-situ Li activation process at 1.7-1.0 V vs. Li/Li⁺, the formula for the reaction being Te+2Li⁺+2e⁻→Li₂Te. The kinetically irreversible capacity of the preceding reaction was measured as 0.11 mAh cm⁻², which corresponds to a mass loading of 0.28 mg cm⁻² for the reacted tellurium, i.e. roughly 36% of the total amount on the separator.

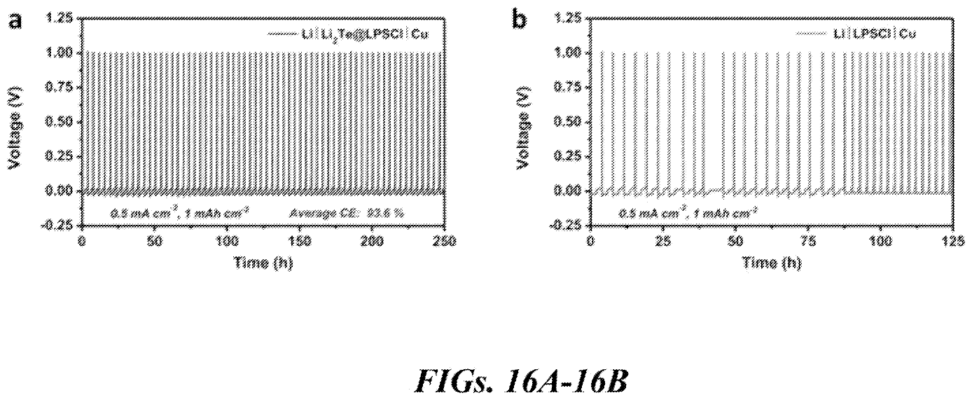

The Li₂Te@LPSCl and the baseline LPSCl SSE were tested in a half-cell configuration. FIG. 15A and FIG. 16 show the performance of these cells tested at 0.5 mA cm⁻², 3 mAh cm⁻², and 0.5 mA cm⁻², 1 mAh/cm², respectively. Both at 1 mAh cm⁻² and 3 mAh cm⁻² the Li₂Te@LPSCl half-cells remain stable at the 65th cycle (250 hours) and 23^{rd} cycle (275 hours), displaying averaged Coulombic efficiency (CE) of 93.6% and 95.4%, respectively. By contrast, the baseline LPSCl cells displayed early onset short-circuit. At 1 mAh cm⁻², the voltage suddenly dropped at the 8th cycle in a manner consistent with a soft short, followed by significantly fluctuated CEs ranging from 15.76% to 240.2%. At 3 mAh cm⁻², the baseline Li cell underwent a full electrical short at the 2^{nd} cycle. To further test the stability of artificial SEI, a continuous deposition test was performed using half-cells of Li₂Te@LPSCl and baseline LPSCl. A current density of 0.5 mA cm⁻² was employed. As shown in FIG. 15D, over 12 mAh cm⁻² of Li (60 m) can be electrodeposited on the Cu foil, the capacity limit being set by the exhaustion of the Li counter electrode, represented by the continuous increase in stripping overpotential. The baseline Li short-circuits after electrodepositing 3.5 mAh cm⁻² onto the Cu foil, as shown in FIG. 15E.

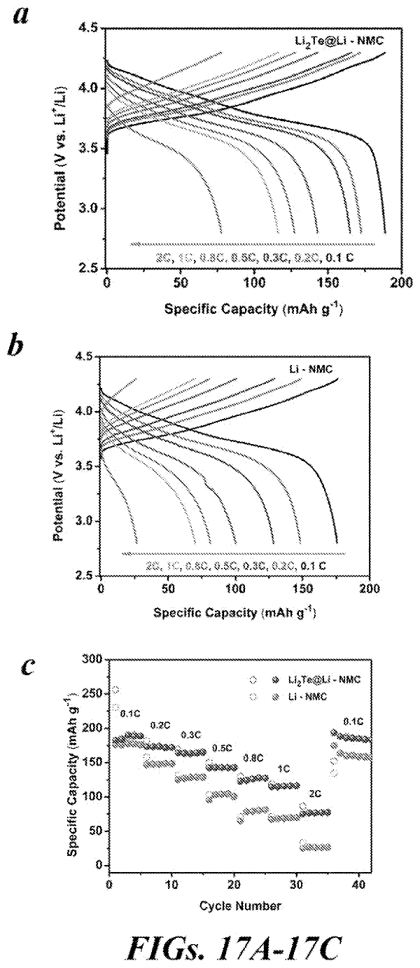

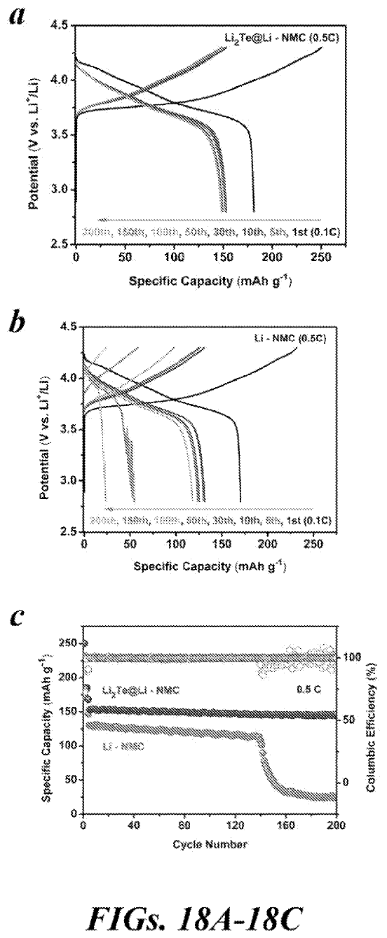

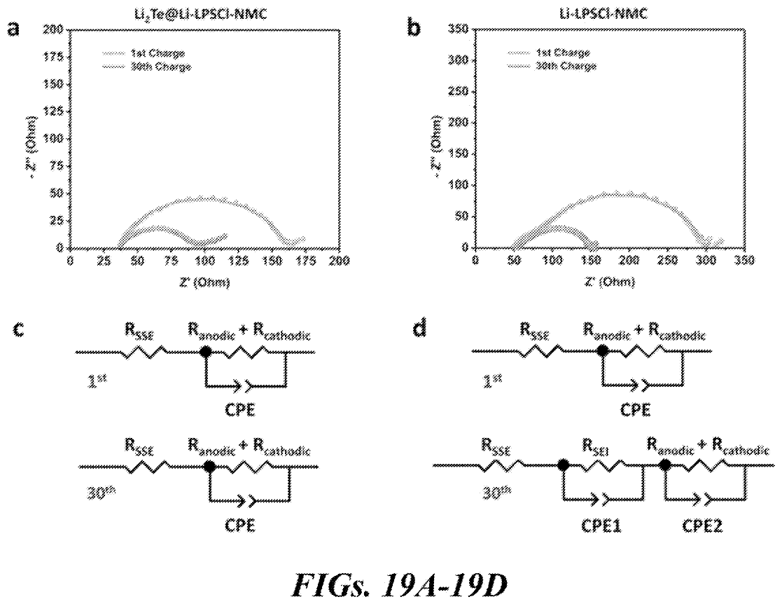

As proof-of-principle, full cells were fabricated using Li(Ni_{0.8}Mn_{0.1} Co_{0.1})O₂ (NMC 811) cathodes and Li₂Te@Li or baseline Li anodes. The average mass loading of the cathodes was 9.5 mg cm⁻² which equals a theoretical capacity of 1.4 mAh cm⁻² and 11.6% DOD for a 60 μm anode. The voltage window for the test was 2.8-4.3 V. FIGS. 17A and 17B display the galvanostatic curves of Li₂Te@Li-NMC and baseline Li-NMC at different current densities. It was observed that the hysteresis for Li₂Te@Li-NMC was consistently lower than that for the baseline. The rate performance of the cells is shown in FIG. 17C. The Li₂Te@Li-NMC cell delivered improved rate capability, achieving 189, 173, 165, 146, 128, 117, 78 mAh g⁻¹ at 0.1, 0.2, 0.3, 0.5, 0.8, 1.0, 2.0 C, respectively. By contrast, baseline Li-NMC delivers 178, 149, 129, 105, 80, 69, 27 mAh g⁻¹ at these currents. Li₂Te@Li-NMC and baseline Li-NMC were conditioned at 0.1 C for 3 cycles and then tested at 0.5 C for prolonged cycling lifetime. These results are shown in FIG. 18A-18C The initial reversible capacities of Li₂Te@Li-NMC and baseline Li-NMC are 182 mAh g⁻¹ and 171 mAh g⁻¹, with associated ICEs of 72.5% and 73.5%. After conditioning, the Li₂Te@Li-NMC delivered a reversible capacity of 154 mAh g⁻¹ at 0.5 C, retaining 147 mA h g⁻¹ after 200 cycles. This is equal to overall 95.5% capacity retention and 0.023% capacity decay per cycle. The corresponding galvanostatic discharge/charge profiles were consistently stable throughout the duration of cycling, shown in FIG. 18A Baseline Li-NMC full cell displayed a reversible capacity of 130 mAh g⁻¹ at 0.5 C, which rapidly decays with cycling. After 200 cycles, the cell delivered 24 mAh g⁻¹, corresponding to a capacity retention of 18.5%. As shown in FIG. 18B, the extended cycling galvanostatic profiles of baseline Li-NMC were unstable. FIG. 19 displays the Nyquist plots and equivalent circuits of Li₂Te@Li-NMC and Li-NMC cells in the charged state at the first and 30^{th} cycles. At the first cycle, the Li₂Te@Li-NMC cell displayed lower R_{ct} as compared to baseline Li-NMC, being 58.3Ω versus 94.4Ω. At the 30^{th} cycle, an additional semi-circle at high frequency (representing R_{SEI}=40Ω) was present for baseline Li-NMC. For Li₂Te@Li-NMC and baseline Li-NMC the Ret values increased to 119.5Ω and 206.1Ω, respectively.

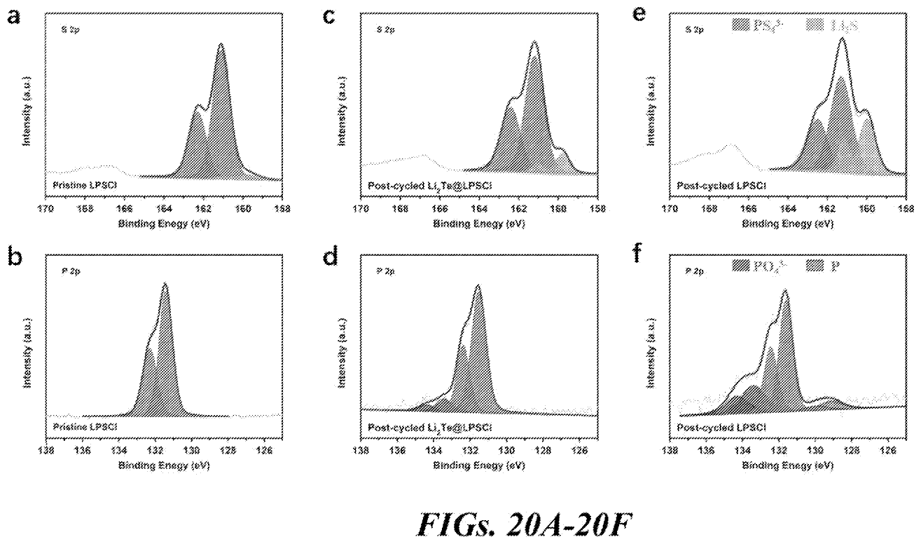

X-ray photoelectron spectroscopy (XPS) analysis was conducted on post-cycled Li₂Te@LPSCl and baseline LPSCl interphases, using half-cells. The half-cells were cycled for two platting-stripping cycles at 0.5 mA cm⁻², 1.5 mAh cm⁻², after which point they were dissembled in an inert Ar atmosphere glove box. The Cu foil was mechanically peeled away from the LPSCl pellet, exposing the SEI for the XPS analysis. Transferring steps were carried out in a sealable capsule to avoid the oxidation-related artifacts. FIGS. 20A and 20B present the background XPS analysis of the pristine LPSCl pellet, showing the high-resolution S 2p and P 2p spectra. A major doublet at the binding energy of 161.1 eV/162.3 eV in S 2p spectrum and a major doublet at the binding energy of 131.3 eV/132.1 eV in P 2p spectrum represent the PS₄³⁻ tetrahedral unit of electrolyte. A weak doublet at 159.8 eV and 161.0 eV in S 2p spectrum originated from trace amounts of Li₂S impurity (4.6% of sulfur) in the as-fabricated electrolyte. Per FIGS. 20C and 20D the post-cycled Li₂Te@Li₆PS₅Cl pellet retained PS₄³⁻ in the P 2p and S 2p spectra, with slightly increased Li₂S byproduct peaks (10.1 at % of sulfur). By contrast, the baseline Li₆PS₅Cl pellet displayed significant growth characteristic peaks of Li₂S (26.6 at %), along with an emerging P 2p peak doublet at 129.2/130.0 eV representing reduced phosphorus (P). Those results are shown in FIGS. 20E and 20F. It is contemplated that the broad PO₄³⁻ peak at 133.4/134.2 eV was induced by oxidation during sample preparation/transferring.

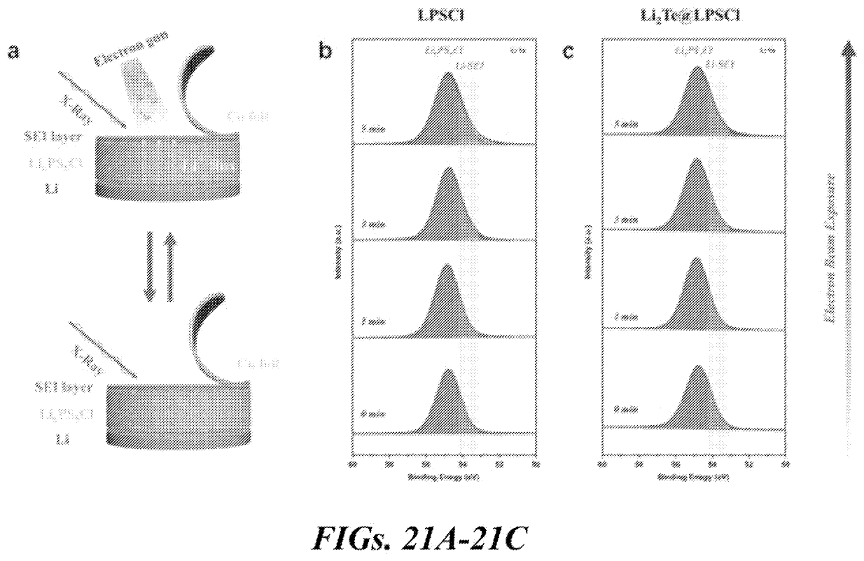

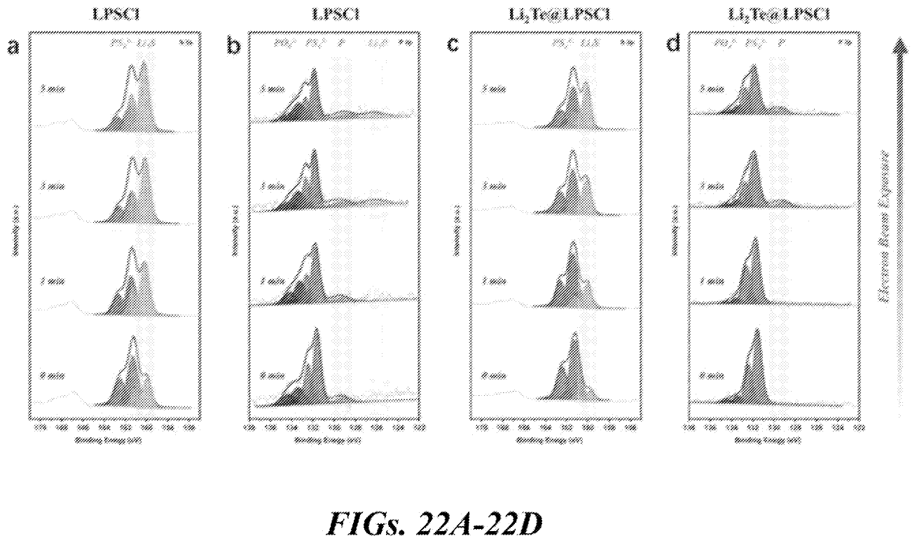

To further understand the interphase evolution in the two materials, in-situ XPS characterization was performed using an approach outlined in ref.^{[20, 24, 39]} FIG. 21A represents the schematic of the in-situ XPS technique employed. An electron gun was used for providing a flux of electrons to the SSEs surface. Since the SSE is an electrical insulator, this leads to negative charge accumulation on electrolyte surface and voltage difference between the surface and the grounded sample holder. This provides a driving force for the lithium ions to migrate from the grounded counter electrode through the bulk electrolyte to plate onto the charged surface. In the experiments, electron beam irradiation was applied for 5 minutes while the XPS spectra was continuously acquired. FIG. 21B shows the high-resolution Li 1 s XPS spectra of the baseline LPSCl while (c) shows this analysis for Li₂Te@LPSCl. The overall results are shown in FIG. 22. Irradiation continuously drove significant decomposition of baseline LPSCl, with an ongoing increase in the Li₂S content. The Li₃P peak intensity started growing after 3 minutes of electron beam exposure. The Li₂Te passivation layer impeded these reactions, with less Li₂S and minimal Li₃P formation. These results further demonstrated the stabilizing role of the tellurene-derived artificial SEI in preventing interphase deterioration.

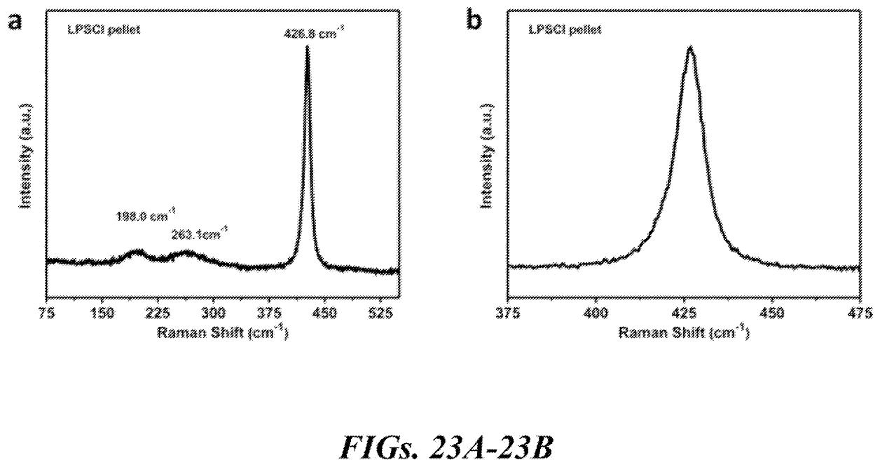

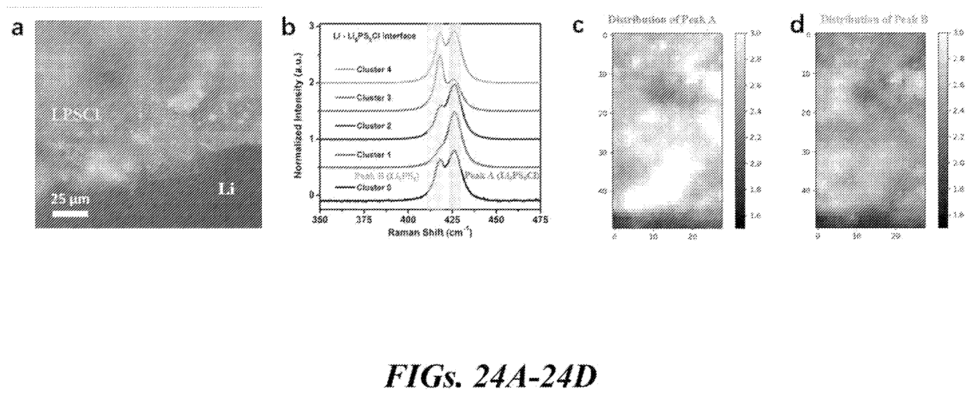

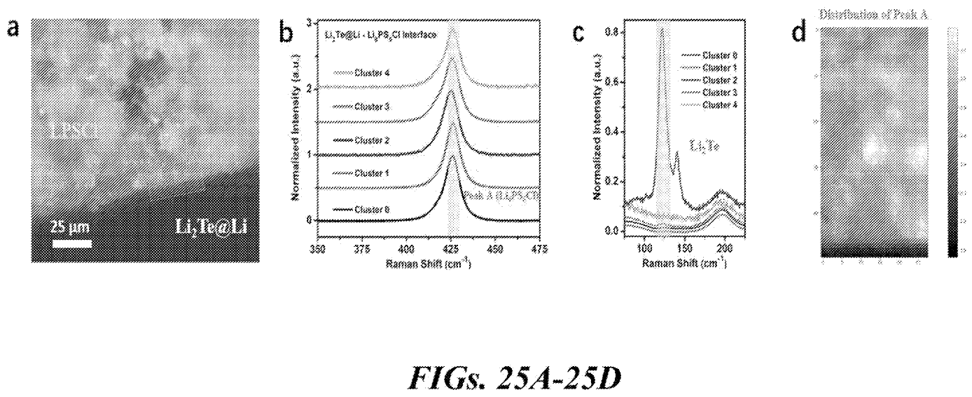

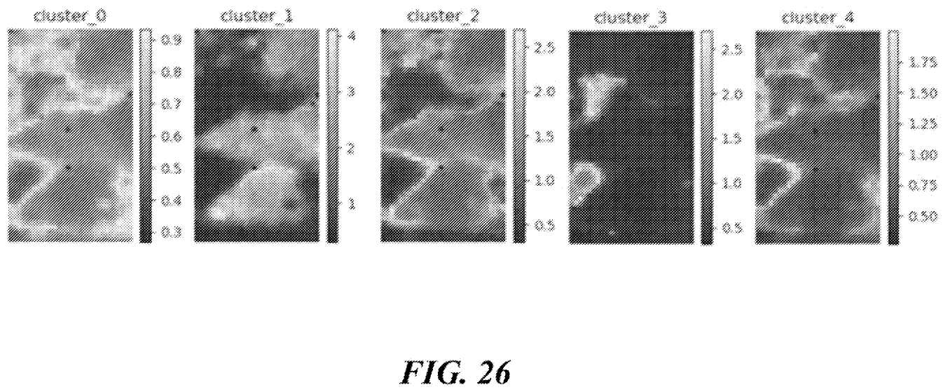

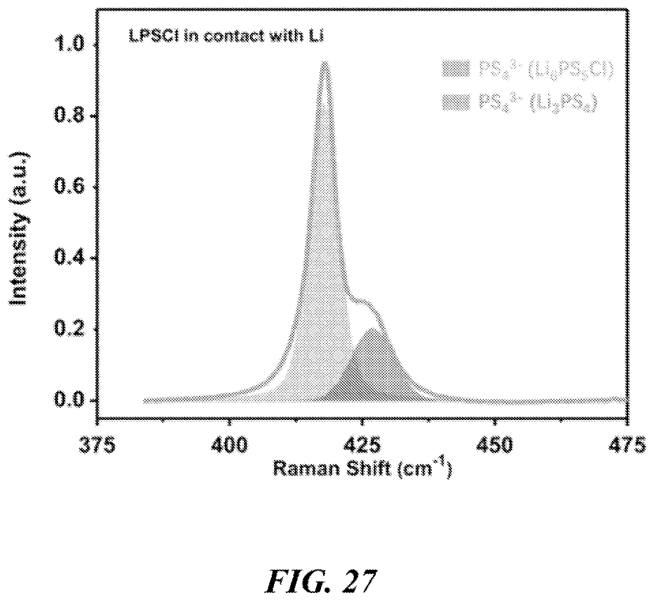

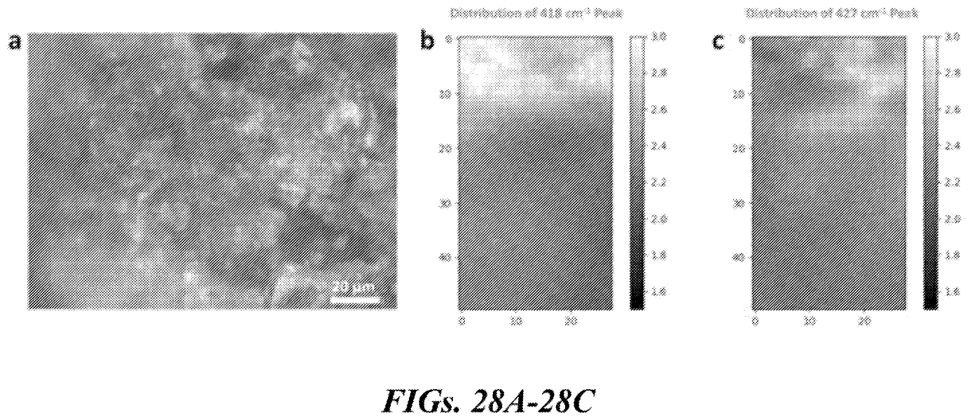

Raman Spectroscopy Experiments. Complementarily Raman mapping was employed to further explore the structure of the Li anode-LPSCl interphase with and without the artificial SE. A bilayer stack based on Li₂Te@Li-LPSCl or baseline Li-LPSCl pellet were first rested for 30 days at the open-circuit voltage in an inert Ar atmosphere glove box. This hold enables the interphases to decompose along their electrochemical-chemical reaction pathways without externally applied electrons. FIG. 23 presents the Raman spectrum of pristine LPSCl pellet. The spectrum displays a prominent peak at 426.8 cm⁻¹ along with two small broad peaks at 198.0 and 263.1 cm⁻¹, these being ascribed to the P—S tetrahedra stretching within Li₆PS₅Cl.^{[40]} FIG. 24 presents cross-sectional Raman mapping of the interfaces. Per FIGS. 24A and 25A, a 28 μm×50 μm region of the interphase was selected for the Raman scanning area. K-means clustering analysis was employed to extract the information out of the 1400 spectra of each mapping frame, which can be categorized into several clusters with similarities.^{[41]} The centroid spectrum of each cluster can then represent the characteristic features of all spectra in that category coded by a certain number. FIG. 24B shows the Raman spectra of five representative clusters at baseline Li-LPSCl interphase, corresponding distribution being visualized in FIG. 26. All five clusters display a new strong band at 417.7 cm⁻¹. Per previous reports, the 417.7 cm⁻¹ peak was associated with PS₄³⁻ (ortho-thiophosphate) ion unit of the Li₃PS₄ byproduct, originating from chemical decomposition of the LPSCl induced by Li metal.^{[13, 42]} The SSE decomposition degree can be quantified by the peak area ratio of Li₃PS₄ to Li₆PS₅Cl (termed S_{LPS}/S_{LPSCl}). Thereinto, the first cluster represents the argyrodite electrolyte with slight decomposition (S_{LPS}/S_{LPSCl}=0.28). The other four clusters display more Li₃PS₄ byproduct distribution (S_{LPS}/S_{LPSCl} values equal to 0.68, 0.53, 1.60, and 0.73 for cluster 0, cluster 2, cluster 3, and cluster 4, respectively). FIGS. 24C and 24D display the intensity distribution of Li₆PS₅Cl solid electrolyte (peak A) and Li₃PS₄ byproduct (peak B) among the Li-LPSCl, with the color bar representing the abundance of each chemical group. The electrolyte decomposition took place not only at the immediate Li-LPSCl interface (FIGS. 27 and 28), but it also occurred within the bulk LPSCl up to 100 m away. Moreover, the distribution of Li₃PS₄ byproduct was quite heterogeneous. These observations further demonstrate that the baseline Li-LPSCl interphase was electrochemically and geometrically unstable.

Experimental Details. Raman spectroscopy experiments were conducted on a confocal Raman spectrometer (Horiba, Xplorer 638 nm, long working distance objective=50×, a grating with 2400 grooves/mm, numerical aperture (N.A.)=0.4, local power<500 μW). The laser spot diameter was estimated to be 1 μm. The scan region was set to 28×50 μm², with a 1 μm²/pixel step size. The integration time was set to 1 second for each point. Autofocus mode was applied at each step to assure consistent focus on sample surface. The samples for Raman mapping test were obtained by having the symmetric cells with Li or Li₂Te@Li foils rest for 30 days at the open-circuit voltage without external pressure, and then dissembling the laminated battery in an inert Ar atmosphere glove box. All Raman mappings were analyzed using Horiba Labspec 6 imaging and spectroscopy software and the K-means clustering algorithm integrated into the Scikit-learn platform with a previously reported similar method.^{[1]} Briefly, this method is to partition the total number (denoted as n) of Raman spectra (x₁, x₂, x₃ . . . xₙ) within the Raman mapping into K sets (K≤n), to minimize the sum of squares within-cluster, defined by the objective function, J as

$$J = arg min {\sum }_{i - 1}^{k} {\sum }_{x ∈ {S}_{i}} {‖ x - {c}_{i} ‖}^{2} \qquad ( 1 )$$

Here ci is the mean of points (or centroid).[2] It serves as the cluster spectrum in the K set, Sᵢ. The value of the centroid is updated iteratively,

$${c}_{i}^{new}$$

based on:

$${c}_{i}^{new} = \frac{1}{\vert {S}_{i} \vert} {\sum }_{x ∈ {S}_{i}} {x}_{j} \qquad ( 2 )$$

Consequently, the total number of n spectra can be categorized into several clusters with similarities. The centroid spectrum of each cluster can then represent the characteristic features of all spectra in that category coded by a certain number.

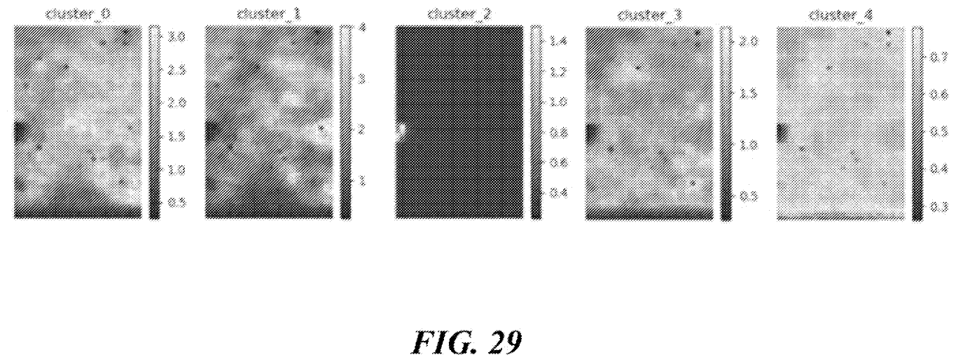

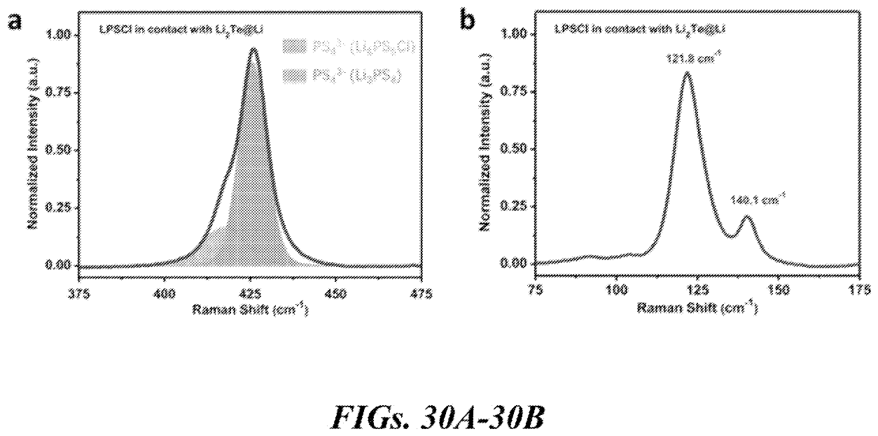

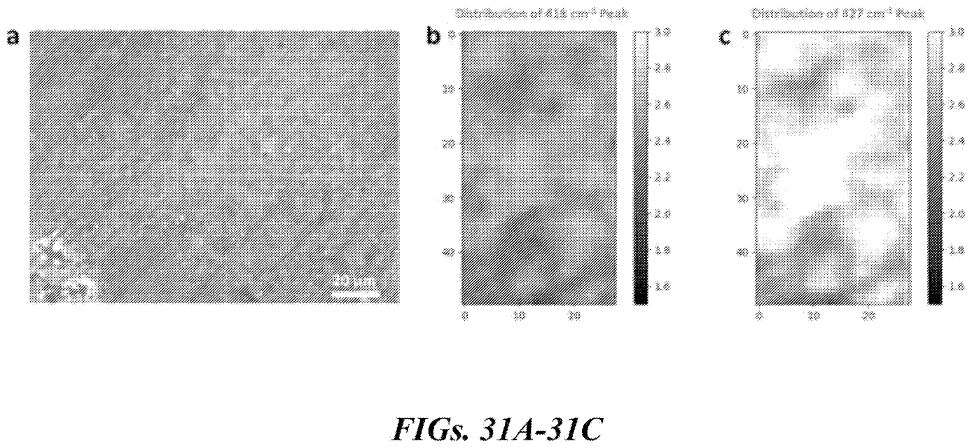

In sharp contrast, after the open-circuit resting period, the Li₂Te@Li-LPSCl interphase did not show distinguishable reaction products. Per FIG. 25B, the spectra of all clusters exhibit the P—S stretching of Li₆PS₅Cl. Per FIG. 25D, the corresponding intensity distribution was largely homogeneous. According to FIGS. 25C and 29, there was a small group of spectra (Cluster 2) which displayed two distinguished peaks between 100 and 150 cm⁻¹, belonging to Li₂Te.^{[43]} It is contemplated that the peaks may stem from a small flake of Li₂Te relocating from the interface to LPSCl bulk during sample preparation. According to FIGS. 30A-30B and 31A-31C directly at the Li₂Te@Li-LPSCl interphase there was relatively minor and generally uniform decomposition, in strong contrast to the large-scale reaction products that are formed without the interlayer.

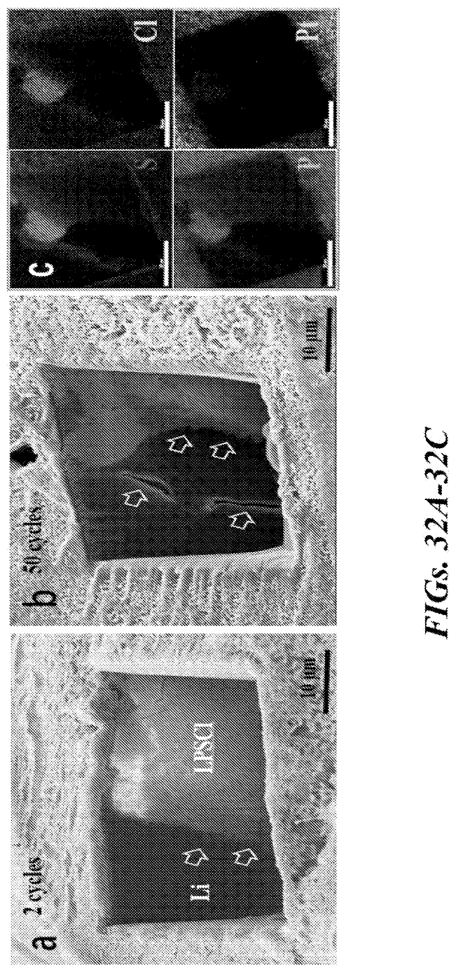

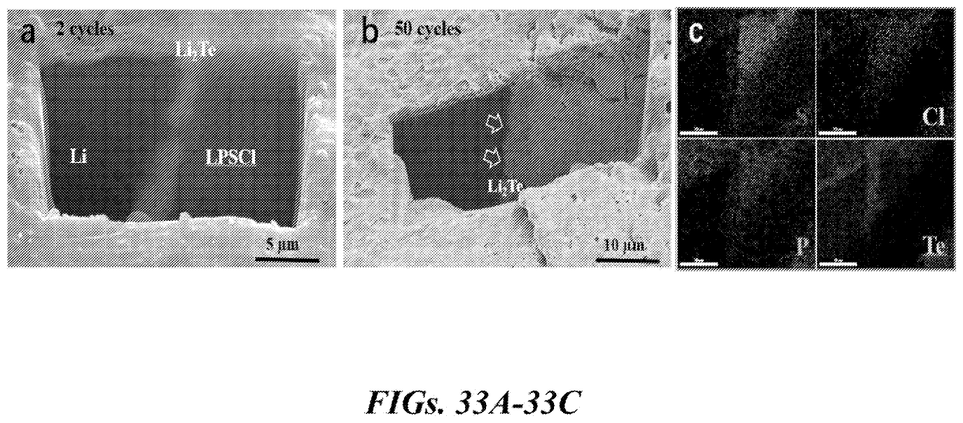

Focus ion beam (FIB) cross-sectional SEM was employed to analyze the interphases of the symmetric cells after two and after 50 cycles at 0.5 mA cm⁻² and 0.5 mAh cm⁻². FIGS. 32A-32C represent this cryo-electron tomography analysis, along with the associated EDXS results. Key features of the interphases are marked by open arrows in the figures, with the Li, LPSCl and Li₂Te layers being labeled. FIG. 32A presents baseline Li-LPSCl cryo-FIB cross-sections after two cycles. FIGS. 32B-32C present baseline Li-LPSCl cross-sections and EDXS maps after 50 cycles. FIGS. 33A-33C show the same analysis for Li₂Te@Li-LPSCl. It may be observed that even after two cycles, the baseline Li-LPSCl was already undergoing decomposition, the two arrows in FIG. 32A point to where the SSE reacted layer actually extended into the Li metal. By the 50^{th} cycle, the Li-LPSCl interphase was highly decomposed and geometrically uneven, with arrows highlighting the reaction layer position as well as the presence of large voids in the Li metal. After 50 cycles in this case, the reaction layer had advanced into the SSE, creating a curved interface between the Li and the LPSCl. It is known that an uneven interface can further cause inhomogeneous charge distribution, uneven ionic flux, and local preferential growth of metal dendrites followed by short circuits.^{[36]} However from these images there was little evidence of pristine Li metal filaments (dendrites) extending into the SSE. This implies that the short-circuit failure that was observed for the baseline Li originates from the growing reaction layer having sufficient electrical conductivity, rather than from Li filaments per se. With the observed rapid SEI growth rates, the sample literally reacts all the way through from the anode to the counter electrode. There may be some unreacted Li in the Li₃P, Li₂S, LiCl, Li₃PS₄ composite SEI which boosts its electrical conductivity enough to cause short circuits. However, given the extreme reactivity of the Li-LPSCl interphase, classical metal dendrites were unlikely. Voids were reported at the Li—Li₆PS₅Cl interface to originate from Li being stripped faster than it was replenished.^{[12c]} It is contemplated that ongoing Li-LPSCl reactivity may be another source of Li depletion, leading void growth with cycling. By contrast, the Li₂Te@Li-LPSCl interphase was unexciting, remaining planar and well-defined after 50 cycles. No voids in the Li are observed.

Computational Study Methods. The chemical stability of the interfaces between the Li anode, argyrodite SSE, and Li₂Te interlayer was assessed by calculating the Gibbs free energies (ΔG_{r×n}) of possible reactions between the two phases at each interface:

$$Δ {G}_{rxn} = {\sum }_{i} {x}_{i}^{p} {E}_{i}^{p} - {\sum }_{j} {x}_{j}^{r} {E}_{j}^{r} \qquad ( 3 )$$

where

$${E}_{i}^{p} and {E}_{j}^{r}$$

denote formation energies of product and reactant phases, respectively.^{[3]} The mole fractions of the product

$$( {x}_{i}^{p} )$$

and reactant

$$( {x}_{j}^{r} )$$

phases were chosen to ensure stoichiometric balance. Formation energies calculated using density functional theory (DFT) were obtained from the Materials Project database, and reaction energies were calculated using the associated Interface Reactions analysis tool.

All DFT calculations in this work were performed using the Vienna Ab initio Simulation Package (VASP). The crystal structures of bulk Li, Li₂Te, and Li₃P were calculated by minimizing the electronic energy with respect to the lattice vectors and atomic positions. The exchange-correlation contribution to the energy was calculated using the functional of Perdew, Burke, and Ernzerhof (PBE). Core electrons were simulated using the projector-augmented wave method, with valence electron configurations of 1 s²2s for Li, 3s²3p³ for P, and 5s²4d¹⁰5p⁴ for Te. All calculations were performed using a plane wave cutoff energy of 600 eV and k-point grids of 10×10×10 for Li, 4×4×4 for Li₂Te, and 4×4×4 for Li₃P.

The band gaps of bulk Li₂Te and Li₃P were calculated using the GW approximation to the many-body perturbation theory, as implemented in VASP. We employed both the single-shot approach (G₀ W₀) and the eigenvalue self-consistent approach (GW₀). Initial DFT wave functions were calculated using either the PBE or the Heyd-Scuseria-Ernzerhof (HSE06) hybrid exchange-correlation functional.^{[8′]} For each system, the number of conduction bands and the number of frequency grid points were increased until band energies converged to within 0.1 eV. The Brillouin zone was sampled using 4×4×4 and 6×6×6 Γ-centered k-point meshes for Li₂Te and Li₃P, respectively.

Interfaces were constructed from low-energy surfaces of Li and Li₂Te. The lowest-energy surfaces of Li were previously determined to be (100), (110), and (111), with energies of 0.48, 0.51, and 0.56 J m⁻², respectively. We calculated the energies of Li₂Te surfaces, using supercells containing slabs at least 28 Å thick with at least 12 Å of vacuum. The Brillouin zone was sampled using 4×4×1 k-point grids, and slab structures were relaxed to obtain the final slab energy, E_{slab}. Surface energies σ of stoichiometric surfaces were calculated as

$$σ = \frac{1}{2 A} ( {E}_{slab} - N {E}_{bulk} ) \qquad ( 4 )$$

where N is the number of atoms in the slab, E_{bulk} is the energy per atom of the bulk material, as calculated using DFT, and A is the surface area of the slab within the simulation cell. Upper and lower bounds for the energies of non-stoichiometric surfaces were calculated according to the procedure described in ref.^{[10′]} The lowest-energy surfaces of Li₂Te were determined to be (110) and Li-terminated (111). The energies of these two surfaces are significantly less than those of the other surfaces we considered, so only these two surfaces were considered in subsequent calculations.

Interface structures with commensurate lattice vectors were constructed using the Interface Builder tool in QuantumATK, version 2022.03. The Li₂Te surface was not strained, as its bulk modulus is greater than that of Li. All simulation cells used in this work have strains of less than 3%. Interfaces were constructed to have mirror symmetry along the out-of-plane direction in order to minimize spurious dipole effects.

The energy of the resulting structure was then minimized according to a four-step procedure. First, the ground-state energy was minimized by rigidly varying the interfacial separation between the two slabs. Second, the two slabs were rigidly shifted relative to each other in the interfacial plane to calculate a γ-surface, and the lowest-energy structure was identified. Structures for these first two minimization steps were generated using the ARTEMIS software. Third, simulated annealing was performed by performing an ab initio molecular dynamics simulation and linearly decreasing the temperature from 400 K to 0 K in 300 steps. A final energy minimization was then performed by relaxing the atomic positions and simulation cell vectors. In all energy minimization calculations, the Brillouin zone was sampled using a single k-point at F, while the final energies of the resulting interface structure and their constituent slabs were calculated using a 2×2×1 sampling of the Brillouin zone.

Four interfacial properties were calculated from the energy E_{Li/Li}_{₂}_{Te} of each final interface structure. The formation energy E_{F} is the energy (per atom) required to form the interface from the bulk phases of each of its constituents:

$${E}_{F} = \frac{1}{{N}_{Li} + {N}_{{Li}_{2} Te}} ( {E}_{Li / {Li}_{2} Te} - {N}_{Li} {E}_{Li}^{bulk} - {N}_{{Li}_{2} Te} {E}_{{Li}_{2} Te}^{bulk} ) \qquad ( 5 )$$

where N_{Li} and N_{Li}_{₂}_{Te} denotes the number of atoms in the Li and Li₂Te slabs comprising the interface, respectively.

$${E}_{Li}^{bulk} and {E}_{{Li}_{2} Te}^{bulk}$$

denote the energies per atom of the bulk Li and Li₂Te phases, respectively. The interfacial energy γ is defined similarly, except it does not include the strain energies of the constituent slabs:

$$γ = \frac{1}{2 A} ( {E}_{Li / {Li}_{2} Te} - {N}_{Li} {E}_{Li ( c )}^{bulk} - {N}_{{Li}_{2} Te} {E}_{{Li}_{2} Te ( c )}^{bulk} ) \qquad ( 6 )$$

Here,

$${E}_{Li ( c )}^{bulk} and {E}_{{Li}_{2} Te ( c )}^{bulk}$$

are the energies per atom of bulk Li and Li₂Te structures, respectively, in which the lattice vectors parallel to the specified surface have been strained according to the strain in the interface, and all other degrees of freedom have been relaxed. Because this property excludes the strain energy, it is a direct measure of the strength of the chemical bonds at the interface relative to bonds in the bulk phases. The excluded strain energy is given as:

$$ζ = {E}_{F} - \frac{2 A γ}{{N}_{L i} + {N}_{L {i}_{2 T e}}} \qquad ( 7 )$$

The work of adhesion W_{ad} is calculated as:

W_{ad}=σ_{Li}+σ_{Li}_{₂}_{Te}−γ_{Li/Li}_{₂}_{Te} (8)

where σ_{Li} and σ_{Li}_{₂}_{Te} denote the energies of Li and Li₂Te surfaces, respectively, with the same surface termination and strain as in the interface. The work of adhesion is related to the interfacial wetting angle θ by the Young-Dupré equation:

W_{ad}=σ_{Li}(1+cos θ) (9)

Electrochemical-transport Model. The governing equation for ion transport through the SEI is given as follows:

∇·(k_{SEI}∇φ_{SEI})=0 (10)

Here, k_{SEI} is the ionic conductivity of the SEI, and φ_{SEI} is the electric potential in SEI. Constant applied current is given as the boundary condition at the top of the solid electrolyte, whereas the Butler-Volmer reaction current (i_{BV}) is given as boundary condition at the Li-SSE interface, which can be expressed as follows:

$${i}_{BV} = {i}_{0} ( exp ( \frac{F η}{2 RT} ) - exp ( - \frac{F η}{2 RT} ) ) 0 \qquad ( 11 )$$

Here, i₀ is the exchange current density, F is the Faraday's constant, R is the universal gas constant, T is the temperature, and η is the overpotential.

Mechanics Model. To estimate the stresses in the SSE and Li metal, mechanical equilibrium is solved for which the governing equation is:

∇·σ=0 (12)

In the elastic regime, the linear elastic stress-strain constitutive relation is given as follows:

$${σ}_{ij} = 2 G {ε}_{ij} + \frac{2 vG}{1 - 2 v} {ε}_{kk} {δ}_{ij} \qquad ( 13 )$$

Here, G is the shear modulus, εᵢⱼ denotes the strain, v is the Poisson's ratio, and δᵢⱼ denotes the Kronecker delta function. To incorporate the plastic deformation of Li, the plasticity model has been adapted from Barai et al.

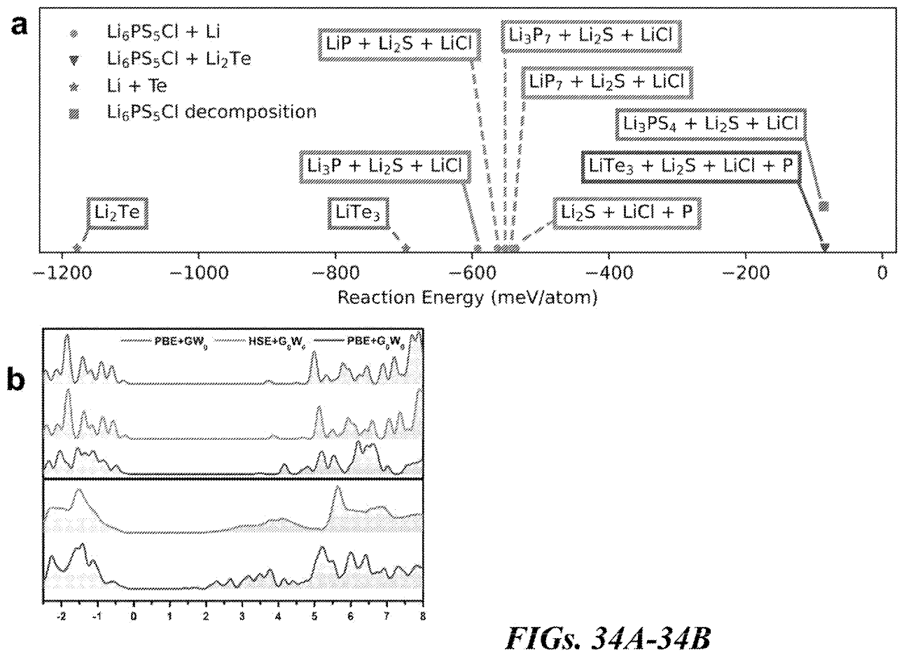

Computational Study Results. Density Functional Theory (DFT) was employed to assess the chemical stability of the interfaces between the Li, Li₂Te and LPSCl. Reactions between Li and Te are highly exergonic, with Li₂Te as the most stable product (ΔG=−1178 meV/atom). The chemical stability of the Li-LPSCl interface was then assessed with and without the Li₂Te interlayer. FIG. 34A indicates that LPSCl was more thermodynamically stable with respect to reaction with Li₂Te than to reaction with Li. The reaction between LPSCl and Li₂Te was only slightly exergonic (ΔG_{r×n}=−84 meV/atom). The reactions between the SSE and Li were more exergonic, with associated reaction energies ranging from −530 to −600 meV/atom. The most exergonic reaction pathway finally yields Li₃P, Li₂S, and LiCl, in accordance with experimental observations and prior literature.^{[12b′, 38′]} Introducing the Li₂Te interlayer kinetically prevented these reactions from occurring. Decomposition of the SSE was slightly exergonic (ΔG_{r×n}=−86 meV/atom) and yields the product phases Li₃PS₄, Li₂S, and LiCl, as noted previously.^{[12d′, 13′, 44′]}

Next the electronic properties of the phases were evaluated, as shown in FIG. 34B. Based on DFT band gaps reported in the Materials Project database,^{[45]} it was surmised that Li₃P has the smallest band gap of all the reaction products at the Li/SSE interface. Phases at the interface with small band gaps can conduct electricity, thereby facilitating further reduction of the SSE and potentially causing electrical shorting. The band gaps of Li₃P and Li₂Te were calculated within the GW approximation. GW band gaps of Li₂Te range from 3.78 eV to 4.11 eV, while band gaps for Li₃P range from 1.71 eV to 2.04 eV. These results indicate that Li₂Te was more electronically insulating than Li₃P and therefore better able to prevent reduction of the SSE. This finding was consistent with previous DFT calculations.^{[10a′]} Although bulk materials with band gaps of this size are generally considered semiconductors or insulators, Li₃P particles within the SEI may have smaller grain sizes and interact with other SEI components, which may further reduce their band gaps and make them more conductive.

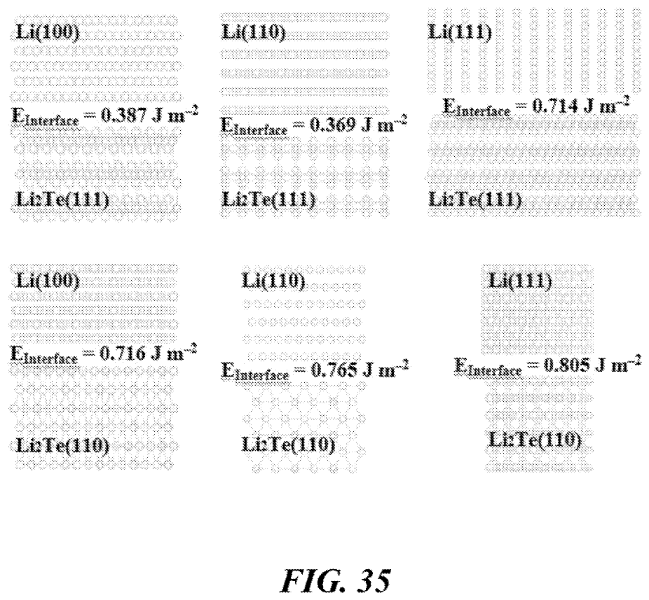

Thirdly, the wetting behavior and interface energy between Li and Li₂Te was considered. Six interfaces are presented in FIG. 35 and Table 3. The associated wetting angles are slightly greater than 90°, indicating that Li₂Te is neither strongly lithiophilic nor lithiophobic. These results support the experimentally-verified conclusion that that the Li₂Te layer acts as an artificial SEI rather than a lithiophilic template for Li growth. Li (111)-Li₂Te (110) and Li (110)-Li₂Te (110) interfaces display high interfacial energies of 0.805 J m⁻² and 0.765 J m⁻², greater than the reported interface energy values of L₆PS₅Cl (−1.216 J m⁻²), Li₂S (0.316 J m⁻²), and Li₃P (0.455 J m⁻²) against Li metal.^{[32′,33′]} It has been argued previously that a high interfacial energy (γ) of the SEI will suppress Li penetration into the SSE.^{[10a′, 32′,33′, 46′]} The current modeling and experimental results further strengthen this conclusion.

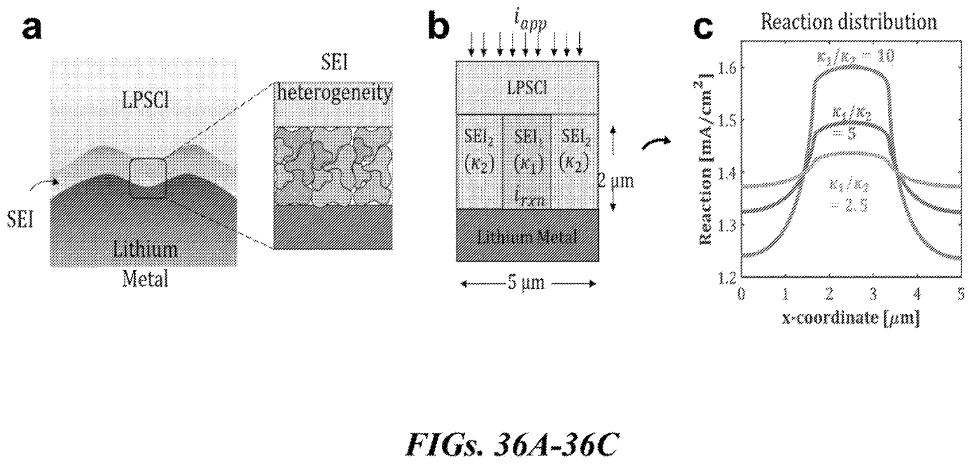

The decomposition of the SSE at the Li-LPSCl interface results in the formation of byproducts such as Li₂S, Li₃P and LiCl. As observed in FIGS. 24A-24D, 25A-25D, 32A-32C, and 33A-33C, the heterogeneous distribution of these decomposition products (FIG. 36A resulted in nonuniform ionic transport through the SEI, leading to heterogeneities in reaction current at the Li-SSE interface. Moreover, the decomposition products exhibited distinct ionic conductivities.^{[47]} For instance, the ionic conductivity reported for Li₃P was around 10⁻⁴ S/cm, whereas for Li₂S and LiCl, the ionic conductivity values were much lower (approximately 10⁻⁵ S/cm).^{[47-48]}

TABLE 3
Properties of different Li—Li₂Te interfaces.

| | | | | Interface | | | | | |
|---|---|---|---|---|---|---|---|---|---|
| | Work of | | Contact | Formation | | Interfacial | | Strain | |
| | Adhesion | | Angle | Energy | | Energy | | Energy | |
| Li (100) \| Li₂Te (111, | 0.304 | J/m² | 111.5° | 4.55 | kJ/mol | 0.387 | J/m² | 0.019 | kJ/mol |
| Li-terminated) | | | | | | | | | |
| Li (110) \| Li₂Te (111, | 0.370 | J/m² | 105.9° | 3.64 | kJ/mol | 0.369 | J/m² | 0.043 | kJ/mol |
| Li-terminated) | | | | | | | | | |
| Li (111) \| Li₂Te (111, | 0.431 | J/m² | 103.3° | 3.53 | kJ/mol | 0.714 | J/m² | 0.205 | kJ/mol |
| Li-terminated) | | | | | | | | | |
| Li (100) \| Li₂Te (110) | 0.424 | J/m² | 96.7° | 3.91 | kJ/mol | 0.716 | J/m² | 0.0592 | kJ/mol |
| Li (110) \| Li₂Te (110) | 0.505 | J/m² | 90.6° | 3.91 | kJ/mol | 0.765 | J/m² | 0.609 | kJ/mol |
| Li (111) \| Li₂Te (110) | 0.467 | J/m² | 99.6° | 4.07 | kJ/mol | 0.805 | J/m² | 0.0418 | kJ/mol |

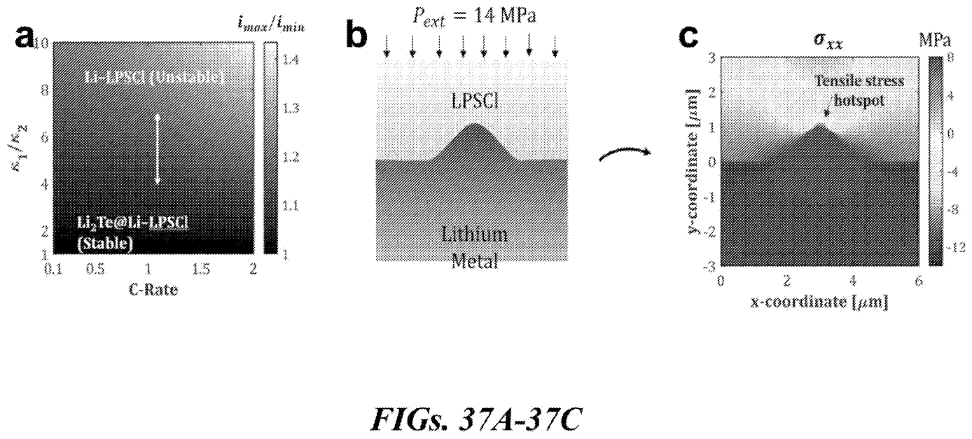

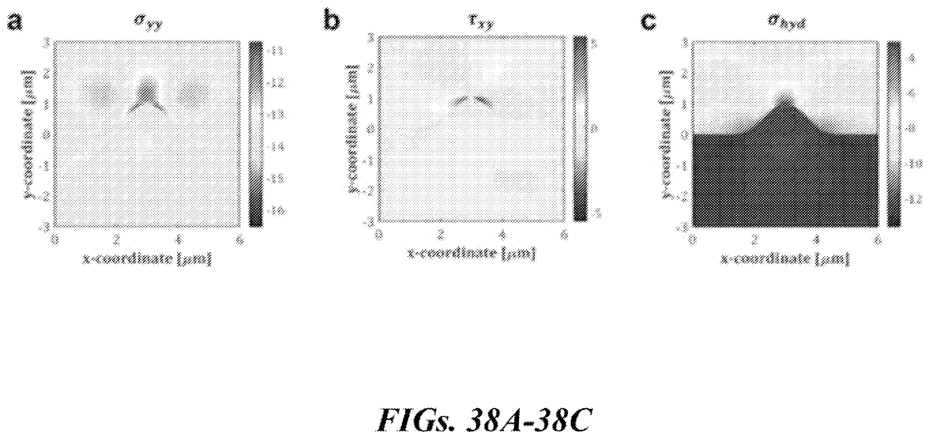

To study the effect of SEI heterogeneity, the developed model (described in Computational Details section) captured the ionic transport through the SEI coupled with the reaction kinetics at the interface. As shown in FIG. 36B, a region at the interface vicinity consisting of two different SEI constituents (SEI₁ and SEI₂) having ionic conductivities K₁ and K₂, respectively. The ionic conductivity of SEI₁ (middle region shown in FIG. 36B) was taken to be 10⁻⁴ S/cm, whereas the ionic conductivity of SEI₂ (right and left region of the SEI) is varied between 10⁻⁵ S/cm and 10⁻⁴ S/cm. FIG. 36C shows the corresponding reaction distribution at the Li-SSE interface for different values of ionic conductivity ratio, θ=κ₁/κ₂. As seen from FIG. 36C, the SEI heterogeneity significantly altered the reaction distribution; enhancement in the heterogeneity descriptor translates to higher nonuniformities in the reaction distribution. FIG. 37D shows the combined effect of SEI heterogeneity and current density on the reaction heterogeneity. Here, reaction heterogeneity is described as the ratio of the maximum and minimum reaction at the Li-SSE interface. With higher SEI heterogeneities, the effect of current density becomes more pronounced, leading to a higher propensity for non-uniform lithium deposition at the interface. The formation of such uneven deposition profiles generated tensile stress hotspots along the x-direction (as shown in FIGS. 37A and 37B), which were critical in determining fracture of the SSE and further cell failure due to short circuit.^{[49]} The corresponding stress profiles along the y-direction and shear direction are presented in FIGS. 38A and 38B. On the other hand, for the Li₂Te@Li-LPSCl interface, as Li₂Te layer prevents decomposition of the SSE and contributes to a homogenous SE, stable deposition is favored.

Discussion Approaches for directly tuning the metal-SSE interface include coating secondary passivation layers directly onto the sulfide electrolytes, such as LiF/Li₃N/Cu,^{[24]} LiPON,^{[25]} and poly(ethylene oxide)/LiTFSI-based solid polymer electrolyte.^{[26]} Alternatively Li metal may be directly coated with these interfacial layers, including (Propylene carbonate)-LiTFSI@Li,^{[27]} LixSiOy@Li,^{[28]} Ag—Li@Li,^{[14g]} Li₂Se@Li,^{[14f]} Li₃N/LiF@Li,^{[14e]} In/LiₓIn@Li,^{[29]} Li₃PO₄—Li₃N@Li,^{[30]} and LiI@Li^{[31]}. To function as ionically permeable interlayers, rather than secondary current collectors, the interlayers must display sufficient ionic conductivity but must be insulating electrically.^{[9a]} With sulfide SSEs, the interfacial layer approach generally is based on inserting inert barriers that minimally react with the Li metal or with the SSE. Phases such as LiF, Li₃N, Li₃PO₄, LiₓSiO_{y}, and Li₂Se are all in this category, being the thermodynamically terminal products of a reaction of Li and N, P, F, etc. Likewise, LIPON is considered electrochemically stable against Li metal anode, forming a self-passivating nanometer-scale trilayer of Li₃PO₄, Li₃N and Li₂O with Li metal.

The reactive interphase stabilization strategy pursued here exploits the physical and chemical properties of tellurene, which is not in equilibrium with alkaline metals. In this respect the strategy represents a significant departure from the established approach of purposely employing interlayers that are effectively inert relative to the metal and to the SSE. Tellurene (Te) is a two-dimensional allotrope of bulk tellurium that can be fabricated down to single monolayer thickness.^{[32]} Tellurene's extreme surface to volume ratio allows for coverage of large interfaces at relatively low mass loadings, and provide abundant sites for targeted chemical reactions. Moreover, tellurene has the advantage of being stable in ambient atmosphere and may be straightforwardly fabricated by hydrothermal techniques. Unlike other 2D materials such as graphene or boron nitride, tellurene is chemically and electrochemically reactive with Li metal. Our fabrication approach consists of first coating a conventional battery separator with tellurene and then mechanically rolling that surface against a Li metal anode. A thin (~1.3 mg cm⁻² loading) yet stable artificial solid electrolyte interphase (SEI) is created, which is ionically conductive and electrically insulating. In a single rolling pass the tellurene reacts with the Li to form a bilayer of thermodynamically equilibrium Li₂Te intermetallic (fcc antifluoride) and intermediate LiTe₃. Likewise, it is demonstrated that tellurene deposited on to the separator may be directly transferred to the LPSCl SSE to achieve a comparable stabilizing effect. During electrochemical testing, this bilayer SEI mitigates the decomposition of the SSE and prevents pore growth and dendrite formation in the Li metal. Based on a broad literature comparison the resultant interphase is among the most stable, both in terms of cycling lifespan and in terms of the critical capacity that is being plated/stripped. Through a combination of advanced analytical techniques and multiscale simulation, a mechanistic description of how such kinetic stabilization occurs was provided, as well as the reaction pathways by which the baseline unmodified Li-SSE interphase decomposes.

### Example 2. Anode-Free all-Solid-State Battery with W/Mg Bilayer

In this study it is demonstrated that electrochemical stability of anode-free all solid-state battery (AF-ASSB) based on Li₆PS₅Cl SE requires two key attributes: Lithium metal has to uniformly electrodeposit/dissolve on Cu current collector, while Li-SE and Cu-SE interfaces have to remain uncorroded. Microstructural control of two distinct naturally reactive interphases is achieved with physical vapor deposited (PVD, magnetron sputtering) bilayer of 140 nm magnesium/30 nm tungsten onto the collector surface (Mg/W—Cu). Magnesium promotes wetting by forming reversible Li—Mg solid solution and minimizes parasitic reduction of SE by Li, while W protects the Cu that otherwise irreversibly reduces SE (when in contact) to form copper sulfides. These features significantly influence the cycling stability during repeated Li electrodeposition/electrodissolution process. Consequently, half-cells Li|SE|Mg/W—Cu cell exhibit reduced overpotentials, smooth voltage profiles, and extended cycling stability over 600 hours at a current density of 1 mA cm⁻². When integrated into an AF-ASSB full cell with an NMC811 composite cathode, the Mg/W—Cu current collector contributes to improved cycling stability, showcasing an average CE above 99.5%. Employing a combination of cryogenic electron microscopy (cryo-EM) and X-ray photoelectron spectroscopy (XPS) analysis, this study provides new fundamental insights into the cycling behavior of current collectors with varying surface chemistries. This study explains the functionality of the Mg layer in promoting uniform Li metal electrodeposition/dissolution and consequently stabilizing the Li-SE SEI. In parallel it is demonstrated that the W layer is necessary to protect the underlying Cu current collector from parasitic reactions with the sulfur species in the SE.

Fabrication of modified current collectors. The current collectors, composed of Mg/W—Cu, Mg—Cu, and W—Cu were fabricated utilizing the physical vapor deposition (PVD) technique employing the “Orion-8” sputtering system by AJA Instruments. The deposition occurred within a turbo-pumped chamber, which was evacuated to a base pressure of less than 10⁻⁸ torr before commencement of any deposition process. The deposition utilized pure Mg (2.0″ diameter, 0.25″ thickness, 99.95% purity) and W (2.0″ diameter, 0.25″ thickness, 99.95% purity) as targets, both sourced from AJA Instruments. Radio Frequency (RF) magnetron sputtering mode was uniformly employed for all deposition processes. The target guns were connected to a water-cooled chiller, with ultrapure Argon serving as the carrier gas. Precise control of Argon gas flow rates, achieved through gas flow meter, was maintained at a standardized rate of 32 SCCM (SCCM denoting standard cubic centimeters per minute) for all depositions. A battery-grade square shaped copper sheet (5 cm×5 cm, 9 μm thickness, MTI Corporation, USA), was affixed to the rotating substrate holder of the instrumentation. This holder was mounted at a distance of 22 cm from the target. The gun energy was set to be 150 kWh for Mg sputtering and 200 kWh for W sputter and the film deposition rate was calibrated using quartz crystals monitor,

Li₆PS₅C/solid-electrolyte. Commercial argyrodite Li₆PS₅Cl SE was purchased from NEI Corporation, USA. To prepare wet ball milled SE, four grams of LPSCl SE was added to a 50 mL zirconia milling jar containing 20 zirconia milling balls (6 mm diameter). Then, 4.8 mL anhydrous m-xylene was added, and the milling jar was vacuum-sealed inside the glovebox. Wet ball milling was conducted on a planetary ball mill machine (PM100, Retsch) at a speed of 300 rpm for 24 hours. Finally, the electrolyte was obtained after drying in the glove box at 80° C. overnight. The XRD profiles in shown in FIG. 74A and the ionic conductivity at room temperature is calculated to be 0.8 mS cm⁻¹ under a pressure of 9 MPa, per FIG. 74B.

All-solid-state half-cells cells. 150 mg milled LPSCl SE powder was first pressed using a hydraulic press (YLJ-24TS, MTI Corporation, USA) under 50 MPa in a polyether ether ketone (PEEK) mold (12 mm in diameter). Then, a piece of current collector (Mg/W—Cu or Mg—Cu or W—Cu or Cu) foil (12 mm in diameter) was attached to one side of the pellet and subsequently pressed at 530 MPa for 1 min. Next, a piece of Li chip was sandwiched in a plastic bakery bag and rolled to a thickness of around 100 μm, and a piece of 8 mm diameter Li foil was attached to the other side of the pellet without compressing. Afterwards, the cell was positioned in the cell case and tightened using a torque wrench. A torque of 20 pounds in (corresponding to 9 MPa pressure) was employed, the pressure being measured using torque wrench with additional torque-pressure calibration being performed at Oak Ridge National Laboratory.

Anode-free all-solid-state batteries (AF-ASSBs). The composite cathode was prepared by hand mixing LiNbO₃-coated NMC811 cathode (NEI Corporation, USA) with SE powder at a weight ratio of 7:3 in a mortar for 40 minutes. When assembling the battery, 150 mg milled LPSCl SE powder was first pressed under 50 MPa in PEEK mold. Then the composite cathode powder was uniformly dispersed on one side of the SE pellet and a piece of current collector (Mg/W—Cu or Mg—Cu or W—Cu or Cu) foil was placed on the other side. The areal capacity of cathode is ~1 mAh cm⁻² for typical measurements and ~8 mAh cm⁻² for high mass-loading experiments. The entire cell was further pressed under 867 MPa for 1 min and finally positioned in the cell housing tightened to 30 pounds in with a torque wrench. The stack pressure was measured to be ~14 MPa.

Galvanostatic cycling was conducted on Land CT2001A battery testers. The current densities and capacities employed during testing are noted in the descriptions of the analyses and the captions of the associated figures. Electrochemical impedance spectroscopy (EIS) tests were recorded on a Princeton PARSTAT MC electrochemical workstation in the frequency range of 1 MHz-1 Hz with an amplitude of 10 mV. The obtained data was analyzed using the Z-View software. Ionic conductivity of SSEs was calculated based on the equation of σ=L/(R_{b}A), where L is the thickness of the electrolyte pellet, R_{b} is the bulk resistance of SSE, and A is the area of the SSE layer. All electrochemical measurements in this work were carried out at room temperature (~23° C.).

Room-temperature and cryogenic scanning electron microscopy (SEM) and focused-ion beam (FIB) SEM were both performed on a Thermo Scientific Scios 2 Dual Beam SEM/FIB with a Leica VCT cryogenic stage and energy dispersive X-ray spectrometer (EDXS). To preserve the structural integrity of the beam-sensitive Li-based materials and to reduce artificial inclusion, the sample was cooled to −150° C. The Ga⁺ FIB milling was performed at an accelerating voltage of 30 keV. X-ray diffraction (XRD) profiles were recorded on Rigaku Miniflex 600 diffractometer with Cu Kα radiation (λ=1.54178 Å) at a scan rate of 5° per minute within the 2θ range from 10° to 80°. X-ray photoelectron spectroscopy (XPS) analysis was performed on a customized XPS system based on a Hemispherical Energy Analyzer PHOIBOS 100 (SPECS Surface Nano Analysis GmbH) with Mg Kα as the excitation sources, the peaks were deconvoluted using CasaXPS software. Depth profiling analysis of the samples were collected on a time-of-flight secondary ion mass spectroscopy (TOM-SIMS) on an M6 TOF-SIMS instrument produced by ionTOF GmbH (Germany, 2023). A Bi⁺ analysis ion beam (30 keV ion energy, ~0.5 pA measured sample current), raster scanning 100 μm×100 μm areas, was used to produce secondary ions that were further detected through a time-of-flight analyzer, while an O²⁺ sputtering ion beam (1 keV ion energy, ~41 nA measured sample current) was used to ablate the surface in 300 μm×300 μm areas centered around the Bi⁺ analysis areas. All detected ions had positive polarity, with an ultra-high mass resolution better than 15,000 (m/dm). The measurements were performed in an ultra-high vacuum at a base pressure of ~10¹⁰ mbar. All post-cycled electrodes were extracted from disassembled cells in an Ar-filled glovebox (<0.1 ppm of H₂O and O₂).

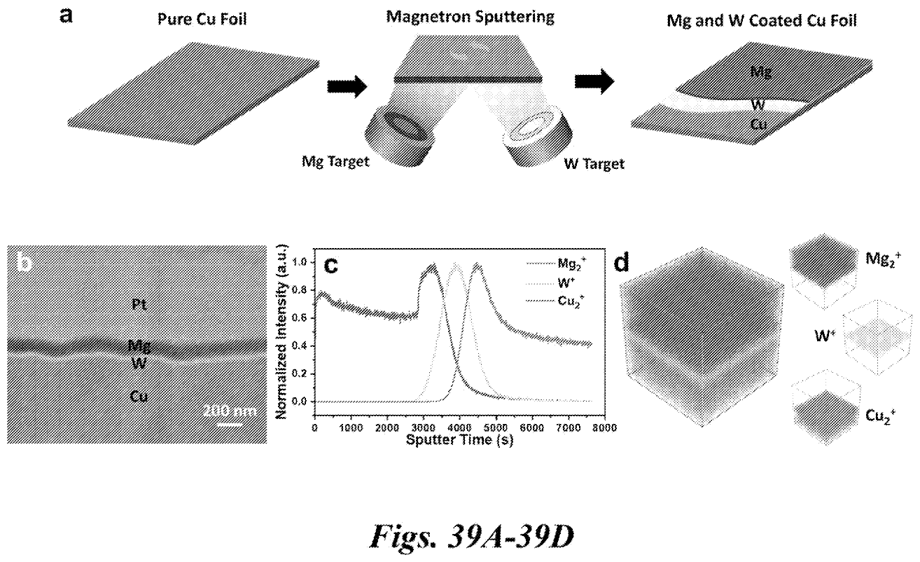

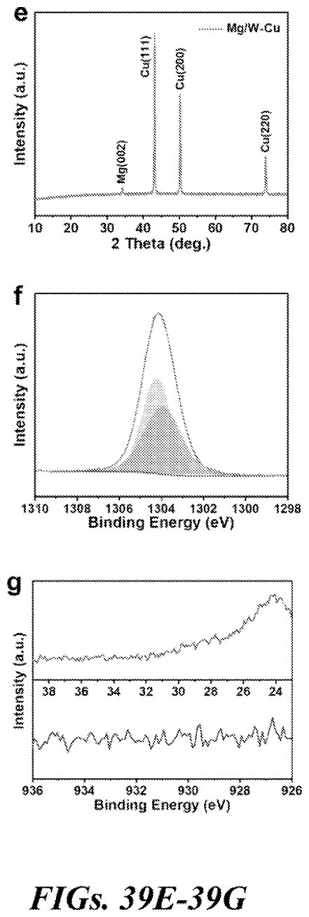

Bilayer magnesium tungsten coated copper current collector (Mg/W—Cu) was fabricated by physical vapor deposition (PVD, magnetron sputtering) and the schematic illustration is shown in FIG. 39A. A battery-grade copper foil (5 cm×5 cm, 9 μm thickness) served as the substrate, which was mounted onto a holder and subsequently transferred into the sputtering chamber and evacuated to a base pressure below 10⁻⁸ torr. Pure Mg and W metal disks with a diameter of 2 inches and a thickness of 0.25 inch were used as the targets. A layer of W followed by a layer of Mg was successively deposited onto the Cu collector foil with the sputter rate calibrated using a quartz crystal monitor. The W layer interfaced the Cu, while the Mg layer would interface with the SE when joined in a cell. For comparison, magnesium-coated copper foil (Mg—Cu) and tungsten-coated copper foil (W—Cu) were prepared using a similar approach.

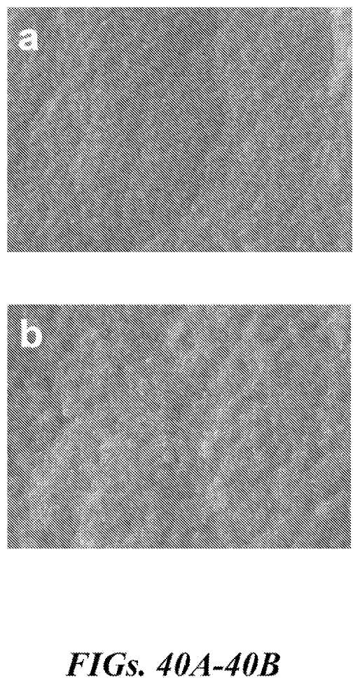

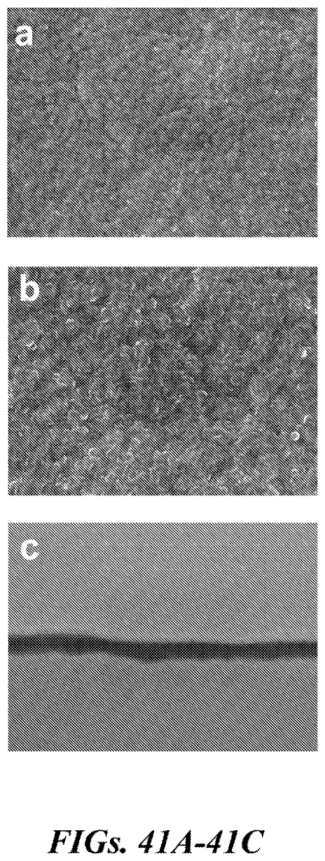

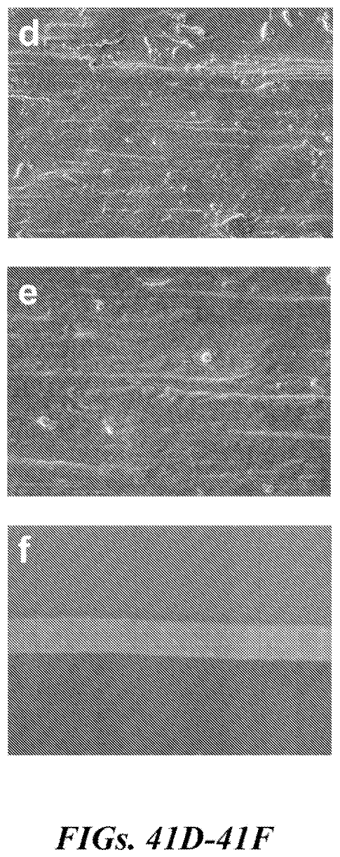

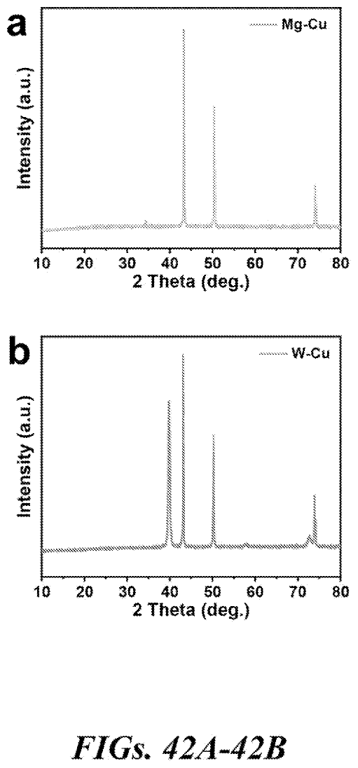

The top down scanning electron microscopy (SEM) and cross sectional focused-ion beam (FIB) SEM analysis of Mg/W—Cu, Mg—Cu, and W—Cu samples are presented in FIG. 39B, FIGS. 40A-40B, and FIGS. 41A-41F. FIGS. 39C and 39D showcase the topological information of the Mg/W—Cu sample using time-of-flight secondary ion mass spectroscopy (TOF-SIMS). FIGS. 39E and 42A-42B compare the X-ray diffraction (XRD) profiles of Mg/W—Cu, Mg—Cu, and W—Cu. FIGS. 39F and 39G show the high-resolution X-ray photoelectron spectroscopy (XPS) spectra of Mg 1s, W 4f, and Cu 2p for Mg/W—Cu. FIGS. 39B, 41C and 41F provide the cross-sectional images of Mg/W—Cu, Mg—Cu, and W—Cu, respectively. An approximately 1 μm thickness platinum (Pt) layer was deposited using the gas injection system (GIS) and cured with a Ga-ion beam prior to ion milling to protect the surface from beam damage. The measured thickness was ~140 nm for the sputtered Mg layer and ~30 nm for the sputtered W layer in the Mg/W—Cu sample. The images were captured using an ion conversion and electron (ICE) detector in secondary electron (SE) mode, where heavy elements typically exhibit a brighter contrast compared to light elements due to the emission of more backscattered electrons. Consequently, the Mg layer appears darker than the Cu substrate while the W layer appears brighter. The thicknesses of Mg layer and W layer in the Mg—Cu and W—Cu specimens are measured to be ~160 and ~260 nm, respectively. To further elucidate the bi-layer structure of the Mg/W—Cu sample, FIG. 39C shows the TOF-SIMS depth profile, displaying the signals of three representative species: Mg²⁺, W⁺, and Cu²⁺. During the initial 2850 seconds of sputtering, only Mg²⁺ signal can be detected. Subsequently, the W⁺ signal emerges and followed by the appearance of the Cu²⁺ signal after 3500 seconds. The sudden increase of Mg²⁺ intensity at the Mg/W interface is likely associated with the ionization probability during the Bi⁺ beam sputtering due to the electron work function difference: 3.7 eV for Mg versus 4.6 eV for W.^{[60-61]} FIG. 39D shows a 3D rendering of the selected species representing Mg, W, and Cu, indicating the uniform deposition of Mg and W to form the bi-layer structure. It should be noted that per the equilibrium phase diagram the Mg and the W possess minimal miscibility. Sputtering Mg onto the W layer could introduce some non-equilibrium mixing at the atomic scale. However, it should be low since W (183.84 u) is much heavier than the Mg (24.305 u) and is not expected to be re-sputtered during the Mg deposition.

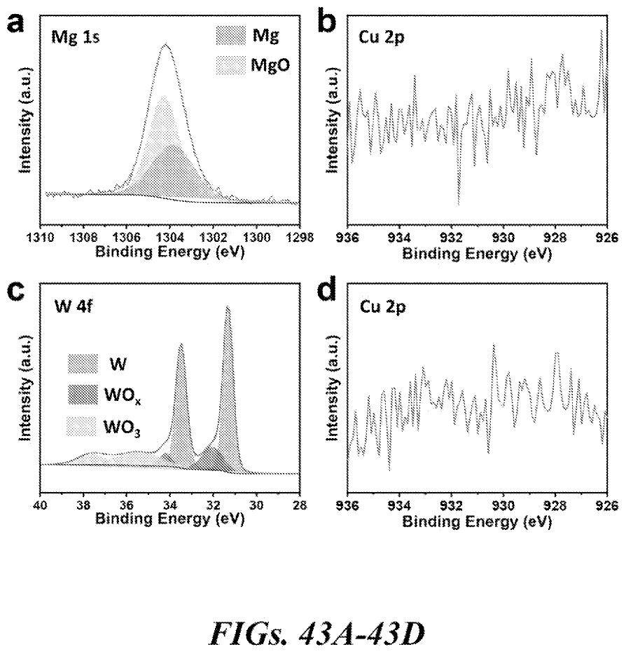

The top-down SEM images of Mg/W—Cu, Mg—Cu, and W—Cu are provided in FIGS. 40A-40B, 42A-42B, and 42D-42E, respectively. The surfaces of Mg/W—Cu and Mg—Cu display a morphology dictated by the hexagonal shaped Mg crystals. Both the Mg/W—Cu and Mg—Cu surfaces exhibit homogeneously distributed hexagonal Mg grains with lateral dimensions ranging from 200 to 300 nm. By contrast, the surface of the W—Cu sample was dense, relatively planar, and without discernible crystallites. This was expected since Mg should undergo grain growth during sputter deposition while the refractory W will remain nanocrystalline due to its low diffusivity. X-ray diffraction (XRD) measurements were performed to analyze the crystal structure of the coating layers, and the results are presented in FIGS. 39E and 43A-43D. All samples exhibited diffraction peaks at 43.3°, 50.43°, and 74.13°, corresponding to the (111), (200), (220) reflections in fcc Cu (a=0.3615 nm, #04-0836) with Fm-3m space group. An additional peak at 34.4° was observed for the Mg—Cu sample, which was attributed to the (002) reflection in hcp Mg (a=3.2096 nm, c=5.2112 nm, #35-0821) with P63/mmc space group. This agrees with the hexagonal grain morphology of the Mg films, with (001) basal plane of the crystallites being parallel to the substrate surface and [100] and [010] being the fast growth directions. Such film growth kinetics are well-known for hexagonal metals such as Mg and Zn. For the W—Cu sample, three additional peaks occurred at 40.26°, 58.27°, and 73.2°, which were ascribed to the (110), (200), and (211) planes of bcc W (a=3.1648 nm, #04-0806) with Im-3m space group. The Mg/W—Cu sample only displays the Bragg peak at 34.4°, corresponding to (002) plane of Mg. The absence of W diffraction peaks was due to the 30 nm thickness, where the scattered intensity fell below the detection limit of the benchtop XRD instrument. Additionally, the mean grain size of the 30 nm film was expected to be finer than that of the 260 nm W—Cu film, causing more peak broadening and making it more difficult to detect above the background.

X-ray photoelectron spectroscopy (XPS) analysis was conducted to investigate the surface chemistry of Mg—W/Cu, Mg—Cu, and W—Cu. FIG. 3F shows the high-resolution Mg 1s spectrum, revealing two distinct peaks. The peak at 1303.9 eV is attributed to Mg metal while the peak at 1304.3 eV is ascribed to the native MgO layer spontaneously formed on the surface. Magnesium oxide was thermodynamically stable with an enthalpy of formation of—601.6 kJ mol-1, making it an effective self-passivating layer. At ambient conditions surface growth of MgO effectively ceases once 2-3 nm thickness is reached. FIG. 39G presents the high-resolution W 4f and Cu 2p spectra of the Mg—W/Cu sample. No characteristic peaks for either element was observed, indicating the absence of both W and Cu on the sample surface. This observation aligns with the TOF-SIMS analysis results. Surface XPS analysis for Mg—Cu is provided in FIGS. 43A and 43B. Both Mg and MgO were detected while representative Cu signals were absent. The results for W—Cu are illustrated in FIGS. 43C and 43D. The W 4f spectrum of W—Cu exhibited three doublets of peaks, corresponding to tungsten metal (31.3 and 33.5 eV for 4f_{7/2} and 4f_{5/2}), tungsten suboxide (WOₓ, 32.0 and 34.2 eV for 4f_{7/2} and 4f_{5/2}), and tungsten oxide (WO₃, 35.5 and 37.7 eV for 4f_{7/2} and 4f_{5/2}), respectively. Notably, the Cu signal was absent on the W—Cu surface. These findings confirm uniform metal deposition for the bilayer and both the single layers.

Electrochemical measurements were performed using polyether ether ketone (PEEK) cells with a two-electrode configuration. The working electrodes included Mg/W—Cu, Mg—Cu, W—Cu, and as another baseline an unmodified Cu current collector. As a reference and counter electrode, an approximate 100 μm Li metal disk with a diameter of 8 mm was employed. A ball-milled argyrodite-type Li₆PS₅Cl solid-state electrolyte (SE) was used as the separator. The electrochemical experiments were performed at room temperature and a stack pressure of approximately 9 MPa. This stack pressure was on the lower end of the range reported in previous ASSB studies, either with Li foils or with Si anodes, with up to 20 MPa being employed.^{[62-64]}

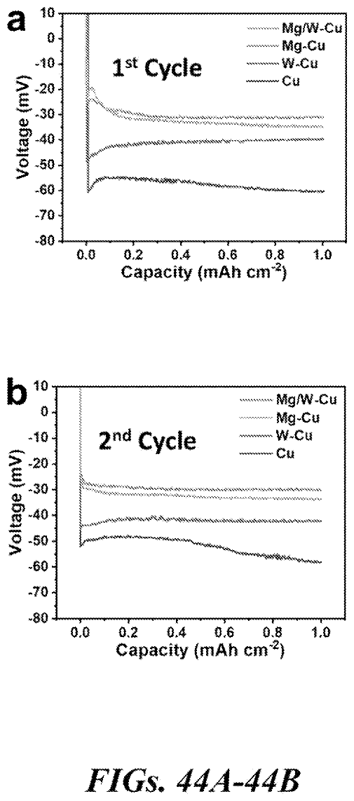

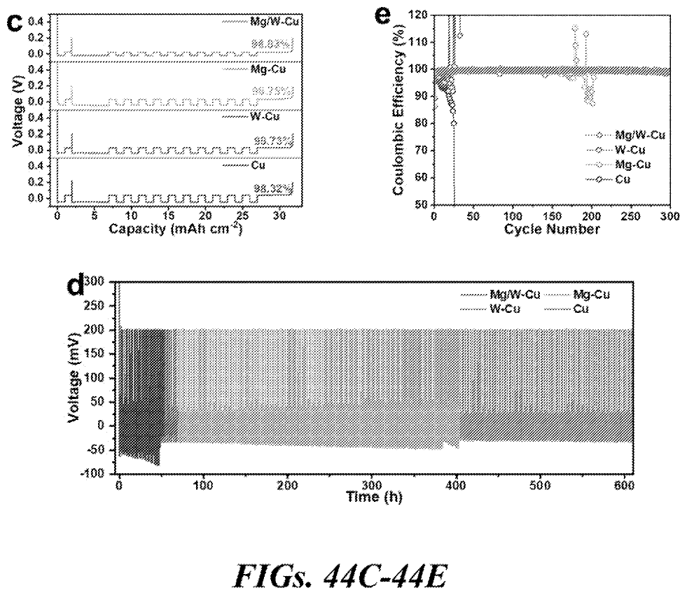

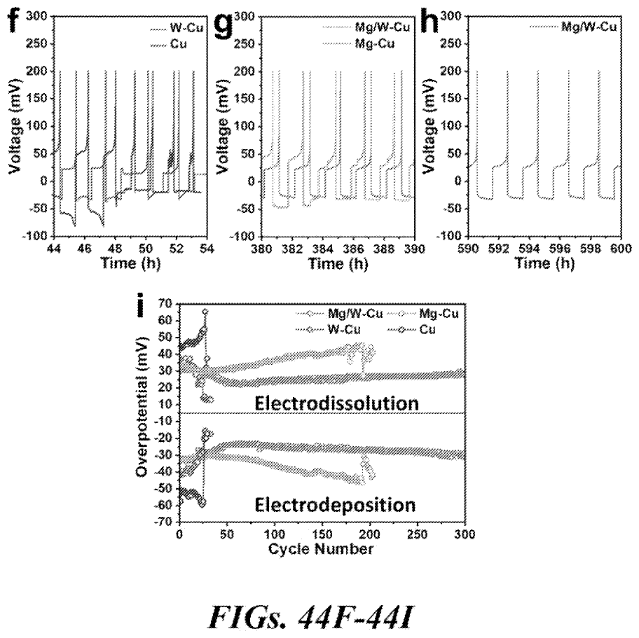

The electroanalytical results for the Li|SE|Mg/W—Cu, Li|SE|Mg-Cu, Li|SE|W-Cu, and Li|SE|Cu half-cells are presented in FIGS. 44A-441. FIGS. 44A and 44B compare galvanostatic electrodeposition profiles of modified and baseline current collectors in the initial and second cycles, tested at a current of 1 mA cm-2 with a fixed capacity of 1 mAh cm⁻². FIG. 44C provides the Coulombic efficiency (CE) measurement during Li electrodeposition/dissolution. FIGS. 44D and 44E present the cycling profiles and CEs at 1 mA cm⁻². FIGS. 44F to 44H offer galvanostatic profiles at selected time periods. FIG. 44I shows the electrodeposition and electrodissolution overpotentials during cycling at the same testing condition. Per FIG. 44A, all samples exhibited a distinctive “dip” at the onset of the profile during the first cycle, which was the nucleation overpotential for metal electrodeposition.

Overpotential behavior during alkaline electrodeposition on non-alloying supports consist of two stages. Initially the voltage profile shows a sharp dip. This is followed by a plateau at a less negative voltage, with a slope of zero or that is weakly negative or positive. The plateau is present for the duration of the electrodeposition. The sharp dip is associated with crystallite layer nucleating on the support surface, while the subsequent plateau is associated with grain growth during film thickening. A slight negative slope is expected when grain growth becomes more facile as the film thickens, while a slight positive slope is expected when the opposite occurs. Such behavior is observed for Li electrodeposited on W—Cu and on baseline Cu working electrodes.

The other, more complex electrodeposition voltage behavior consists of three stages. First there is the initial sharp dip, which is followed by a more gradual spike, which is then followed by a plateau. This behavior is observed with the Mg/W—Cu and Mg—Cu specimens. The nucleation overpotentials (initial sharp dip) were measured at 61 and 49 mV for baseline Cu and W—Cu, respectively. For Mg/W—Cu and Mg—Cu these values are 30 and 25 mV. The reduced nucleation overpotential on a Mg surface known for alloying supports such Li—Mg, Li—Au and Li—Ag, being correlated with more facile nucleation kinetics and enhanced wetting.^{[65]} The more gradual voltage spike was associated with an alloying reaction barrier between Mg and Li, leading to the formation of an extended Li—Mg solid solution. After the Li film nucleates on the Mg surface it begins to inter-diffuse with the layer, forming a bulk solid solution. Based on the Li—Mg phase diagram, Mg forms a random solid solution (α-phase with 0-15 at. % Li) and an ordered solid-solution (β-phase with 30 at. % Li and above).^{[66-69]} However, it has been reported that the alloying reaction is kinetically sluggish due to the low Li diffusivity in Li—Mg (in the order of 10⁻¹¹ cm² s⁻¹).^{[70-72]} Moreover forming a single alloy phase from a bilayer of two pure metals results in volume changes and associated stresses. Therefore, when cycled at a relatively high current density of 1 mA cm⁻², the initially sluggish alloying kinetics are manifested as this spike which gradually decays into the terminal plateau as stresses are relieved and the Li—Mg alloy is homogenized and diluted (increasing Li, constant Mg reservoir). FIG. 44B shows the galvanostatic profiles of the half-cells in the 2^{nd} cycle where both Mg/W—Cu and W—Cu samples exhibited a notable absence of both the nucleation dip and the alloying spike. This is synonymous new film growth occurring epitaxially with the pre-existing Mg—Li alloy, thereby not requiring a distinct nucleation step at the onset. If distinct new Li grains were formed on the surface of the pre-existing Li—Mg alloy, a nucleation dip would have to occur, such as it did at cycle 1. At cycle 2 the nucleation overpotentials on the W—Cu and baseline Cu surfaces are 45 and 52 mV, respectively.

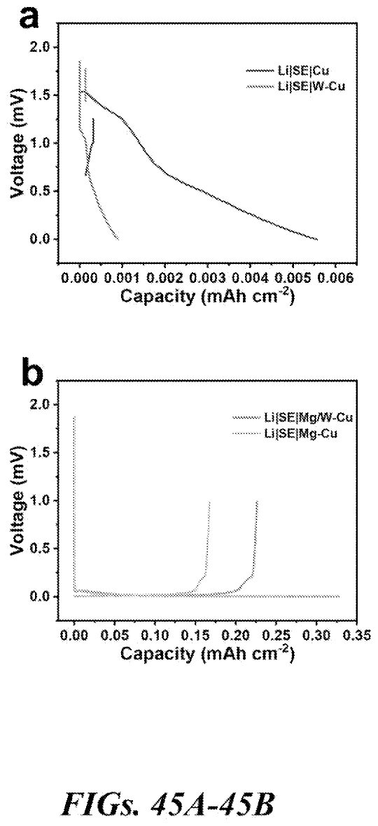

The initial galvanostatic profile for the baseline Cu and W—Cu samples at a low current (0.05 mA cm⁻²) between 0 and 1 V is shown in FIG. 45A. It was observed that there was negligible reversible or irreversible capacity, i.e. that Cu and W—Cu were inert with Li. It also indicates that during activation there was minimal SEI formed between the Li and the SE. As is demonstrated next, the capacity loss with Li|SE|Mg/W—Cu and Li|SE|Mg-Cu is due to irreversibility in Mg. FIG. 45B shows the same activation protocol for Li|SE|Mg/W—Cu and Li|SE|Mg-Cu. In this case there is 0.23 mAh cm⁻² of reversible capacities and an initial Coulombic efficiency (ICE) of 72%. The capacity loss is attributed to some irreversibility in the alloying of Li with Mg. For example the associated lithiation stresses may be physically damaging in the Mg film, with limited pulverization, cracking or delamination.^{[73]} Counting only the reversible capacity, the Mg layer alloys to Li_{3.9}Mg (β-Mg), with the associated film swelling being in effect a volume summation of the inserted Li atoms.^{[74]} For Li|SE|Mg-Cu, the reversible capacity achieved above 0 V is 0.17 mAh cm⁻², with an ICE of 66%. The difference in the ICE for Li|SE|Mg/W—Cu versus Li|SE|Mg-Cu may be due to the action of underlying W in preventing delamination or other forms of physical degradation in the Mg layer during alloying.

A comparative analysis of the CE during Li electrodeposition/dissolution process is presented in FIG. 44C. The measurements were carried out following a standard protocol, as reported previously for evaluating the efficiency of Li deposition in liquid electrolytes.^{[75]} The evaluation comprised three steps: Firstly, an initial formation cycle was performed by electrodepositing Li at 1 mA cm⁻² to a capacity of 1 mAh cm⁻², followed by electrodissolution at the same current to an anodic limit of 0.2 V. Secondly, a reservoir of 5 mAh cm⁻² Li was electrodeposited at the same current, followed by ten cycles of electrodissolution/deposition (from that reservoir). Finally, the entire reservoir was electrodissolved to the 0.2 V anodic limit. The CE was calculated based on the cumulative electrodeposition and electrodissolution capacities from the reservoir. For Mg/W—Cu, Mg—Cu, W—Cu, and baseline Cu the calculated CEs are 98.83%, 98.75%, 98.73%, and 98.32%, respectively. The minimal difference of CEs (<1%) observed among these samples further supports negligible differences in the degree of early-stage capacity loss. This early loss, which was roughly equal in the four specimens, was due to SEI formation as well as electrochemically inactive “dead Li” that was formed on the collector surface. As will be demonstrated next, it is the longer-term cycling stability and the associated CE that are tremendously influenced by the presence of the Mg and W layers on the Cu.

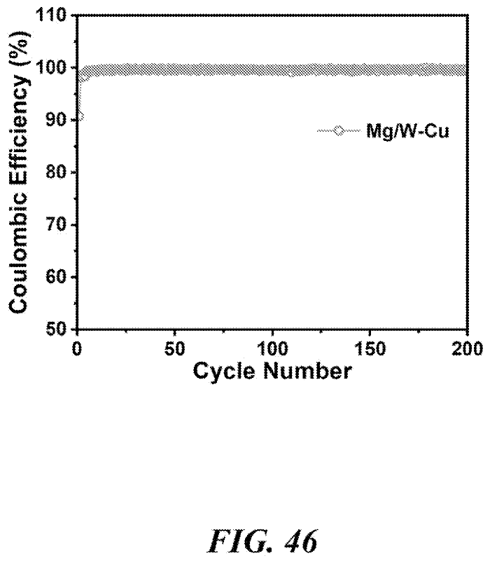

FIGS. 44D-44H compare the long-term cycling performance and CEs of Li|SE|Mg/W—Cu, Li|SE|Mg-Cu, Li|SE|W-Cu, and Li|SE-Cu half-cells, tested at a current density of 1 mA cm⁻² with a Li electrodeposition/dissolution capacity of 1 mAh cm⁻². The bottom panels in FIGS. 44F-44H display enlarged profiles of selected regions from FIG. 44D. With a half-cells configuration, the working electrode is an “empty” current collector. Since CE is never exactly 100%, an anodic cutoff voltage of 0.2 V is employed, after which the current was switched. Distinct differences in the voltage-time profiles are observed among the four working electrodes. Per FIG. 44F, with the baseline Li|SE|Cu and Li|SE|W-Cu, cells deteriorate after 48 and 49 hours (26 and 25 cycles), respectively. According to FIG. 44G the Li|SE|Mg-Cu cell exhibits stable cycling up to 383 hours (193 cycles), at which point a sudden voltage drop occurs, indicating a short circuit. Instability is also evident by the fluctuating CE values that start at the 193^{rd} cycle. By contrast, the Li|SE|Mg/W—Cu cell demonstrates stable electrodeposition/dissolution for over 600 hours (300 cycles) without any signs of deterioration. This is illustrated in FIG. 44H. The accumulated electrodeposition/dissolution capacity reaches 300 mAh cm⁻². Since 1 mAh cm⁻² of Li metal corresponds to a ~5 μm film, a cumulative 300 mAh cm⁻² capacity corresponds to 1.5 mm of metal that is cumulatively electrodeposited and electrodissolved. FIG. 46 shows the cycling performance for the Li|SE|Mg/W—Cu cell tested at a higher current of 2 mA cm⁻² to 1 mAh cm⁻², maintaining a stable CE up to 200 cycles.

A comparison of Li electrodeposition/dissolution overpotentials during cycling, extracted from the 1 mA cm⁻² to 1 mAh cm⁻² cycling is provided in FIG. 44I. For the baseline Cu cell, both electrodeposition/dissolution overpotentials gradually increased with cycling until a sudden drop in voltage occurred at the 26^{th} cycle (48 hours), indicating a short circuit. The 1^{st} cycle electrodeposition/dissolution overpotentials were 57 and 45 mV, while the 25^{th} cycle overpotentials were 58 and 54 mV. It may be observed that W—Cu cell exhibits more stable and lower electrodeposition/dissolution overpotentials as compared to the baseline Cu, although a short circuit occurs nearly at the same cycle number. The 1^{st} cycle electrodeposition/dissolution overpotentials were 41 and 35 mV, while the 24^{th} cycle overpotentials were 28 and 24 mV. It was therefore concluded that the W layer by itself has a minimal effect on the cell's electrochemical stability but does allow for incrementally improved kinetics while the cell remains active. The Mg—Cu cell displays electrodeposition/dissolution overpotentials measured as 33 and 34 mV at the 1^{st} cycle. Additionally, the studies demonstrate extended cycling stability for up to 193 cycles, with overpotentials being 46 and 45 mV before the onset of instability. The Mg/W—Cu cell exhibits the lowest electrodeposition/dissolution overpotentials, being 32 and 30 mV at the 1^{st} cycle. Even at cycle 300, the overpotentials remained low at 29 and 28 mV, underscoring its distinct electrochemical stability. Both Mg/W—Cu and Mg—Cu cells showed a similar trend; decreasing overpotentials up to 50 and 30 cycles followed by an increase afterward. The initial overpotential decrease is likely associated with the enhancement of interfacial contact between the SE and current collector with repeated Li electrodeposition/dissolution.^{[33]} As will be demonstrated, the subsequent overpotential increase was mainly attributed to the corrosion reactions at the SE-Li and SE-Cu interphases. For Mg—Cu the electrodeposition/dissolution overpotentials increased by approximately 0.1 mV per cycle until the cell was short circuited. The overpotentials in the Mg—W/Cu cell was more stable, between 50 to 300 cycles the increase was 0.02 mV per cycle. The difference in overpotential increased rates between the Mg/W—Cu and Mg—Cu cells with the difference in the corrosion resistance of the W coated versus the unmodified Cu surface.

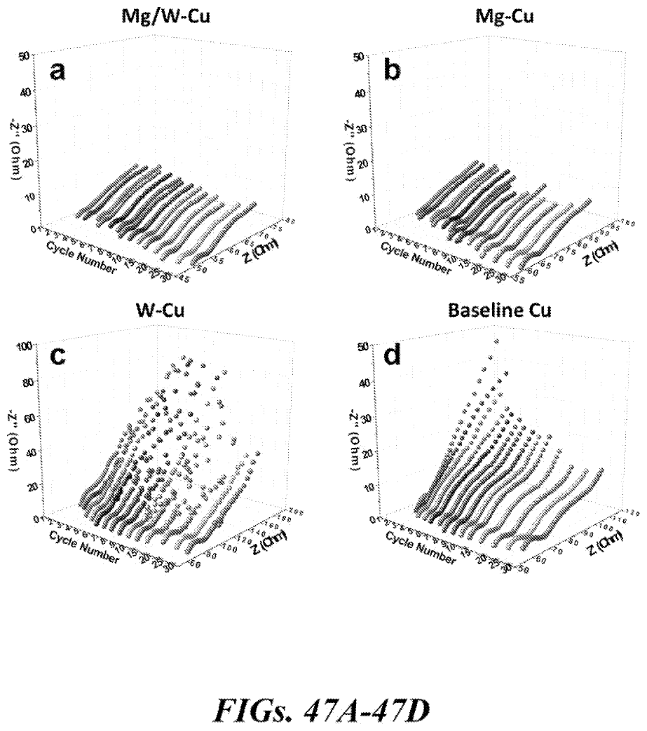

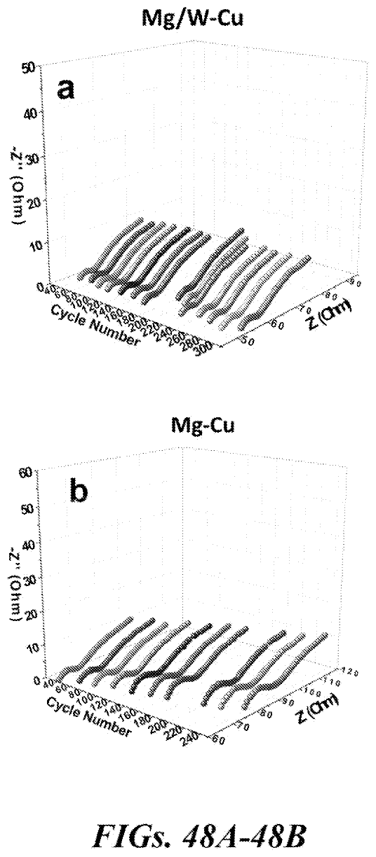

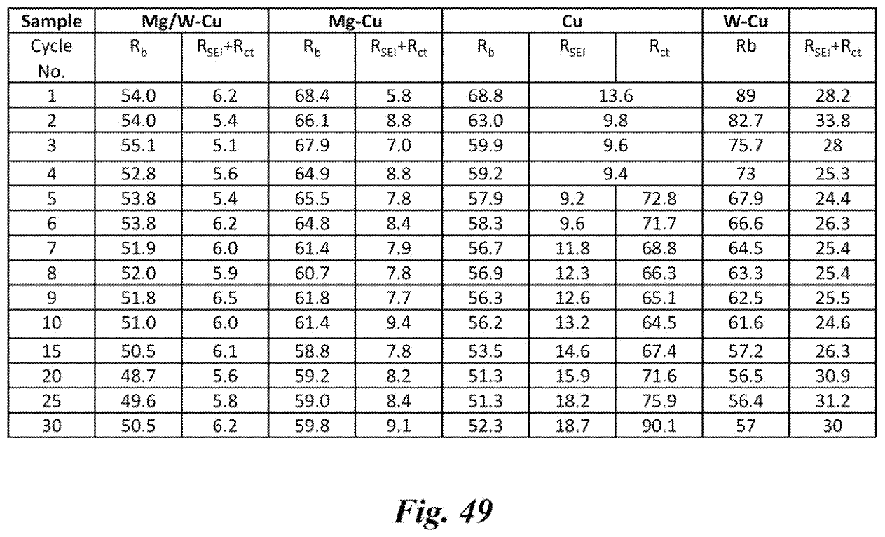

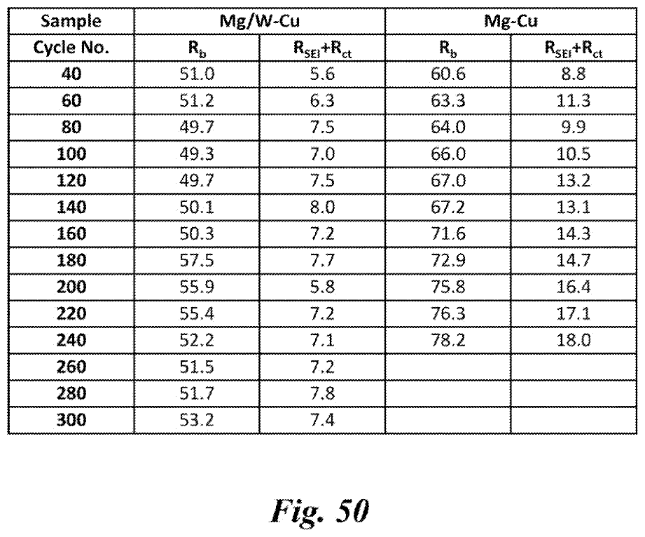

Electrochemical impedance spectroscopy (EIS) analysis was conducted to further investigate changes in interfacial resistance during cycling. FIGS. 47A-47C provides the Nyquist plots for Li|SE|Mg/W—Cu, Li|SE|Mg-Cu, and Li|SE|Cu cells, respectively. The cells were analyzed at cycle 1 through cycle 10, cycle 15, 20, 25 and 30, all tested at 1 mA cm⁻² and 1 mAh cm⁻². FIGS. 48A-48B extend the analysis for Li|SE|Mg/W—Cu, Li|SE|Mg-Cu, focusing on cycles 40 and higher. The plots were fitted using Z-view software with the corresponding results being detailed in FIG. 49 and FIG. 50. At cycles 1-30, the four cells displayed an incremental lowering of the bulk resistance (R_{b}). This was likely due to a combination of improved contact between the cell components and gradual densification of the LPSCl during cycling under pressure. The calculated resistivity is the intrinsic resistance divided by the geometric contact area and multiplied by the geometric ionic path length (i.e. SE compact thickness). A reduction of the overall pore volume in the SE resulted in an increase of effective contact area despite the geometric contact area being fixed. It also resulted in a reduction in the effective ionic path even if the geometric SE thickness was not changed: Lithium ions have to diffuse around the pores, making their path through the SE more circuitous. The Li|SE|Mg/W—Cu cell displays an initial bulk resistance (R_{b}) of 54.0Ω and a combined SEI and charge-transfer resistance (R_{SEI}+R_{ct}) of 6.2Ω. With cycling the R_{b} gradually decreases, becoming 50.5Ω at cycle 30. The R_{SEI}+R_{ct} value remained stable, being 6.2Ω at cycle 30, with some fluctuations in between. This indicates that at these cycle numbers the cell interfaces were quite stable.

The interface stability with Mg—Cu was not as good, with R_{SEI}+R_{ct} going from 5.8Ω at cycle 1 to 9.1Ω at cycle 30. In the Li|SE|W-Cu cell, the initial R_{b} measured 89.0Ω, which decreased to a lower value of 57.0Ω by cycle 30. The R_{SEI}+R_{ct} started at 28.2Ω at the 1^{st} cycle and increased slightly to 30.0Ω after 30 cycles. The R_{SEI}+R_{ct} for the baseline Cu cell increased significantly with cycling, to a point whereby cycle 5 it was possible to separate R_{SEI}+R_{ct} into two distinct overlapping semicircles, the R_{SEI} being at the higher frequency. At the 1^{st} cycle, R_{SEI}+R_{ct} for the baseline Cu was 13.6Ω. By the 5^{th} cycle, the semicircle R_{SEI} was 9.2Ω, while the semicircle R_{ct} was 72.8Ω. Both R_{SEI} and R_{ct} continued to increase, reaching 18.7Ω and 90.1Ω by cycle 30.

The Nyquist plots and associated fitting results for the extended cycling of the Mg/W—Cu and Mg—Cu specimens are presented in FIGS. 48A, 48B, and 50. The Li|SE|Mg-W/Cu cell exhibited a relatively stable R_{b} throughout the cycling up to 300 cycles, with some fluctuations. For instance, R_{b} measured 51.0Ω, 50.1Ω, 52.2Ω, and 53.2Ω at cycles 40, 140, 240, and 300, respectively. Additionally, the R_{SEI}+R_{ct} exhibited a slightly increasing trend, measuring 5.6Ω at cycle 40, 8.0Ω at cycle 140, 7.2Ω at cycle 240, and 7.4Ω at cycle 300. In the Li|SE|Mg-Cu cell, both R_{b} and R_{SEI}+R_{ct} demonstrated an increasing trend, measuring 60.6Ω and 8.8Ω, 67.2Ω and 13.1Ω, 78.2Ω and 18.0Ω, at cycle 40, 140, 240, respectively.

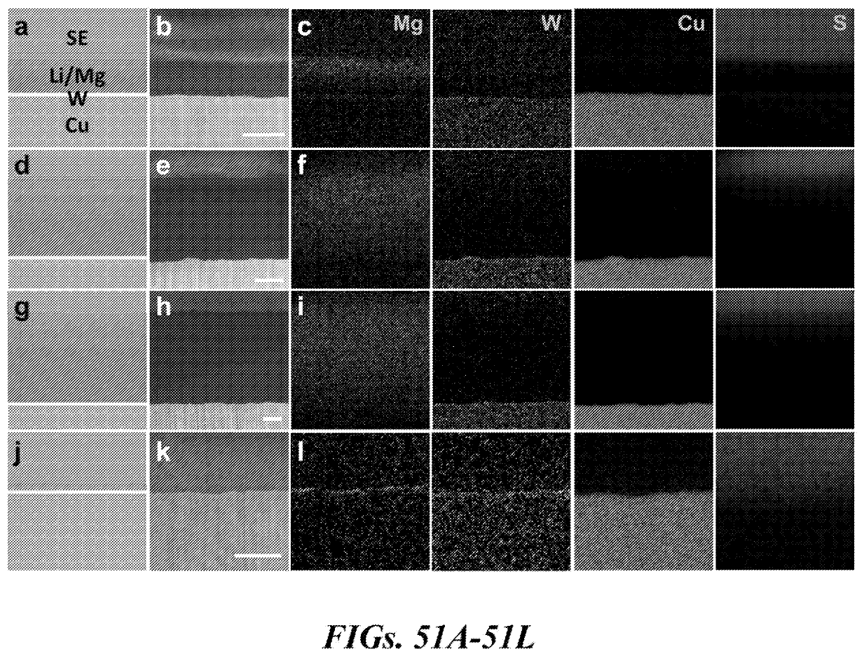

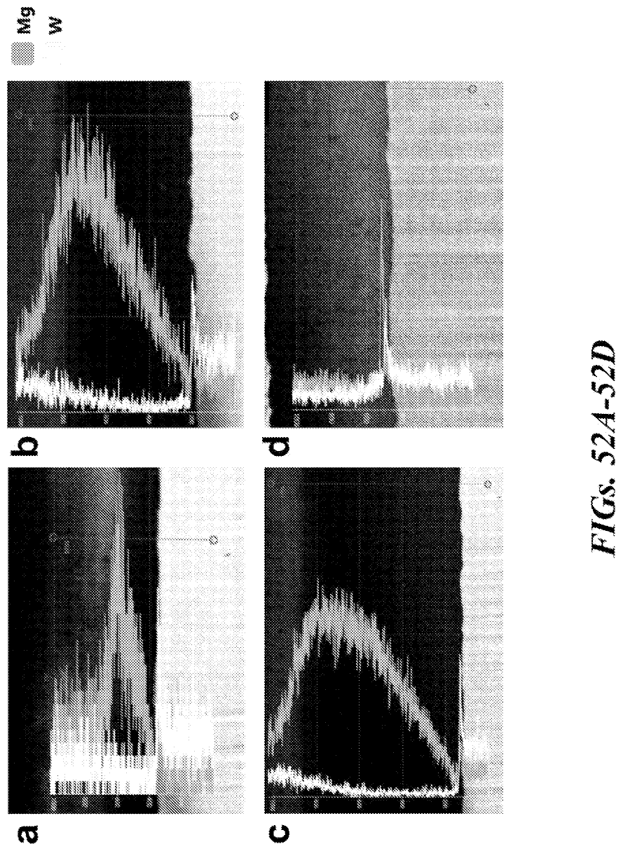

FIGS. 51A-51L and 52A-52D display cross-sectional cryogenic focused ion beam (cryo-FIB) SEM and associated EDXS microstructural analysis of post-electrodeposited and post-electrodissolved Li|SE|Mg/W—Cu cells. All tests were conducted at a current of 1 mA cm⁻². FIGS. 51A-51C present the cell microstructure after electrodeposition of 1 mAh cm⁻²; FIGS. 51D-51F after electrodeposition of 3 mAh cm⁻²; and FIGS. 51G-51I after electrodeposition of 5 mAh cm⁻². FIGS. 51J-51L display the microstructure after electrodissolving the remaining Li to the 0.2 V anodic limit. FIGS. 52A-52D show the EDXS line scan of the cell cross-sections at corresponding electrodeposition/dissolution conditions. At accumulated capacities of 1, 3 and 5 mAh cm⁻², the measured metal thickness was 4.4, 14.6 and 24.2 μm, comparable to the theoretical values of 4.9, 14.7, 24.5 μm, respectively. The electrodeposited Li at 1 mAh cm⁻² was observed to be largely free of pores and of imbedded SEI. This Li microstructure remained consistent after accumulating capacities of 3 and 5 mAh cm⁻².

Further evaluating the Li|SE|Mg/W—Cu cells microstructure, it was observed that within the resolution of the EDXS area and line scans the alloying of Li with Mg was nonuniform. Rather the region of the film facing the SE interphase remains enriched in Mg, especially at low electrodeposited capacity. Tungsten does not form intermetallic phases with Li and has minimal mutual solubility at room temperature.^{[76]} According to the equilibrium binary phase diagram, the W and Mg layers are also expected to stay distinct, with no intermetallics formed and with minimal mutual solubility.^{[77]} The seeming overlap between the W and Mg EDXS line scans was due to the limited resolution of the technique and the interaction volume of the electron beam. Since the heavy and refractory W layer (183.84 u, Tₘ=3422° C.) was deposited first with the lighter Mg (24.305 u) layer being deposited on top, significant element intermixing was not expected during the magnetron sputtering process. According to the EDXS maps, the W layer remained attached to the Cu surface at all testing conditions, while the Mg layer reversibly alloys and dealloys with the Li. After complete electrodissolution, there was no obvious presence of dead metal or clump-like SEI. Rather the Mg/W layer reverts to its original geometry, with the W facing the Cu and the Mg facing the SE. According to the binary phase diagram, W does form sulfides WS₂ and WS₃.^{[78]} However it was shielded from the LPSCl by the Mg layer. A MgS phase was not detected by XPS and had not been reported to form in solid-state. If present, it was very thin and may be useful for kinetically passivating the rest of the Mg layer from reacting with the SE.

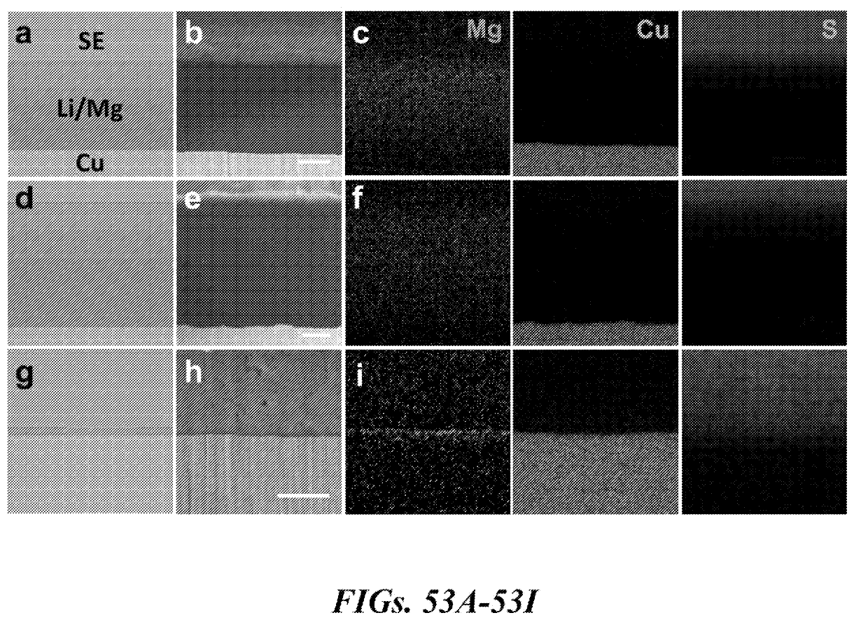

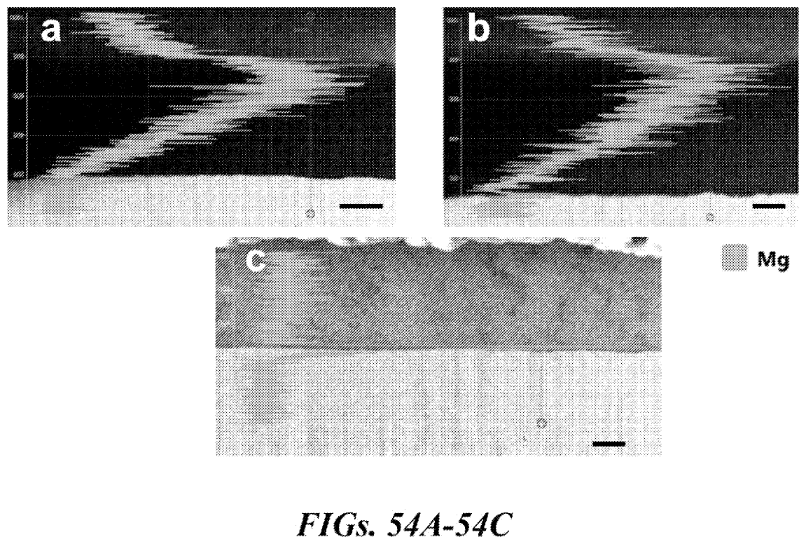

FIGS. 53A-53I present analysis of the Li|SE|Mg-Cu cells, illustrating cell microstructures after electrodeposition of 3 mAh cm⁻², electrodeposition of 5 mAh cm⁻² and electrodissolution to the 0.2 V anodic limit. FIGS. 54A-54C provide the EDXS line scan scans at these test conditions. At accumulated capacities of 3 and 5 mAh cm⁻², the electrodeposit remained uniform and free from pores and embedded SEI. The phenomenology of Li electrodeposition and Mg distribution was analogous for Li|SE|Mg-Cu and Li|SE|Mg/W—Cu. The key difference between the two was the corrosion of the Cu current collector when the W layer was absent. As will be demonstrated, Mg by itself is insufficient to prevent its reaction with LPSCl SE. This is why a refractory non-reactive W layer was needed to sustain long-term cycling stability.

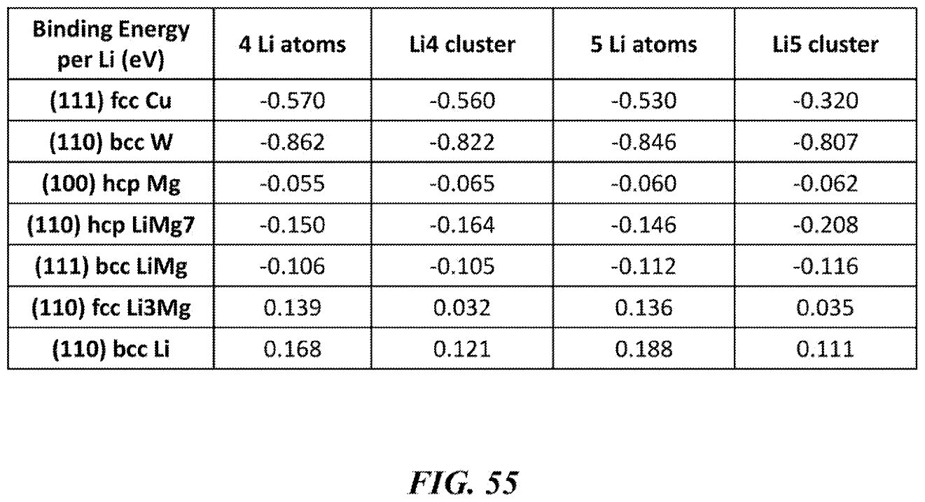

Unlike the previously reported Ag/C work, where Ag nanoparticles migrate to the current collector interface after lithiation, it was found that the Li—Mg solid solution forms a concentration gradient of Mg, with an Mg-rich phase facing the SE interface, as indicated by the EDXS results in FIGS. 52A-52D and 54A-54C. To investigate this phenomenon, atomistic density functional theory (DFT) calculations were conducted to compare the binding energies of four or five Li atoms on different substrates. The results, shown in FIG. 55, reveal a trend in binding energies as follows: W<Cu<LiMg₇<LiMg<Mg<Li₃Mg<Li. There is an energetic driving force for Li to segregate to the W or the Cu surface.

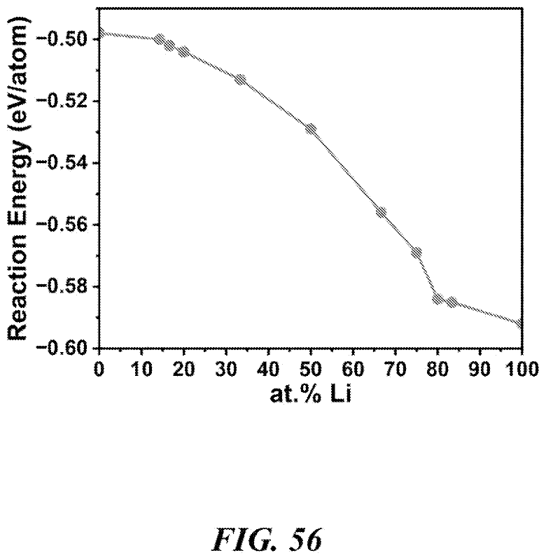

The Mg-rich phase adjacent to the SE can reduce the interphasial reactivity between the Li—Mg alloy and LPSCl SE. This was supported by the reaction energy diagram shown in FIG. 56, where the reaction energy decreased monotonically from pure Mg to pure Li. This trend corresponds to an increased reactivity from pure Mg to pure Li, with pure Li exhibiting the highest reactivity. This explains the reduced reactivity with the Mg coating layer. However, the reactivity between LPSCl and the Cu current collector still persists, leading to Cu corrosion and subsequent performance decay.

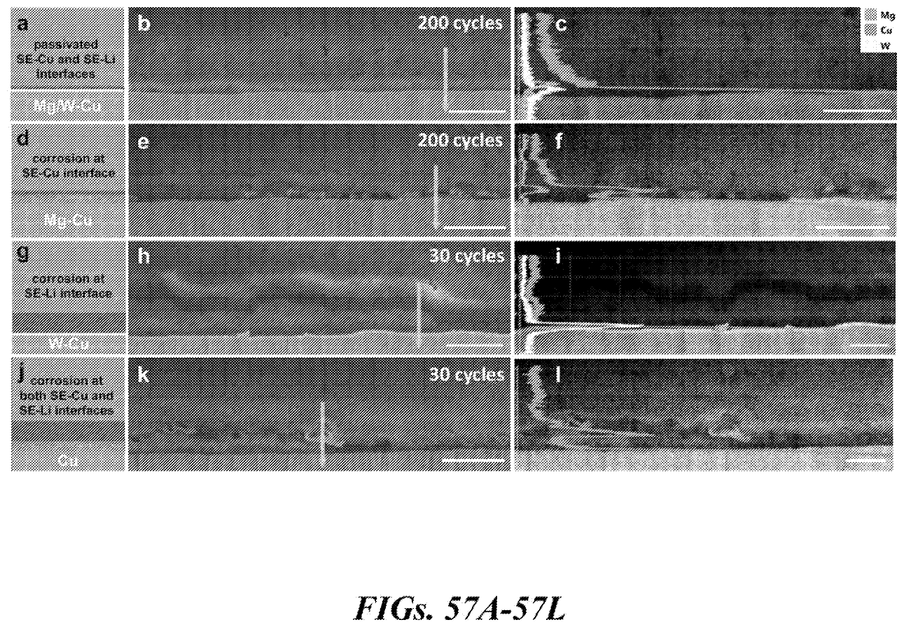

FIGS. 57A-57L and 58A-58F provide the cross-sectional cryo-FIB SEM and EDXS line scan spectra of the microstructural analysis of post-cycled half-cells cells employing Mg/W—Cu, Mg—Cu, W—Cu, and baseline Cu current collectors. All cells were cycled at 1 mA cm⁻² to 1 mAh cm⁻² with an anodic limit of 0.2 V. FIGS. 57A 57C and 57D-57F show the Mg/W—Cu and Mg—Cu cell microstructures, respectively, at the electrodissolved state after 200 cycles. FIGS. 57G-57I and 57J-57L present the microstructures of W—Cu and baseline Cu cells, respectively, at the electrodissolved state after 30 cycles. Additionally, FIGS. 58A-58F display the Mg/W—Cu cell microstructure at the electrodissolved state after 30 cycles, electrodeposited state after 300 cycles, and electrodissolved state after 300 cycles. Schematics representing the cell microstructures after cycling are provided in front of each row.

As shown in FIGS. 57A-57C, uniform Li electrodeposition/dissolution was observed for the Mg/W—Cu cell after 200 cycles without noticeable pores and electrolyte or current collector fragments. Of course, the LPSCl SE still reacted to some extent with the Li in the Mg—Li alloy. However, the kinetics of this reaction were markedly suppressed. In parallel, the W effectively eliminated the corrosion of the Cu by the LPSCl, at least as long as it maintained physical integrity on the collector surface. As expected, EDXS analysis indicated that the Mg layer was recovered after full electrodissolution. FIGS. 58C-58F provide additional analysis of the electrodeposition and electrodissolution behavior, after 300 cycles at 1 mA cm⁻² to 1 mAh cm⁻². The electrodeposition remained unform, forming a Li—Mg solid solution but with no discernable W signal originating from the alloy. In the electrodissolved state, there was minimal corrosion products present. The EDXS line scan results highlight the stability of the unreactive W layer.

The microstructure of the Mg—Cu cell after 200 cycles is presented in FIGS. 57D-57L. At the interface between the SE and Cu collector, there were numerous detached particles that appeared as corrosion products. EDXS line scan spectra revealed a strong Cu signal in these particles. The S signal contained significant noise and fluctuated even inside the SE region. In the electrodissolved state, the EDXS results revealed a thin Mg layer at the collector/SE interface, signifying the general reversibility of the dealloying process. However, as indicated earlier, there was a substantial CE loss associated with the 1^{st} cycle lithiation of the Mg film (34% Li was lost with Mg, 28% Li was lost with Mg/W). It is likely that additional losses of Li in Mg occur during subsequent cycling, also due to the repeated alloying—dealloying and the associated volume changes and stresses. One can hypothesize that the reason that a single layer Mg is not fully effective in protecting the Cu from reacting with the SE is that during extended cycling, portions of the Mg layer pulverize, crack or otherwise become detached from the collector surface. Aided by the 9 MPa external stack pressure, the SE comes into contact with the Cu collector at these weak points.

FIGS. 57D-57F illustrate the microstructural analysis of W—Cu after 30 electrodeposition/dissolution cycles, shown in the electrodissolved state after the cell hit the 0.2 V anodic cutoff limit. The corrosion layer that is visible in the should be various decomposition products of LPSCl reacting with Li metal (e.g. Li₂S, Li₃P, Li₃PS₄, LiCl) since analysis of the Cu-W∥SE∥W-Cu symmetric cells shows that the W layer prevents its reaction with Cu. EDXS analysis revealed that the sputtered W layer remains conformal and intact after cycling with no discernible Cu or W signal being observed in the regions of Li metal and SE fragments. This indicates that the W coating layer was stable against the sulfide SE and will protect Cu from corrosion. However, it may be observed that during cycling the SE was actually fractured, separating in the bulk but near the SE-W interface. Per the relatively darker contrast in the SE image, it appears that the fractured region was filled with inactive Li metal.

Analogous analysis of the baseline Cu cell after 30 cycles is provided in FIGS. 57J-57L, which exhibited a distinct layer between the sulfide SE and Cu current collector containing phases with varying contrast. EDXS line scan results indicated an isolated particle with brighter contrast consisting of Cu signals, giving evidence that Cu corrodes and that these products break off from the foil surface. The corrosion product appeared to be a heterogeneous mixture of several phases. The electrochemical formation of these phases was supported by the relatively low CE measured in the cycled half-cells. Per the darker contrast in some portions of the corrosion layer, electrochemically inactive dead Li metal may be present. The corrosion layer consistently contained porosity throughout, which signals significant volume changes occurring during phase formation. Corrosion of the Cu current collector directly by contacting the LPSCl was supported by electroanalysis of the Cu|SE|Cu symmetric cells.

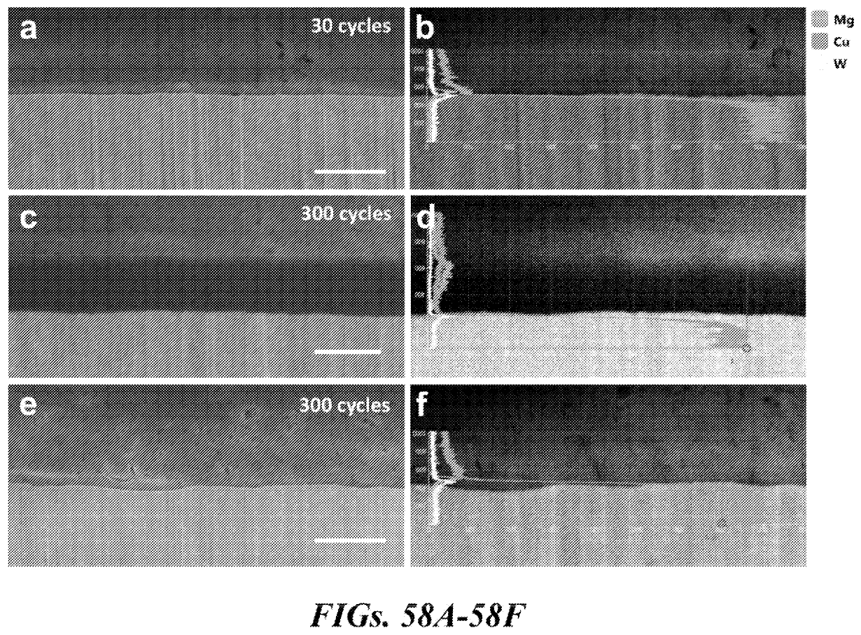

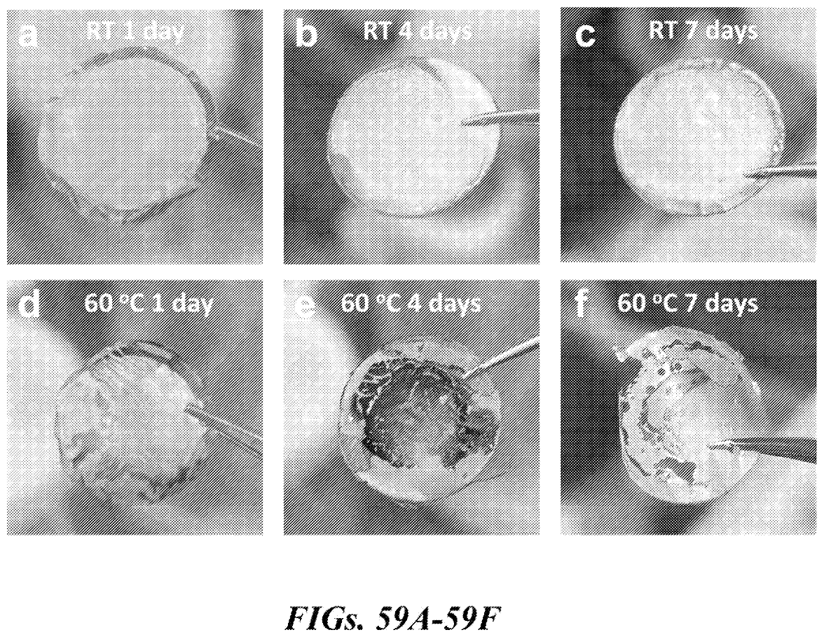

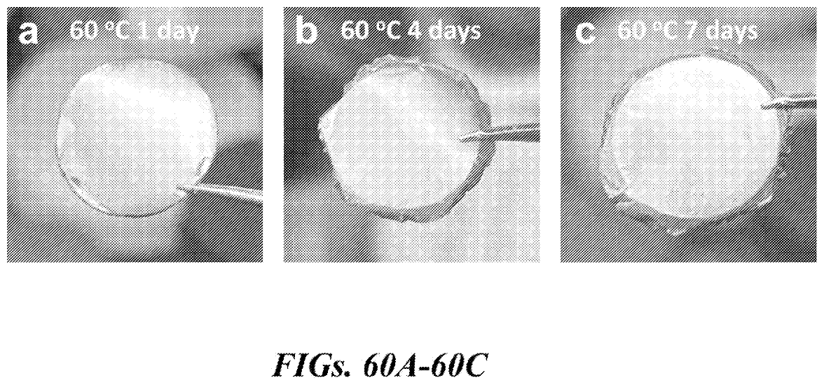

To further demonstrate the role of W in preventing Cu corrosion, baseline Cu and W—Cu samples were affixed to the LPSCl SE under 9 MPa pressure. The geometry can be visualized as symmetric Cu|SE|Cu and W-Cu|SE|W-Cu half cells without applying any bias. Characterization was performed after these cells were held for various durations. To further accelerate the corrosion process, experiments were carried out at 60° C. FIGS. 59A-59F show digital photographs of the baseline Cu current collectors after 1, 4, and 7 days at room temperature and at 60° C. At room temperature the Cu surface noticeably changes in color after the 4-day hold, indicating macroscopic corrosion. The amount of corrosion layer present increases after the 7-day hold. The corrosion reaction between the Cu and the SE was significantly accelerated by elevated temperature. At 60° C. the foil was heavily corroded after even 1 day and was further corroded by day 4 and day 7, with no evidence of surface passivation with prolonged exposure. FIGS. 60A-60C show the W—Cu foil held at 60° C., with no visible corrosion of the surface even after 7 days. In principle, the W layer can react with LPSCl to form WS₂.^{[78]} However, judging by the optical contrast of the surface, there did not appear to be any discernable attack of the underlying Cu.

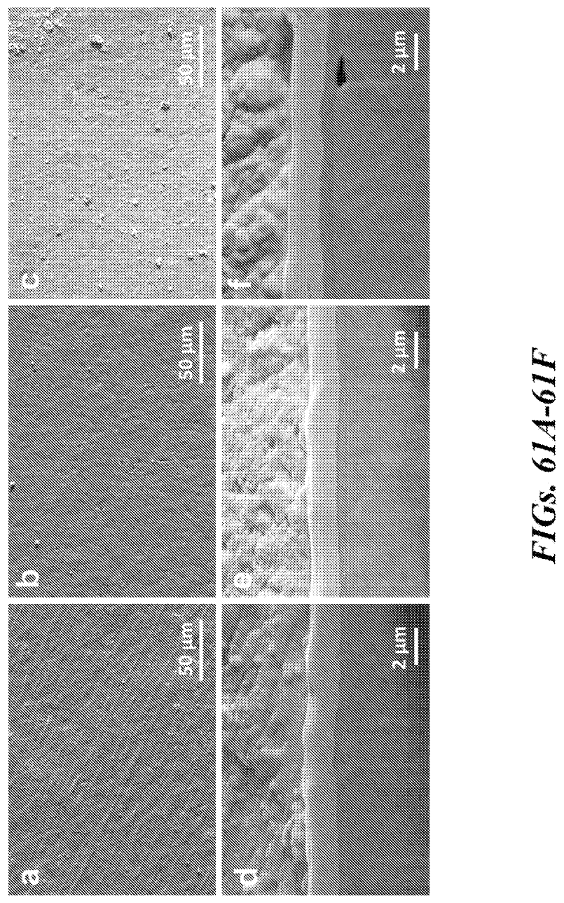

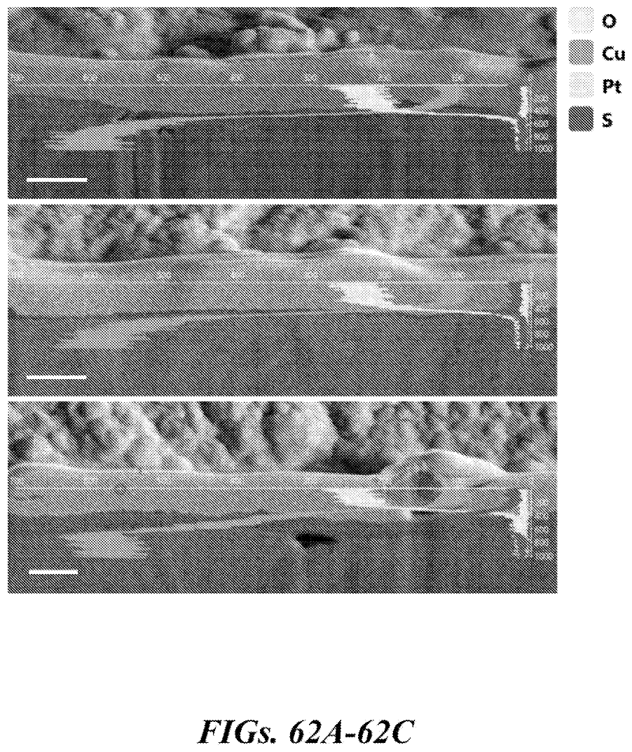

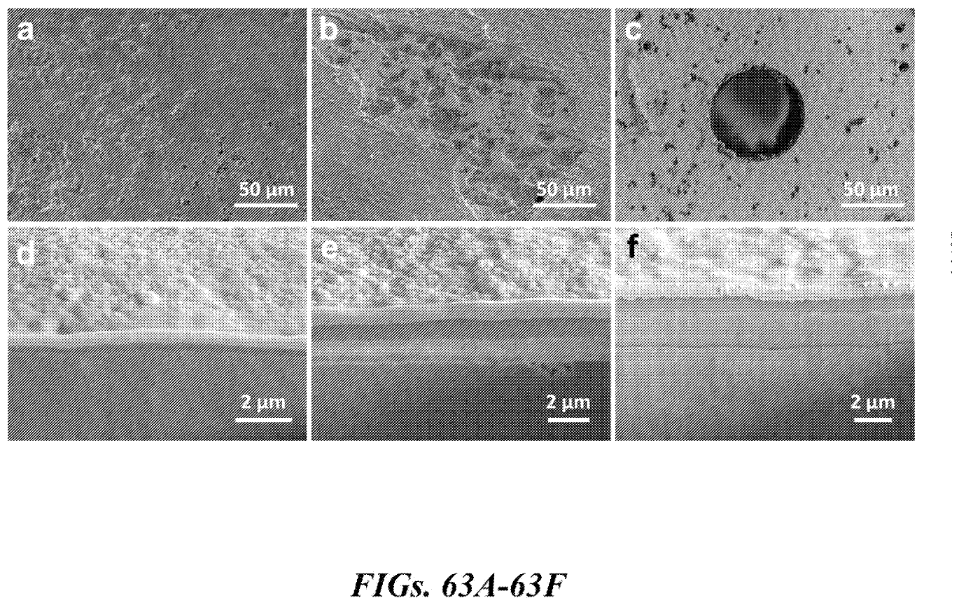

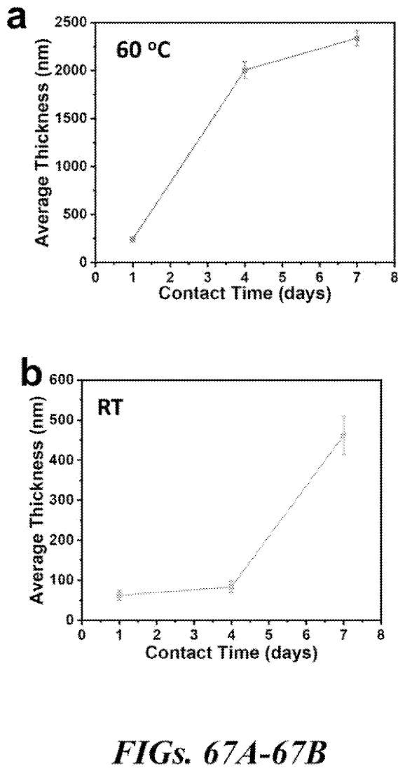

FIGS. 61A-61F and 62A-62C present top-down and cross-sectional SEM images along with associated EDXS analysis of baseline Cu in contact with SE at room temperature after different contact times. Similar analysis for baseline Cu and W—Cu at 60° C. is shown in FIGS. 63A-63F and 64A-64C and FIGS. 65A-65E and 66A-66B. In FIGS. 61A-61F, the surfaces of the Cu foil remained relatively smooth, and pitting was not discernible until after a 4-day contact. The thickness of the corrosion layer was analyzed using FIB-SEM, as shown in FIGS. 61D-61F. A Pt layer was deposited on top of the surface to minimize the beam damage during FIB milling. The statistical average thickness of the corrosion layer is provided in FIG. 67A, measuring 62 nm, 83 nm, and 462 nm after 1, 4, and 7 days of contact; and 243 nm, 2005 nm, and 2337 nm after 1, 4, and 7 days of contact, respectively. EDXS line scan spectra indicated that the corrosion product was mainly composed of copper sulfides.

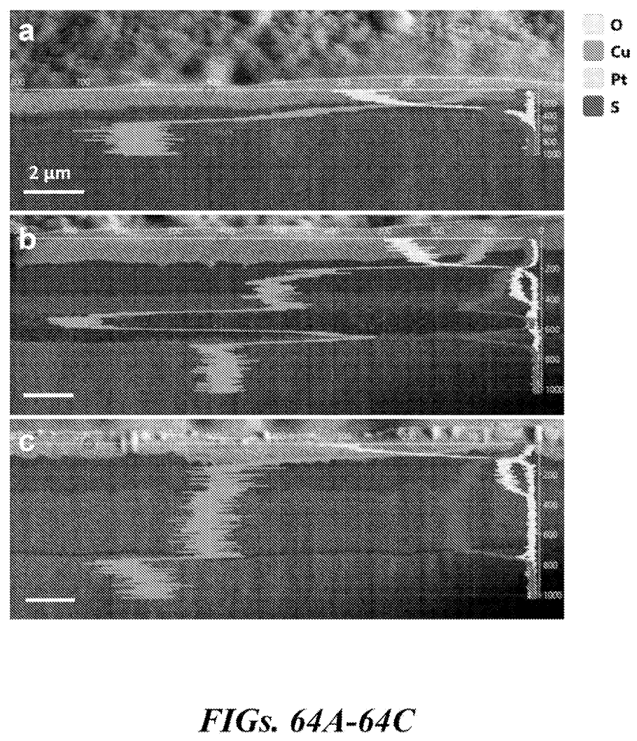

The post-contact baseline Cu samples with SE at an elevated temperature are depicted in FIGS. 61A-61F and 62A-62C. Compared to the results at room temperature, the surface of Cu foil became rough after 1 day of contact with the SE, displaying the formation of craters indicative of pitting corrosion. These pits grew larger and deeper after 4 days of contact and ultimately resulted in the formation of holes after 7 days. Cross-sectional SEM analysis suggests the existence of a corrosion layer, which was much thicker than that at room temperature. FIG. 67B provides the average thickness of these layers, which were measured to be 243 nm, 2005 nm, and 2337 nm after 1, 4, and 7 days of contact, respectively. In addition, multiple layers within the corrosion region were evident, as reflected by the contrast difference. FIGS. 64A-64C present the corresponding EDXS line scan spectra at the cross-sections, indicating these layers primarily consisted of Cu, S, and O signals, suggesting compositions such as copper sulfide, copper oxide, and copper sulfate.

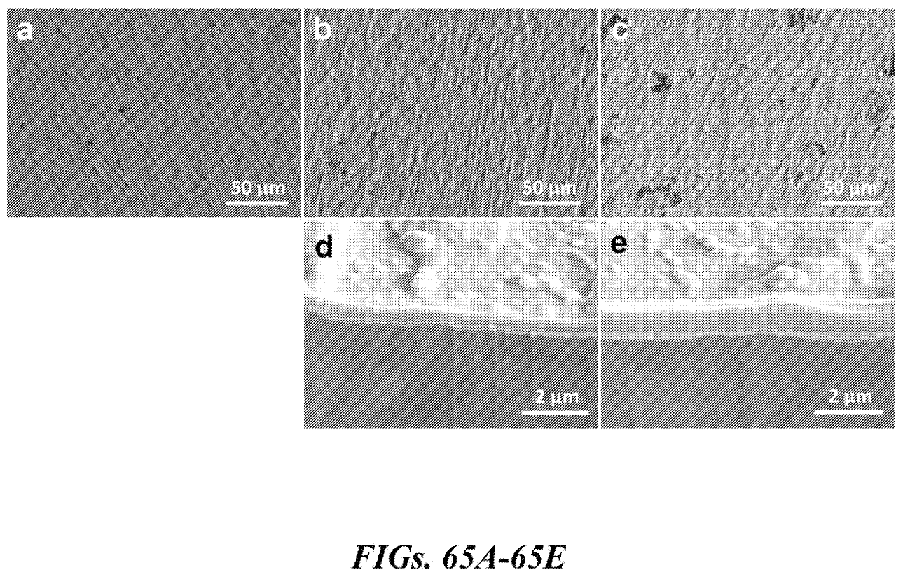

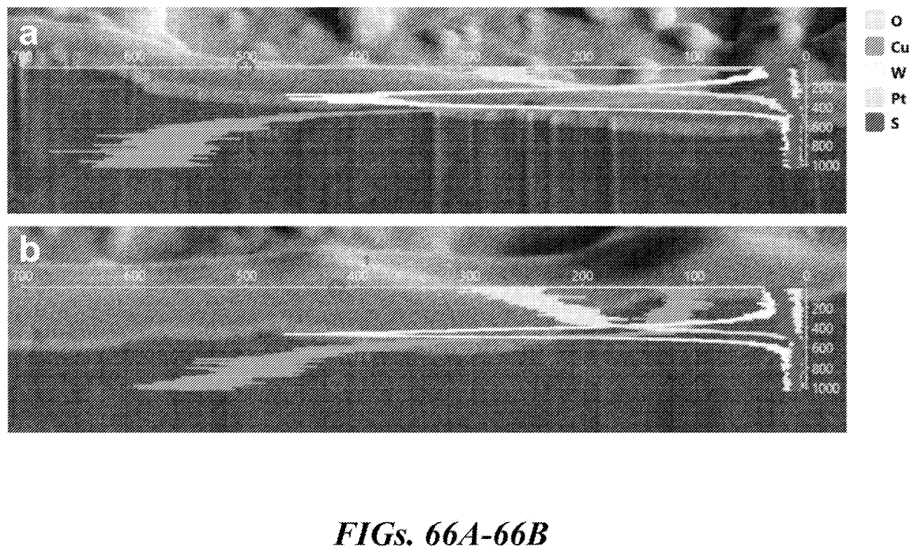

FIGS. 65A-65E and 66A-66B present an analogous corrosion study with the W—Cu sample at 60° C. It is evident that the surface of W—Cu remained smooth and conformal without any signs of pitting. The cross-sectional view further verifies the uniformity of the W coating situated between the Cu foil and Pt coating, displaying no discernible interlayers. EDXS line scan results corroborate the absence of any Cu signal on top of the W layer, indicating the passivation of the Cu surface from corrosion, consistent with the electroanalytical observations mentioned earlier. Overall, the above study underscores the instability of Cu current collector with the sulfide SE wherein direct contact leads to Cu corrosion that exacerbates at elevated temperatures. By contrast, the W coating provides effective passivation of Cu, significantly reducing corrosion by SE.

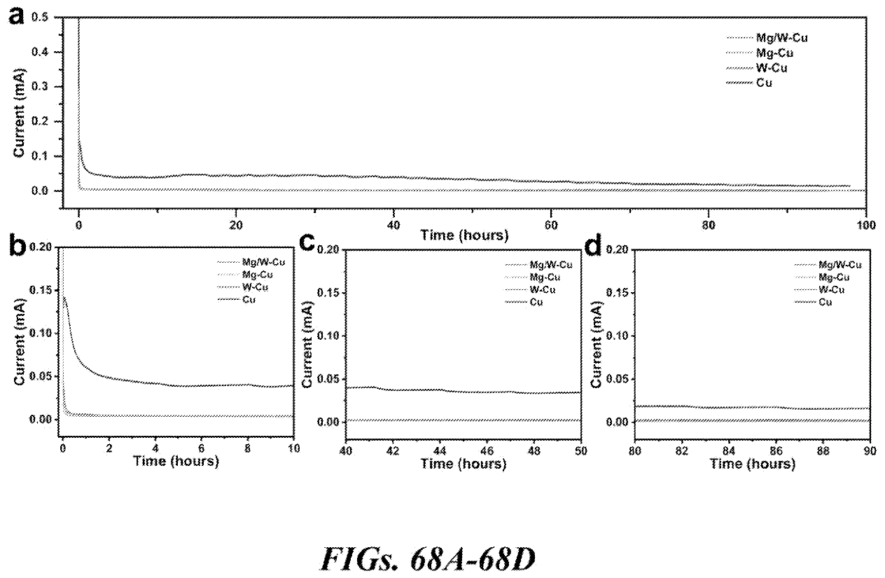

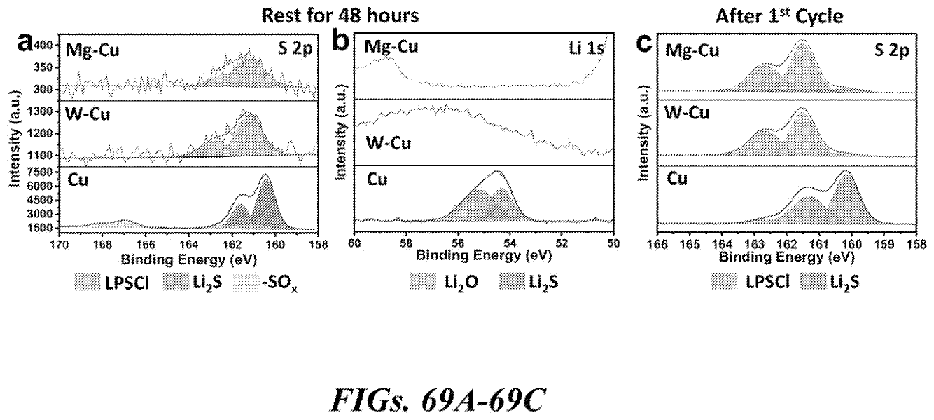

The electrochemical stability of the four current collectors against LPSCl SE was further evaluated in symmetric configurations, without the presence of Li metal: Mg/W-Cu|SE|Mg/W—Cu, Mg—Cu|SE|Mg—Cu, W—Cu|SE|W-Cu, and Cu|SE|Cu. This was done by holding the cells at 4.2 V. Anodes may experience such high voltages as a result of Li exhaustion (analogous to half-cells) when batteries are over-discharged. For conventional LIBs this is a known problem that causes the Cu collector surface to dissolve in the electrolyte.^{[79-80]} FIG. 68A presents the corrosion currents observed in different samples held at 4.2 V for up to 100 hours, with selected regions detailed in FIGS. 68B-68D and 69A-69D. All cells initially exhibited a rapid drop in currents, followed by stabilization. After 10 hours for Cu|SE|Cu, W-Cu|SE|W—Cu, Mg—Cu|SE|Mg-Cu and Mg/W-Cu|SE|Mg/W—Cu, the currents were 39 μA, 10 μA, 3 μA, and 4 μA, respectively. After 50 hours these values were 35 μA, 6 μA, 2 μA, and 2 μA. After 90 hours they were 16 μA, 6 μA, 1 μA, and 1 μA. This indicates that at all stages of the test, the baseline Cu collector corrodes the most, while the Mg-Cu|SE|Mg-Cu and Mg/W-Cu|SE|Mg/W—Cu corrode the least. However, as indicated by cryo-FIB SEM analysis, electrochemical cycling damages the integrity of a single Mg layer, allowing for corrosion products to accumulate. Therefore, a bilayer Mg/W approach was needed to ensure long-term cycling stability.

The chemical and electrochemical stability of Mg—Cu, W—Cu, and baseline Cu current collectors against sulfide SE was further investigated by XPS characterization, sampling approximately the top 5 nm of the specimen surface. To investigate the chemical stability, these current collectors were pressed onto sulfide SE and left undisturbed for 48 hours without cycling. Subsequently, they were separated from the SE and subjected to the XPS analysis. All cells were disassembled in an Ar-filled glove box and transferred to XPS analysis chamber using a dedicated holder to avoid exposure to air. FIGS. 69A and 69B present the results for the samples held for 48 hours without cycling, showing high-resolution S 2p and Li 1s spectra. A key difference was observed in the baseline Cu, which exhibited strong S signals with an intensity two magnitudes higher than that of Mg—Cu and W—Cu samples. There were three pairs of S 2p peaks for the Cu sample, corresponding to Li₂S (160.4 eV (S 2p_{3/2}) and 161.6 eV (S 2p_{1/2})). LPSCl (161.2 eV (S 2p_{3/2}) and 162.4 eV (S 2p_{1/2})), and SOₓ (166.9 eV (S 2p_{3/2}) and 168.1 eV (S 2p_{1/2})). The dominating Li₂S signal originates from the decomposition of the sulfide SE, which appears to be catalyzed by the Cu support (the specimen was not Li cycled). As will be demonstrated by the LPSCl-Cu corrosion test shown next, the Cu support was significantly corroded by the SE. However, this underlying corrosion layer does not show up in XPS analysis since it samples only the top ~5 nm of material. By contrast, the surfaces of both Mg—Cu and W—Cu samples lack Li₂S signals, with weak peaks attributed to the trace amount of residual electrolyte. The Li 1 s spectra further supported the relatively strong Li signals (Li₂S and Li₂O) on the Cu and W—Cu surface, in contrast to the absence of Li signals on the Mg—Cu surfaces. In another set of experiments for XPS analysis, a fixed capacity of 1 mAh cm⁻² Li was electrodeposited onto the surface at 1 mA cm⁻², followed by electrodissolving to an anodic limit of 0.2 V. FIG. 69C shows the S 2p spectra after the 1^{st} cycle where all samples exhibit two doublets of peaks that were attributed to the Li₂S and the LPSCl SE. However, the Li₂S peak accounted for 86% for the baseline Cu cell, in contrast to 8% for Mg—Cu and 9% for W—Cu cells. In summary, XPS demonstrated that the reductive decomposition of LPSCl to Li₂S was significantly accelerated for the baseline Cu both when the sample was held without any external current and when it was cycled with Li. The W and the Mg/W layers suppressed this decomposition.

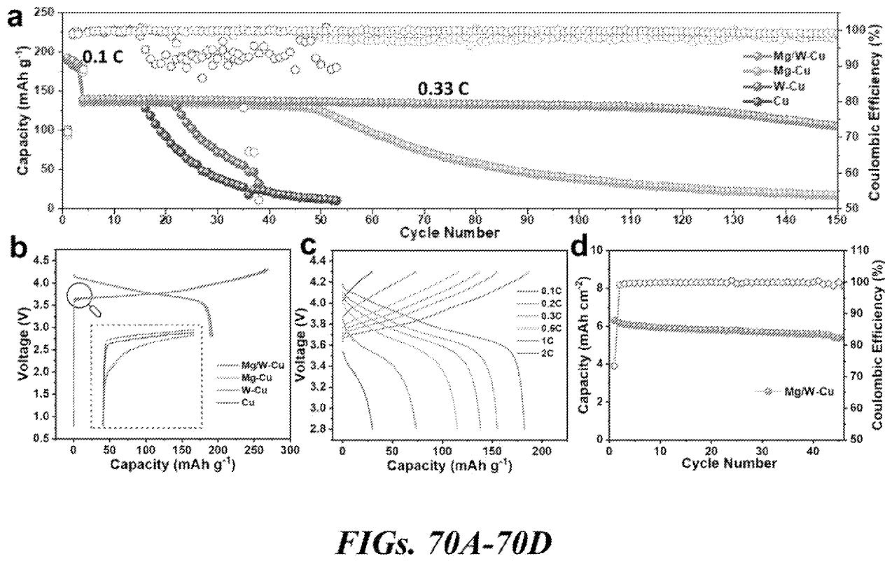

As proof of concept, anode-free all-solid-state batteries (AF-ASSBs) were fabricated and tested using Mg/W—Cu, Mg—Cu, W—Cu, and baseline Cu current collectors. In an AF-ASSB configuration, it is critical to achieve cycling CEs approaching 100% since there is no active Li reservoir apart from what is in the cathode. The anode-free full cells were assembled using a composite cathode consisting of commercial LiNbO₃-coated LiNi_{0.8}Mn_{0.1}Co_{0.1}O₂ (LNO@NMC811) and argyrodite electrolyte at a weight ratio of 7:3 without any carbon additives. The areal capacity of cathode was ~1 mAh cm⁻² for typical measurements and over 8 mAh cm⁻² for high mass-loading experiments. The CEs in the AF-ASSBs were calculated based on the discharge and charge capacities of the composite cathodes. FIG. 70A compares the long-term cycling performance of the Mg/W—Cu, Mg—Cu, W—Cu, and baseline Cu AF-ASSBs. All cells were activated at 0.1 C (1 C equals 200 mA g⁻¹ based on the mass of NMC cathode) for 3 cycles before switching to 0.33 C. The electrochemical measurements were carried out within the voltage window of 2.8-4.3 V at room temperature. FIG. 70B provides the galvanostatic profiles of the cells during the initial cycle at 0.1 C. The AF-ASSBs employing Mg/W—Cu, Mg—Cu, W—Cu, and baseline Cu current collectors exhibited charge/discharge capacities of 269/192 mAh g⁻¹, 270/191 mAh g⁻¹, 265/189 mAh g⁻¹, and 265/192 mAh g⁻¹, resulting in approximate initial Coulombic efficiencies (ICEs) of 71%, 71%, 71%, and 72%, respectively. The inset in FIG. 70B shows an enlarged view from the beginning of charge process, revealing a remarkable difference in the voltage profiles among these samples. W—Cu and Cu full cells required higher voltages to reach the plateau regions, while Mg/W—Cu and Mg—Cu cells exhibited much lower voltages. This indicates that W—Cu and baseline Cu samples need to overcome greater overpotentials for Li to nucleate whereas the nucleation overpotentials are much lowered on the Mg/W—Cu and Mg—Cu surfaces, in agreement with the observation in half cells (FIG. 44A).

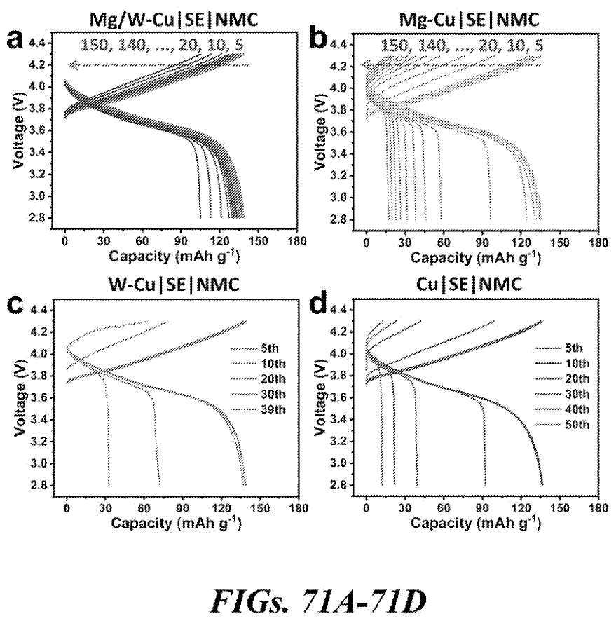

After switching to a higher current of 0.33 C, all cells displayed comparable capacities (135-139 mAh g⁻¹) from the onset. However, Cu|SE|NMC and W-Cu|SE|NMC cells experienced rapid capacity decay after 15 and 21 cycles, respectively. The Mg-Cu|SE|NMC cell showed extended cycle life up to 50 cycles before the capacity began to decline. In contrast, the Mg/W-Cu|SE|NMC cell did not show any significant capacity loss within 120 cycles, sustaining a specific capacity of 122 mAh g⁻¹, which corresponds to a capacity decay rate of 0.06% per cycle. Afterwards, a gradual capacity decrease was observed with a faster decay rate of 0.58% per cycle from cycle 130 to 150. Overall, the Mg/W-Cu|SE|NMC AF-ASSB delivered a capacity retention of 76% after 150 cycles at 0.33 C. FIGS. 71A-71D present the galvanostatic profiles of these cells starting from the 5^{th} and 10^{th} cycles, followed by every 10 cycles until 150^{th} cycle or cell failure. It was observed that the failure mechanism appears similar among these cells, which was correlated with the deteriorated voltage profile during discharging at certain cycles. When the cells started to fail, the discharge curve no longer overlapped with the previous cycles, instead, the voltage-capacity profiles exhibited a sharp turn, followed by a rapid voltage drop. As the discharge process corresponds to the Li electrodissolution on the anode side, this issue resulted mainly from the depletion of electrochemically active Li reservoir that led to a surge in polarization.

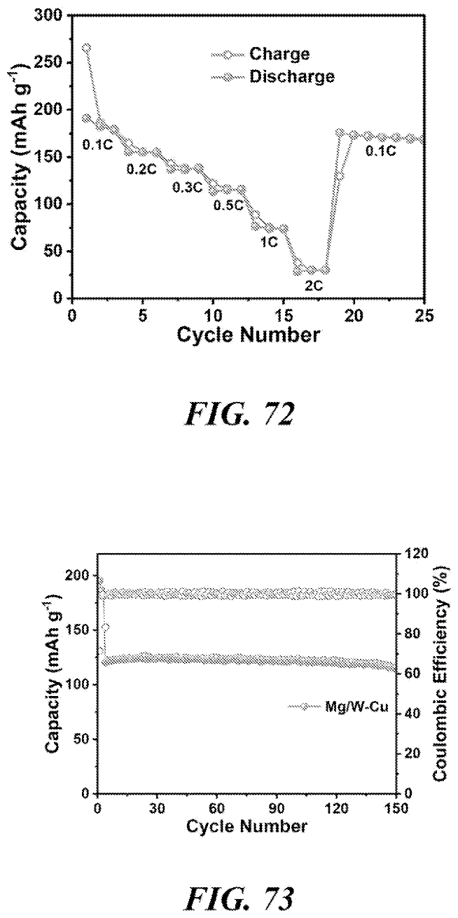

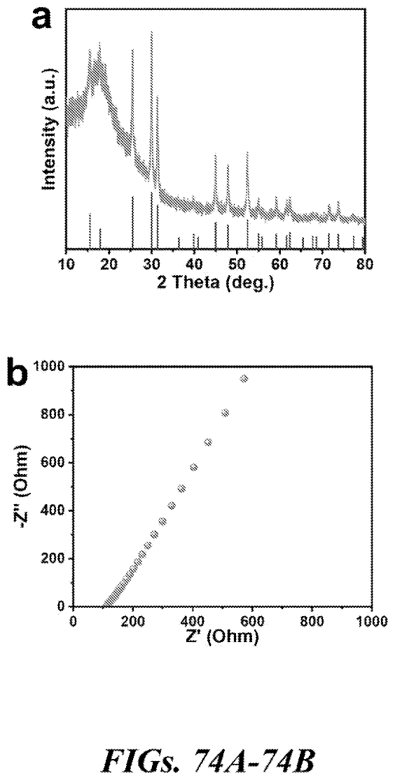

FIGS. 70C and 72 display the rate capability of the Mg/W-Cu|SE|NMC cell, with discharge capacities of 183, 155, 138, 115, 74, and 30 being obtained at 0.1 C, 0.2 C, 0.3 C, 0.5 C, 1 C and 2 C, respectively. FIG. 73 provides the cycling stability at a higher current density of 0.5 C. A reversible capacity of 115 can be obtained after 150 cycles with a capacity decay rate of only 0.03% per cycle. In order to test the practicality of the Mg/W-Cu|SE|NMC cell, a high mass-loading NMC cathode was employed with an areal capacity exceeding 8 mAh cm⁻², almost twice as much as commercial lithium-ion batteries cathode (4 mAh cm⁻²). As shown in FIG. 70D, the high mass-loading Mg/W-Cu|SE|NMC cell delivered an initial charge and discharge capacities of 8.6 and 6.3 mAh cm⁻² at 0.2 C, corresponding to an ICE of 73.4%. The cell stably cycled for more than 45 cycles, exhibiting a capacity retention of 86.5%. It is noteworthy that with such a high areal capacity, a thickness of more than 30 μm Li was being electrodeposited and electrodissolved for each cycle. NMC cathode typically exhibits a volumetric change of less than 5% during charging and discharging, which cannot offset the overall cell volume change. This results in substantial pressure changes due to the volumetric expansion and contraction during Li electrodeposition and electrodissolution, which was fundamentally different from half cells tested with a thick Li metal anode where the net volume change for the cell was close to zero as Li electrodeposition and electrodissolution occurred simultaneously on both electrodes. Therefore, engineering the cell structure and optimizing operational parameters such as pressure are crucial for implementation. Overall, these AF-ASSB results aligned well with the analytical and electroanalytical findings for the half-cells, demonstrating the outstanding performance of the Mg/W—Cu current collector.

Discussion. All-solid-state batteries (ASSBs) are an emerging technology that has the potential to address the increasing safety and energy demands for next-generation electrochemical energy storage systems, including for electric vehicles.^{[1-8]} Notably, their potential compatibility with lithium (Li) metal anodes holds great promise for achieving high specific energy (>500 Wh kg⁻¹) at the cell-level, particularly when coupled with high-voltage cathode materials such as LiNi_{0.8}Mn_{0.1}Co_{0.1}O₂ (NMC811) and LiNi_{0.5}Mn_{1.5}O₄ (LNMO).^{[9-16]} The incorporation of inorganic solid electrolytes (SEs) further enhances the appeal of ASSBs as these materials are either nonflammable or exhibit exceptionally high ignition temperatures, thereby offering superior safety features compared to their counterparts utilizing liquid electrolytes.^{[17-19]} Sulfide-based SEs stand out for their high Li-ionic conductivities and advantageous physical “softness” that enables enhanced formability. Argyrodite-type Li₆PS₅Cl (LPSCl) sulfide SE has demonstrated significant promise, combining a relatively high ionic conductivity of about 1 mS cm⁻² with some degree of self-passivation at both the anode-SE and cathode-SE interphases.^{[20-24]}

Despite these advancements, the implementation of sulfide SEs in ASSBs presents several serious challenges. One major issue is the inherent reactivity between sulfides and both electrodes, resulting in electrolyte/electrode decomposition that increases cell impedance and fosters the formation of a mixed conducting interphase (MCI).^{[25-28]} The interface between the metal anode and the SE should ideally be thermodynamically stable or passivated to be kinetically stable. However, sulfide SEs are not thermodynamically stable at 0 V vs. Li/Li⁺, leading to the formation of either MCI or a (partially) kinetically stabilized solid electrolyte interphase (SEI).^{[29-32]} It has been recently demonstrated that even LPSCl, which was assumed to be kinetically self-passivated, continues to decompose through reaction with Li during electrochemical cycling.^{[33-35]} With argyrodite electrolyte, Li-SE reaction induced voids in the metal have been reported.^{[33]} Kirkendall-type porosity in the lithium foil may be caused by the significant site-to-site variations in the thickness of the formed SEI during cycling or storage, as documented by cryo-stage electron microscopy and Raman mapping. At reacted regions there was also voiding in the decomposed LPSCl due to the reaction products being denser than the parent materials. Such reactivity will also lead to the lithium metal and the SSE pulling away from each other. Lithium metal dendrite growth has also been reported at the Li-SE interphase, with a recent study employing site-specific electron microscopy to image a branched intergranular sheet-like dendrite that has shorted an LPSCl symmetric cell.^{[23, 36-38]} For ASSBs utilizing sulfides, cell failure may occur gradually or suddenly and catastrophically, underscoring the critical demand for addressing these issues.

A “conventional” ASSB employed a metallurgically rolled Li foil as the anode^{[39-40]}. However, for a relatively thick lithium foil the capacity of the two electrodes is imbalanced and the cell energy is not optimized. For example, the capacity of a 50 μm Li foil is 250 mAh cm⁻², versus a commercially relevant cathode that is at 4 mAh cm⁻². To achieve ASSBs with the targeted 400 or 500 Wh kg⁻¹ energy, it is imperative to limit the amount of Li utilized.^{[41-44]} This also significantly reduces cell cost and increases safety, since oxidation of Li metal is a highly exothermic process. An anode-free all-solid-state battery (AF-ASSB) configuration emerges as the targeted architecture, where all the active Li is stored in the cathode, the same way it is in conventional LIBs.^{[45-48]} Pioneering studies on AF-ASSBs were focused on thin-film solid-state batteries using Li phosphorus oxynitride (LiPON) electrolyte.^{[49]} LiPON electrolyte is kinetically stable with Li and is straightforward to deposit as a thin film using magnetron sputtering.^{[50-51]} However its relatively low ionic conductivity (~10⁻⁶ S cm⁻¹) limits its applications. Another seminal study demonstrated the feasibility of a non-reactive garnet solid electrolyte Li₇La₃Zr₂O₁₂ (LLZO) for AF-ASSBs.^{[52]} Recently there have been a number of significant advances in the interfacial science and in architecture design of sulfide-based ASSBs.^{[29, 53-59]} Despite these highly promising findings, achieving long-term electrochemical stability in sulfide-based ASSBs remains a major challenge. Yet to be understood interface-related problems in-sum quickly reduce the cycling Coulombic efficiency, spike the cell impedance, and exhaust the finite Li supply in the cathode.

Electrochemical stability in anode-free all solid-state battery (AF-ASSB) based on sulfide argyrodite Li₆PS₅Cl (LPSCl) solid-electrolyte (SE) requires microstructural control of three interfaces. The Lithium metal/SE interface has to remain uniform and passivated; Li—Cu current collector interface has to remain wetted, and (at 100% discharge) the Cu-SE interface has to remain uncorroded. A bilayer of 140 nm magnesium/30 nm tungsten (Mg/W—Cu), as disclosed in the herewith example, achieves all three functions, with cryogenic focused ion beam (cryo-FIB) microscopy and multiscale simulations supporting the electroanalysis. Magnesium promotes uniform Li metal electrodeposition/dissolution through reversible alloying, but with its segregation to SE boundary. This in-turn stabilizes the solid electrolyte interphase (SEI) during cycling. Tungsten protects Cu from catalyzing irreversible decomposition of LPSCl, while being corroded in the process. AF-ASSB with NMC811 cathode achieves 150 cycles with Coulombic efficiency (CE) above 99.8%. AF-ASSB with high mass-loading cathode (8.6 mAh cm⁻²) retains 86.5% capacity after 45 cycles at 0.2 C.

Electrochemical stability of anode-free all solid-state battery (AF-ASSB) based on argyrodite Li₆PS₅Cl (LPSCl) solid-electrolyte (SE) requires two key attributes: Lithium has to uniformly electrodeposit/dissolve onto/from both the “empty” Cu current collector and the preexisting Li metal. In parallel, the Li-SE and Cu-SE interfaces have to remain stable and minimally corroded. Microstructural control of these complex interfaces and interphases is achieved with physical vapor deposited (PVD, magnetron sputtering) bilayer of 140 nm Mg/30 nm W onto the collector surface (Mg/W—Cu). The top Mg layer promotes unform Li wetting/dewetting and reduces electrodeposition/dissolution overpotentials by forming a Li—Mg solid-solution. The bottom W layer increases the chemical and electrochemical stability against sulfide SE and prevents Cu corrosion. Cryogenic focused-ion beam (cryo-FIB) analysis confirms uniform electrodeposition/dissolution, with no signs of voids or dendrites at the collector-SE interphase. The baseline Cu collector is unstable against the sulfide SE and is poorly wetted by the Li, leading to premature cell failure. Moreover, comparative analysis of single layer Mg-coated Cu (Mg—Cu) and single layer W-coated Cu (W—Cu) highlights the deficiency of each: The Mg—Cu collector shows Cu corrosion during long-term cycling, while the W—Cu collector leads to inhomogeneous Li electrodeposition/dissolution.

Additional explanation and examples can be found in Hao H, et.al., “Tuned Reactivity at the Lithium Metal-Argyrodite Solid State Electrolyte Interphase”, Advanced Energy Materials. 2023 December; 13(46): 2301338, which is expressly incorporated herein by reference.

### Exemplary Aspects

Exemplary aspect 1. An electrochemical cell comprising: a first electrode comprising one or more monovalent and/or multivalent metal; a solid-state electrolyte comprising the one or more monovalent and/or multivalent metal; and an intermetallic layer disposed between the first electrode and the solid-state electrolyte, wherein the intermetallic layer comprises the one or more monovalent and/or multivalent metal and one or more metallic elements.

Exemplary aspect 2. The electrochemical cell of exemplary aspect 1, wherein the intermetallic layer is formed in situ.

Exemplary aspect 3. The electrochemical cell of exemplary aspect 1, wherein the intermetallic layer is formed ex situ.

Exemplary aspect 4. The electrochemical cell of any one of exemplary aspects 1-3, wherein the one or more metallic elements comprise chalcogens, chalcogenides, transition metals, semiconductors, halogens, cluster cations, cluster anions, polyatomic ions, hydrides, borohydrides, super-atomic cluster anions (SACA), cluster substituted sulfides, intermetallics, including BF₄, BH₄, F, Cl, Br, Te, Se, Bi, Sn, Sb, Pb, Al, or Ge, Ag, Cu₂Te, or a combinations thereof.

Exemplary aspect 5. The electrochemical cell of any one of exemplary aspects 1-4, wherein the one or more monovalent and/or multivalent metal comprises one of Li, Na, K, Zn, Mg, Al, Ca, or a combination thereof.

Exemplary aspect 6. The electrochemical cell of any one of exemplary aspects 1-5, wherein the intermetallic layer comprises a thermodynamically stable structure, a metastable structure, or a combination of equilibrium and metastable structures and compositions.

Exemplary aspect 7. The electrochemical cell of any one of exemplary aspects 1-6, wherein the intermetallic layer is formed by first disposing the one or more metallic elements onto the first electrode, the solid-state electrolyte, or a sacrificial substrate by mechanical pressing, rolling, spraying, slurry deposition, vacuum-based deposition such as PVD and CVD, or through sacrificial templating.

Exemplary aspect 8. The electrochemical cell of any one of exemplary aspects 1-7, wherein the intermetallic layer has a thickness of about 0.1 nanometers to about 500 nanometers.

Exemplary aspect 9. The electrochemical cell of any one of exemplary aspects 1-8, wherein the electrochemical cell further comprises a second electrode.

Exemplary aspect 10. The electrochemical cell of exemplary aspect 9, wherein the first electrode is an anode, and the second electrode is a cathode.

Exemplary aspect 11. The electrochemical cell of exemplary aspect 9, wherein the first electrode is a cathode, and the second electrode is an anode.

Exemplary aspect 12. The electrochemical cell of exemplary aspects 10 or 11, wherein the anode comprises Li, Na, K, Zn, Mg, Al, Ca, Li alloys, Li intermetallics, Li compounds, Na alloys, Na intermetallics, Na compounds, K alloys, K intermetallics, K compounds or any combination thereof.

Exemplary aspect 13. The electrochemical cell of exemplary aspects 10 or 11, wherein the cathode is a metal cathode, a ceramic cathode, or a composite cathode.

Exemplary aspect 14. The electrochemical cell of exemplary aspect 13, wherein the cathode comprises copper, carbon, graphite, sodium, potassium, lithium, magnesium, calcium, aluminum, layered oxides, vanadium-based cathode, sulfur-based cathode, spinels, olivines, or any combination thereof.

Exemplary aspect 15. The electrochemical cell of any one of exemplary aspects 1-14, wherein the solid-state electrolyte comprises at least one of sulfide compounds, LPSCLi, LPSB, LPSF, lithium thiophosphases, lithium thiosulfides, halides, garnet structure oxides, LISICON-type solids, NASICON- or KSICON-type phosphate glass ceramics, perovskite-type and anti-perovskite type compounds, nitrides, oxynitrides, argyrodite-type, or polymer-based electrolytes, or any combination thereof.

Exemplary aspect 16. The electrochemical cell of any one of exemplary aspects 1-14, wherein the solid-state electrolyte comprises M₆PS₅Cl, wherein M is the one or more monovalent and/or multivalent metal.

Exemplary aspect 17. The electrochemical cell of exemplary aspect 16, wherein the electrochemical cell exhibits reversible capacity for about 2-5000 or more cycles at about 0.01-10 mA/cm².

Exemplary aspect 18. The electrochemical cell of exemplary aspect 16, wherein the electrochemical cell exhibits continuous plating of about 0.1-20 mAh/cm2 at about 0.1-20 mA/cm².

Exemplary aspect 19. The electrochemical cell of exemplary aspect 16, wherein the electrochemical cell exhibits coulombic efficiency of greater than about 70% to 100%.

Exemplary aspect 20. A method of making an electrochemical cell, the method comprising: (a) providing an intermetallic complex disposed on a first substrate comprising a monovalent and/or multivalent metal, wherein the intermetallic complex comprises the one or more monovalent and/or multivalent metal of the first substrate; and (b) disposing a second substrate onto the intermetallic complex disposed on the first substrate.

Exemplary aspect 21. The method of exemplary aspect 20, wherein the intermetallic complex is formed in situ.

Exemplary aspect 22. The method of exemplary aspect 21, the method further comprising applying pressure to an intermetallic precursor disposed on the first substrate.

Exemplary aspect 23. The method of exemplary aspect 22, wherein the intermetallic precursor comprises one or more metallic elements disposed on a separator.

Exemplary aspect 24. The method of exemplary aspect 24, the method further comprising removing the separator before disposing the second substrate.

Exemplary aspect 25. The method of exemplary aspect 20, wherein the intermetallic complex is formed ex situ.

Exemplary aspect 26. The method of any one of exemplary aspects 20-25, the method further comprising disposing a third substrate onto the first substrate.

Exemplary aspect 27. The method of any one of exemplary aspects 20-25, the method further comprising disposing a third substrate onto the second substrate.

Exemplary aspect 28. The method of any one of exemplary aspects 20-27, wherein disposing includes one of mechanical pressing, rolling, spraying, slurry deposition, vacuum-based deposition such as PVD and CVD, or through a sacrificial templating.

Exemplary aspect 29. The method of any one of exemplary aspects 24-28, wherein the one or more metallic elements comprise chalcogens, chalcogenides, transition metals, semiconductors, halogens, cluster cations, cluster anions, polyatomic ions, hydrides, borohydrides, super-atomic cluster anions (SACA), cluster substituted sulfides, intermetallics, including BF₄, BH₄, F, Cl, Br, Te, Se, Bi, Sn, Sb, Pb, Al, or Ge, Ag, Cu₂Te, or a combinations thereof.

Exemplary aspect 30. The method of any one of exemplary aspects 24-29, wherein the separator is a polypropylene separator, nylon, cellulose base or any combination thereof.

Exemplary aspect 31. The method of any one of exemplary aspects 22-24, wherein the intermetallic precursor comprises about 0.0001 mg/cm2 to about 1000 mg/cm2 of the one or more metallic elements disposed on the separator.

Exemplary aspect 32. The method of any one of exemplary aspects 22-24, wherein the one or more metallic elements have a thickness of about 1 nanometer to about 500 nanometer on the separator.

Exemplary aspect 33. The method of exemplary aspect 32, wherein the intermetallic precursor comprises at least one monolayer of the one or more metallic elements.

Exemplary aspect 34. The method of exemplary aspect 32, wherein the intermetallic precursor comprises a plurality of layers of the one or more metallic elements.

Exemplary aspect 35. The method of any one of Exemplary aspects 20-34, wherein the one or more monovalent and/or multivalent metal comprises one of Li, Na, K, Zn, Mg, Al, Ca, or a combination thereof.

Exemplary aspect 36. The method of exemplary aspect 26, wherein the first substrate is a solid-state electrolyte, the second substrate is a cathode, and third substrate is an anode.

Exemplary aspect 37. The method of exemplary aspect 26, wherein the first substrate is a solid-state electrolyte, the second substrate is an anode, and the third substrate is a cathode.

Exemplary aspect 38. The method of exemplary aspect 27, wherein the first substrate is an anode, the second substrate is a solid-state electrolyte, and the third substrate is a cathode.

Exemplary aspect 39. The method of exemplary aspect 27, wherein the first substrate is a cathode, the second substrate is a solid-state electrolyte, and the third substrate is an anode.

Exemplary aspect 40. The method of any one of exemplary aspects 36-39, wherein the anode comprises Li, Na, K, Zn, Mg, Al, Ca, Li alloys, Li intermetallics, Li compounds, Na alloys, Na intermetallics, Na compounds, K alloys, K intermetallics, K compounds or any combination thereof.

Exemplary aspect 41. The method of any one of exemplary aspects 36-40, wherein the solid-state electrolyte comprises at least one of sulfide compounds, LPSCLi, LPSB, LPSF, lithium thiophosphases, lithium thiosulfides, halides, garnet structure oxides, LISICON-type solids, NASICON- or KSICON-type phosphate glass ceramics, perovskite-type and anti-perovskite type compounds, nitrides, oxynitrides, argyrodite-type, or polymer-based electrolytes, or any combination thereof.

Exemplary aspect 42. The method of any one of exemplary aspects 36-41, wherein the solid-state electrolyte comprises M₆PS₅Cl, wherein M is the one or more monovalent and/or multivalent metal.

Exemplary aspect 43. The method of any one of exemplary aspects 36-42, wherein the cathode is a metal cathode, a ceramic cathode, or a composite cathode.

Exemplary aspect 44. The method of any one of exemplary aspects 36-43, wherein the cathode comprises copper, carbon, graphite, sodium, potassium, lithium, magnesium, calcium, aluminum, layered oxides, vanadium-based cathode, sulfur-based cathode, spinels, olivines, or any combination thereof.

Exemplary aspect 45. An electrochemical cell, comprising: a first substrate comprising a conductive metal; a solid-state electrolyte comprising one or more monovalent and/or multivalent metal; and an intermetallic bilayer disposed between the first substrate and the solid-state electrolyte, wherein the intermetallic bilayer comprises a first metallic layer comprising a first metal, and a second metallic layer comprising a second metal; wherein the first metallic layer is adjacent to the first substrate and is disposed between the first substrate and the second metallic layer.

Exemplary aspect 46. The electrochemical cell of Exemplary aspect 45, wherein the conductive metal comprises copper, silver, gold, iron, steel, including stainless steel, platinum, lithium, aluminum, or a combination thereof.

Exemplary aspect 47. The electrochemical cell of exemplary aspect 45, wherein the conductive metal comprises copper, aluminum, stainless steel, or a combination thereof.

Exemplary aspect 48. The electrochemical cell of exemplary aspect 45, wherein the conductive metal comprises copper.

Exemplary aspect 49. The electrochemical cell of exemplary aspect 45, wherein the first metal comprises tungsten.

Exemplary aspect 50. The electrochemical cell of exemplary aspect 45, wherein the second metal comprises magnesium, gold, silver, aluminum, platinum, zinc, tin, copper, nickel, titanium, or a combination thereof.

Exemplary aspect 51. The electrochemical cell of exemplary aspect 45, wherein the second metal comprises magnesium, aluminum, zinc, or a combination thereof.

Exemplary aspect 52. The electrochemical cell of exemplary aspect 45, wherein the second metal comprises magnesium.

Exemplary aspect 53. The electrochemical cell of exemplary aspect 45, wherein the conductive metal comprises copper, the first metal comprises tungsten, and the second metal comprises magnesium.

Exemplary aspect 54. The electrochemical cell of any of exemplary aspects 45-53, wherein the first metal has a thickness that is from 1-500 nm, from 1-250 nm, from 1-100 nm, form 1-75 nm, from 1-50 nm, from 1-25 nm, from 1-10 nm, from 5-25 nm, from 10-50 nm, or from 50-100 nm.

Exemplary aspect 55. The electrochemical cell of any of exemplary aspects 45-54, wherein the second metal has a thickness that is from 1-1,000 nm, from 1-100 nm, from 100-1,000 nm, from 500-1,000 nm, from 100-500 nm, from 100-250 nm, from 250-500 nm, from 50-150 nm, from 200-300 nm, or from 150-300 nm.

Exemplary aspect 56. The electrochemical cell of any of exemplary aspects 45-55, wherein a surface of the second metallic layer facing away from the first metallic layer comprises crystalline second metal.

Exemplary aspect 57. The electrochemical cell of any of exemplary aspects 45-56, wherein the first substrate is a foam, a wire, or a film.

Exemplary aspect 58. The electrochemical cell of any of exemplary aspects 45-57, further comprising a cathode material.

Exemplary aspect 59. The electrochemical cell of exemplary aspect 58, wherein the cathode material comprises copper, carbon, graphite, sodium, potassium, lithium, magnesium, calcium, aluminum, layered oxides, vanadium-based cathode, sulfur-based cathode, spinels, olivines, or any combination thereof.

Exemplary aspect 60. The electrochemical cell of any of exemplary aspects 45-59, wherein the solid-state electrolyte comprises at least one of sulfide compounds, LPSCLi, LPSB, LPSF, lithium thiophosphases, lithium thiosulfides, halides, garnet structure oxides, LISICON-type solids, NASICON- or KSICON-type phosphate glass ceramics, perovskite-type and anti-perovskite type compounds, nitrides, oxynitrides, argyrodite-type, or polymer-based electrolytes, or any combination thereof.

Exemplary aspect 61. The electrochemical cell of any of exemplary aspects 45-60, wherein the solid-state electrolyte comprises M₆PS₅Cl, wherein M is the one or more monovalent and/or multivalent metal.

Exemplary aspect 62. A method of making the electrochemical cell of any of exemplary aspect 45-61, the method comprising: providing the first substrate; disposing the first metallic layer onto the first substrate; disposing the second metallic layer onto the first metallic layer; and disposing the solid-state electrolyte onto the second metallic layer.

Exemplary aspect 63. The method of exemplary aspect 62, further comprising applying pressure.

### REFERENCES

The following patents, applications, and publications, as listed below and throughout this document, are hereby incorporated by reference in their entirety herein.

### Example 1

[1] T. Krauskopf, F. H. Richter, W. G. Zeier, J. Janek, Chem Rev 2020, 120, 7745-7794; bK. J. Kim, M. Balaish, M. Wadaguchi, L. Kong, J. L. M. Rupp, Advanced Energy Materials 2020, 11, 2002689; cR. Chen, Q. Li, X. Yu, L. Chen, H. Li, Chem Rev 2020, 120, 6820-6877; dH. Lee, P. Oh, J. Kim, H. Cha, S. Chae, S. Lee, J. Cho, Advanced Materials 2019, 31.
[2] L. Ye, X. Li, Nature 2021, 593, 218-222; cY G. Lee, S. Fujiki, C. Jung, N. Suzuki, N. Yashiro, R. Omoda, D. S. Ko, T. Shiratsuchi, T. Sugimoto, S. Ryu, J. H. Ku, T. Watanabe, Y. Park, Y. Aihara, D. Im, I. T. Han, Nature Energy 2020, 5, 299-308; dJ. Lee, S. H. Choi, G. Im, K. J. Lee, T. Lee, J. Oh, N. Lee, H. Kim, Y. Kim, S. Lee, J. W. Choi, Advanced Materials 2022, 34.
[3] R. Fan, C. Liu, K. He, S. Ho-Sum Cheng, D. Chen, C. Liao, R. K. Y. Li, J. Tang, Z. Lu, ACS Appl. Mater. Interfaces 2020, 12, 7222-7231; bS. J. Liu, L. Zhou, J. Han, K. H. Wen, S. D. Guan, C. J. Xue, Z. Zhang, B. Xu, Y. H. Lin, Y. Shen, L. L. Li, C. W. Nan, Advanced Energy Materials 2022, 12.
[4] Y. Wang, Y. Liu, M. Nguyen, J. Cho, N. Katyal, B. S. Vishnugopi, H. Hao, R. Fang, N. Wu, P. Liu, P. P. Mukherjee, J. Nanda, G. Henkelman, J. Watt, D. Mitlin, Adv Mater 2023, 35, e2206762.
[5] L. Zhou, K.-H. Park, X. Sun, F. Lalere, T. Adermann, P. Hartmann, L. F. Nazar, ACS Energy Letters 2018, 4, 265-270; bJ. Wu, S. Liu, F. Han, X. Yao, C. Wang, Adv Mater 2021, 33, e2000751; cN. Kamaya, K. Homma, Y Yamakawa, M. Hirayama, R. Kanno, M. Yonemura, T. Kamiyama, Y. Kato, S. Hama, K. Kawamoto, A. Mitsui, Nat Mater 2011, 10, 682-686.
[6] S. Lou, F. Zhang, C. Fu, M. Chen, Y. Ma, G. Yin, J. Wang, Adv Mater 2020, e2000721; bS. F. Lou, F. Zhang, C. K. Fu, M. Chen, Y L. Ma, G. P. Yin, J. J. Wang, Advanced Materials 2021, 33; cA. Banerjee, X. Wang, C. Fang, E. A. Wu, Y. S. Meng, Chem Rev 2020, 120, 6878-6933; dW D. Richards, L. J. Miara, Y. Wang, J. C. Kim, G. Ceder, Chemistry of Materials 2015, 28, 266-273; eY Xiao, Y. Wang, S.-H. Bo, J. C. Kim, L. J. Miara, G. Ceder, Nature Reviews Materials 2019, 5, 105-126.
[7] H. C. Hao, T. Hutter, B. L. Boyce, J. Watt, P. C. Liu, D. Mitlin, Chemical Reviews 2022, 122, 8053-8125.
[8] B. Zheng, J. Zhu, H. Wang, M. Feng, E. Umeshbabu, Y. Li, Q. H. Wu, Y. Yang, ACS Appl Mater Interfaces 2018, 10, 25473-25482.
[9] S. Wenzel, T. Leichtweiss, D. KrOger, J. Sann, J. Janek, Solid State Ionics 2015, 278, 98-105.
[10] X. Ji, S. Hou, P. Wang, X. He, N. Piao, J. Chen, X. Fan, C. Wang, Adv Mater 2020, 32, e2002741; bS. T. Luo, Z. Y. Wang, X. L. Li, X. Y. Liu, H. D. Wang, W. G. Ma, L. Q. Zhang, L. Y. Zhu, X. Zhang, Nature Communications 2021, 12.
[11] Q. Zhang, D. Cao, Y. Ma, A. Natan, P. Aurora, H. Zhu, Adv Mater 2019, 31, e1901131.
[12] aJ. Zhang, C. Zheng, L. J. Li, Y. Xia, H. Huang, Y. P. Gan, C. Liang, X. P. He, X. Y. Tao, W. K. Zhang, Advanced Energy Materials 2020, 10; bT K. Schwietert, V. A. Arszelewska, C. Wang, C. Yu, A. Vasileiadis, N. J. J. de Klerk, J. Hageman, T. Hupfer, I. Kerkamm, Y. L. Xu, E. van der Maas, E. M. Kelder, S. Ganapathy, M. Wagemaker, Nature Materials 2020, 19, 428-+; cZ. Y Ning, D. S. Jolly, G. C. Li, R. De Meyere, S. D. D. Pu, Y. Chen, J. Kasemchainan, J. Ihli, C. Gong, B. Y. Liu, D. L. R. Melvin, A. Bonnin, O. Magdysyuk, P. Adamson, G. O. Hartley, C. W. Monroe, T. J. Marrow, P. G. Bruce, Nature Materials 2021, 20, 1121-+; dC. Zheng, J. Zhang, Y. Xia, H. Huang, Y. P. Gan, C. Liang, X. P. He, X. Y. Tao, W. K. Zhang, Small 2021, 17; eC. Lee, S. Y Han, J. A. Lewis, P. P. Shetty, D. Yeh, Y. Liu, E. Klein, H. W. Lee, M. T. McDowell, Acs Energy Letters 2021, 6, 3261-3269; fJ. M. Doux, H. Nguyen, D. H. S. Tan, A. Banerjee, X. F. Wang, E. A. Wu, C. Jo, H. D. Yang, Y. S. Meng, Advanced Energy Materials 2020, 10; gT Cheng, B. V. Merinov, S. Morozov, W. A. Goddard, Acs Energy Letters 2017, 2, 1454-1459.
[13] J. F. Wang, A. A. Panchal, G. S. Gautam, P. Canepa, Journal of Materials Chemistry A 2022, 10, 19732-19742.
[14] aD. S. Jolly, Z. Y. Ning, G. O. Hartley, B. Y. Liu, D. L. R. Melvin, P. Adamson, J. Marrow, P. G. Bruce, Acs Applied Materials & Interfaces 2021, 13, 22708-22716; bJ. Kasemchainan, S. Zekoll, D. S. Jolly, Z. Y Ning, G. O. Hartley, J. Marrow, P. G. Bruce, Nature Materials 2019, 18, 1105-+.
[15] aC. Wang, J. Liang, Y. Zhao, M. Zheng, X. Li, X. Sun, Energy & Environmental Science 2021, 14, 2577-2619; bY Li, W Arnold, J. B. Jasinski, A. Thapa, G. Sumanasekera, M. Sunkara, B. Narayanan, T. Druffel, H. Wang, Electrochimica Acta 2020, 363, 137128; cY Wang, J. Ju, S. Dong, Y Yan, F. Jiang, L. Cui, Q. Wang, X. Han, G. Cui, Advanced Functional Materials 2021, 31, 2101523; dF. P. Zhao, Q. Sun, C. Yu, S. M. Zhang, K. Adair, S. Z. Wang, Y. L. Liu, Y. Zhao, J. W. Liang, C. H. Wang, X. N. Li, X. Li, W. Xia, R. Y. Li, H. Huang, L. Zhang, S. Q. Zhao, S. G. Lu, X. L. Sun, Acs Energy Letters 2020, 5, 1035-1043; eC. Wang, X. Sun, L. Yang, D. Song, Y. Wu, T. Ohsaka, F. Matsumoto, J. Wu, Advanced Materials Interfaces 2020, 8, 2001698; fH. Park, J. Kim, D. Lee, J. Park, S. Jo, J. Kim, T. Song, U. Paik, Adv Sci (Weinh) 2021, 8, e2004204; gH. J. Choi, D. W. Kang, J. W. Park, J. H. Park, Y. J. Lee, Y. C. Ha, S. M. Lee, S. Y. Yoon, B. G. Kim, Advanced Science 2022, 9; hB. Q. Li, Z. Sun, N. Lv, Y Q. Hu, L. X. Jiang, Z. L. Zhang, F. Y. Liu, Acs Applied Materials & Interfaces; iY Liu, H. Su, M. Li, J. Y. Xiang, X. Z. Wu, Y. Zhong, X. L. Wang, X. H. Xia, C. D. Gu, J. P. Tu, Journal of Materials Chemistry A 2021, 9, 13531-13539.
[16] C. Hansel, B. Singh, D. Kiwic, P. Canepa, D. Kundu, Chemistry of Materials 2021, 33, 6029-6040.
[17] C. Kim, J. Kim, J. Park, J. Kim, S. Lee, S. Sun, S. Myung, D. Lee, K. Park, I. Jang, S. Kim, H. Lee, H. Jung, U. Paik, T. Song, Advanced Energy Materials 2021, 11, 2102045.
[18] Z. J. Fan, B. Ding, Z. W. Li, B. Hu, C. Xu, C. Y. Xu, H. Dou, X. G. Zhang, Small.
[19] Z. Sun, Y. Lai, N. Lv, Y. Hu, B. Li, L. Jiang, J. Wang, S. Yin, K. Li, F. Liu, ACS Appl Mater Interfaces 2021, 13, 54924-54935.
[20] B. W. Taklu, W. N. Su, Y. Nikodimos, K. Lakshmanan, N. T. Temesgen, P. X. Lin, S. K. Jiang, C. J. Huang, D. Y. Wang, H. S. Sheu, S. H. Wu, B. J. Hwang, Nano Energy 2021, 90.
[21] H. Liu, Q. S. Zhu, C. Wang, G. X. Wang, Y. H. Liang, D. B. Li, L. Gao, L. Z. Fan, Advanced Functional Materials 2022, 32.
[22] Y. Liu, H. Su, Y. Zhong, X. L. Wang, X. H. Xia, C. D. Gu, J. P. Tu, Advanced Functional Materials.
[23] R. Song, J. Yao, R. Xu, Z. Li, X. Yan, C. Yu, Z. Huang, L. Zhang, Advanced Energy Materials 2023, 13, 2203631.
[24] S. Wenzel, S. J. Sedlmaier, C. Dietrich, W. G. Zeier, J. Janek, Solid State Ionics 2018, 318, 102-112.
[25] H. L. Wan, J. X. Zhang, J. L. Xia, X. Ji, X. Z. He, S. F. Liu, C. S. Wang, Advanced Functional Materials 2022, 32.
[26] J. Su, M. Pasta, Z. Y. Ning, X. W. Gao, P. G. Bruce, C. R. M. Grovenor, Energy & Environmental Science 2022, 15, 3805-3814.
[27] F. J. Simon, M. Hanauer, A. Henss, F. H. Richter, J. Janek, Acs Applied Materials & Interfaces 2019, 11, 42186-42196.
[28] H. Wan, Z. Wang, S. Liu, B. Zhang, X. He, W. Zhang, C. Wang, Nature Energy 2023.
[29] Y. Chen, W. W. Li, C. Z. Sun, J. Jin, Q. Wang, X. D. Chen, W. P. Zha, Z. Y. Wen, Advanced Energy Materials 2021, 11.
[30] Y. Chen, L. Yao, X. D. Chen, J. Jin, M. F. Wu, Q. Wang, W. P. Zha, Z. Y. Wen, Acs Applied Materials & Interfaces 2022, 14, 11950-11961.
[31] H. Lim, S. Jun, Y. B. Song, H. Bae, J. H. Kim, Y. S. Jung, Energy Storage Materials 2022, 50, 543-553.
[32] H. Su, Y. Liu, Y. Zhong, J. R. Li, X. L. Wang, X. H. Xia, C. D. Gu, J. P. Tu, Nano Energy 2022, 96.
[33] J. Li, Y. Li, S. Zhang, T. Liu, D. Li, L. Ci, ACS Appl Mater Interfaces 2022, 14, 55727-55734.
[34] W. Wu, G. Qiu, Y. Wang, R. Wang, P. Ye, Chem Soc Rev 2018, 47, 7203-7212.
[35] aR. Jain, Y. Yuan, Y. Singh, S. Basu, D. Wang, A. Yang, X. Wang, M. Rong, H. J. Lee, D. Frey, R. Khadka, P. Hundekar, S. O. Kim, F. Han, L. W. Wang, D. Mitlin, R. Shahbazian-Yassar, N. Koratkar, Advanced Energy Materials 2020, 11, 2003248; bY Wang, G. Qiu, R. Wang, S. Huang, Q. Wang, Y. Liu, Y Du, W. A. Goddard, M. J. Kim, X. Xu, P. D. Ye, W. Wu, Nature Electronics 2018, 1, 228-236.
[36] R. Schlenker, D. Stepien, P. Koch, T. Hupfer, S. Indris, B. Roling, V. Miss, A. Fuchs, M. Wilhelmi, H. Ehrenberg, Acs Applied Materials & Interfaces 2020, 12, 20012-20025.
[37] D. Zeng, J. Yao, L. Zhang, R. Xu, S. Wang, X. Yan, C. Yu, L. Wang, Nat Commun 2022, 13, 1909.
[38] D. H. S. Tan, E. A. Wu, H. Nguyen, Z. Chen, M. A. T. Marple, J. M. Doux, X. F. Wang, H. D. Yang, A. Banerjee, Y. S. Meng, Acs Energy Letters 2019, 4, 2418-2427.
[39] aA. L. Davis, E. Kazyak, D. W. Liao, K. N. Wood, N. P. Dasgupta, Journal of The Electrochemical Society 2021, 168, 070557; bS. Narayanan, U. Ulissi, J. S. Gibson, Y. A. Chart, R. S. Weatherup, M. Pasta, Nat Commun 2022, 13, 7237; cE. Querel, N. J. Williams, I. D. Seymour, S. J. Skinner, A. Aguadero, Chem Mater 2023, 35, 853-862.
[40] Y. Zhou, C. Doerrer, J. Kasemchainan, P. G. Bruce, M. Pasta, L. J. Hardwick, Batteries & Supercaps 2020, 3, 647-652.
[41] aM. K. Burdette-Trofimov, B. L. Armstrong, J. Nelson Weker, A. M. Rogers, G. Yang, E. C. Self, R. R. Armstrong, J. Nanda, G. M. Veith, ACS Appl Mater Interfaces 2020, 12, 55954-55970; bG. Yang, M. L. Lehmann, S. Zhao, B. Li, S. Ge, P.-F. Cao, F. M. Delnick, A. P. Sokolov, T. Saito, J. Nanda, Energy Storage Materials 2021, 35, 431-442; cG. Yang, R. Tao, C. J. Jafta, C. Shen, S. Zhao, L. He, I. Belharouak, J. Nanda, The Journal of Physical Chemistry C 2021, 125, 13146-13157; dG. Yang, X. Li, Y Cheng, M. Wang, D. Ma, A. P. Sokolov, S. V. Kalinin, G. M. Veith, J. Nanda, Nat Commun 2021, 12, 578.
[42] aN. Ahmad, S. Sun, P. Yu, W. Yang, Advanced Functional Materials 2022, 32, 2201528; bN. H. H. Phuc, K. Morikawa, T. Mitsuhiro, H. Muto, A. Matsuda, Ionics 2017, 23, 2061-2067; cG. H. Lee, S. G. Lee, S. H. Park, D. Jun, Y. J. Lee, Journal of Materials Chemistry A 2022, 10, 10662-10671; dH. Stöffler, T. Zinkevich, M. Yavuz, A.-L. Hansen, M. Knapp, J. Bednarčik, S. Randau, F. H. Richter, J. Janek, H. Ehrenberg, S. Indris, The Journal of Physical Chemistry C 2019, 123, 10280-10290; eJ. Li, W. Liu, X. Zhang, Y Ma, Y Wei, Z. Fu, J. Li, Y Yan, Journal of Solid State Electrochemistry 2021, 25, 1259-1269.
[43] S. N. Yannopoulos, Journal of Materials Science: Materials in Electronics 2020, 31, 7565-7595.
[44] Z. Chen, Z. Liang, H. Zhong, Y. Su, K. Wang, Y. Yang, ACS Energy Letters 2022, 7, 2761-2770.
[45] A. Jain, S. P. Ong, G. Hautier, W. Chen, W. D. Richards, S. Dacek, S. Cholia, D. Gunter, D. Skinner, G. Ceder, K. A. Persson, APL Materials 2013, 1, 011002.
[46] S. Liu, X. Ji, J. Yue, S. Hou, P. Wang, C. Cui, J. Chen, B. Shao, J. Li, F. Han, J. Tu, C. Wang, J Am Chem Soc 2020, 142, 2438-2447.
[47] Energy Materials 2023.
[48] aH. Chen, A. Pei, D. Lin, J. Xie, A. Yang, J. Xu, K. Lin, J. Wang, H. Wang, F. Shi, D. Boyle, Y. Cui, Advanced Energy Materials 2019, 9, 1900858; bZ. Luo, S. Li, L. Yang, Y. Tian, L. Xu, G. Zou, H. Hou, W. Wei, L. Chen, X. Ji, Nano Energy 2021, 87, 106212.
[49] D. K. Singh, A. Henss, B. Mogwitz, A. Gautam, J. Horn, T. Krauskopf, S. Burkhardt, J. Sann, F. H. Richter, J. Janek, Cell Reports Physical Science 2022, 3, 101043.
[1′] aG. Yang, R. Tao, C. J. Jafta, C. Shen, S. Zhao, L. He, I. Belharouak, J. Nanda, The Journal of Physical Chemistry C 2021, 125, 13146-13157; bG. Yang, X. Li, Y. Cheng, M. Wang, D. Ma, A. P. Sokolov, S. V. Kalinin, G. M. Veith, J. Nanda, Nat Commun 2021, 12, 578.
[2′] J. MacQueen, in Proceedings of the fifth Berkeley symposium on mathematical statistics and probability, Vol. 1, Oakland, CA, USA, 1967, pp. 281-297.
[3′] Y. Zhu, X. He, Y. Mo, Journal of Materials Chemistry A 2016, 4, 3253-3266.
[4′] A. Jain, S. P. Ong, G. Hautier, W. Chen, W. D. Richards, S. Dacek, S. Cholia, D. Gunter, D. Skinner, G. Ceder, K. A. Persson, APL Materials 2013, 1, 011002.
[5′]
[6′] a; bP. E. Blochl, Phys Rev B Condens Matter 1994, 50, 17953-17979.
[7′] M. S. Hybertsen, S. G. Louie, Phys Rev B Condens Matter 1986, 34, 5390-5413.
[8′] aA. V. Krukau, O. A. Vydrov, A. F. Izmaylov, G. E. Scuseria, J Chem Phys 2006, 125, 224106; bJ. Heyd, G. E. Scuseria, J Chem Phys 2004, 121, 1187-1192.
[9′]
[10′] J. S. Lowe, D. J. Siegel, ACS Appl Mater Interfaces 2020, 12, 46015-46026.
[11′] S. Smidstrup, T. Markussen, P. Vancraeyveld, J. Wellendorff, J. Schneider, T. Gunst, B. Verstichel, D. Stradi, P. A. Khomyakov, U. G. Vej-Hansen, M. E. Lee, S. T. Chill, F. Rasmussen, G. Penazzi, F. Corsetti, A. Ojanpera, K. Jensen, M. L. N. Palsgaard, U. Martinez, A. Blom, M. Brandbyge, K. Stokbro, J Phys Condens Matter 2020, 32, 015901.
[12′] Z. Souadia, A. Bouhemadou, R. Khenata, Y. Al-Douri, Physica B 2017, 521, 204-214.
[13′] K. T. Butler, G. Sai Gautam, P. Canepa, npj Computational Materials 2019, 5.
[14′] N. T. Taylor, F. H. Davies, I. E. M. Rudkin, C. J. Price, T. H. Chan, S. P. Hepplestone, Comput Phys Commun 2020, 257.
[15′] P. Barai, K. Higa, V. Srinivasan, Phys Chem Chem Phys 2017, 19, 20493-20505.
[16′] C. Wang, X. Sun, L. Yang, D. Song, Y. Wu, T. Ohsaka, F. Matsumoto, J. Wu, Advanced Materials Interfaces 2020, 8, 2001698.
[17′] B. Q. Li, Z. Sun, N. Lv, Y. Q. Hu, L. X. Jiang, Z. L. Zhang, F. Y. Liu, Acs Applied Materials & Interfaces.
[18′] Y. Chen, W. W. Li, C. Z. Sun, J. Jin, Q. Wang, X. D. Chen, W. P. Zha, Z. Y. Wen, Advanced Energy Materials 2021, 11.
[19′] H. Su, Y. Liu, Y. Zhong, J. R. Li, X. L. Wang, X. H. Xia, C. D. Gu, J. P. Tu, Nano Energy 2022, 96.
[20′] Y. Chen, L. Yao, X. D. Chen, J. Jin, M. F. Wu, Q. Wang, W. P. Zha, Z. Y. Wen, Acs Applied Materials & Interfaces 2022, 14, 11950-11961.
[21′] C. Kim, J. Kim, J. Park, J. Kim, S. Lee, S. Sun, S. Myung, D. Lee, K. Park, I. Jang, S. Kim, H. Lee, H. Jung, U. Paik, T. Song, Advanced Energy Materials 2021, 11, 2102045.
[22′] H. Lim, S. Jun, Y. B. Song, H. Bae, J. H. Kim, Y. S. Jung, Energy Storage Materials 2022, 50, 543-553.
[23′] H. Park, J. Kim, D. Lee, J. Park, S. Jo, J. Kim, T. Song, U. Paik, Adv Sci (Weinh) 2021, 8, e2004204.
[24′] Z. J. Fan, B. Ding, Z. W. Li, B. Hu, C. Xu, C. Y. Xu, H. Dou, X. G. Zhang, Small.
[25′] H. J. Choi, D. W. Kang, J. W. Park, J. H. Park, Y. J. Lee, Y. C. Ha, S. M. Lee, S. Y. Yoon, B. G. Kim, Adv Sci (Weinh) 2022, 9, e2103826.

### Example 2

[1] J. B. Goodenough, Y. Kim, Chem. Mater. 2009, 22, 587.
[2] Y. Zhu, J. C. Gonzalez-Rosillo, M. Balaish, Z. D. Hood, K. J. Kim, J. L. M. Rupp, Nat. Rev. Mater. 2020, 6, 313.
[3] D. H. S. Tan, A. Banerjee, Z. Chen, Y. S. Meng, Nat. Nanotechnol. 2020, 15, 170.
[4] J. Janek, W. G. Zeier, Nat. Energy 2016, 1, 1.
[5] P. Albertus, V. Anandan, C. Ban, N. Balsara, I. Belharouak, J. Buettner-Garrett, Z. Chen, C. Daniel, M. Doeff, N. J. Dudney, B. Dunn, S. J. Harris, S. Herle, E. Herbert, S. Kalnaus, J. A. Libera, D. Lu, S. Martin, B. D. McCloskey, M. T. McDowell, Y. S. Meng, J. Nanda, J. Sakamoto, E. C. Self, S. Tepavcevic, E. Wachsman, C. Wang, A. S. Westover, J. Xiao, T. Yersak, ACS Energy Lett. 2021, 4, 1399.
[6] V. Raj, V. Venturi, V. R. Kankanallu, B. Kuiri, V. Viswanathan, N. P. B. Aetukuri, Nat. Mater. 2022, 21, 1050.
[7] R. Pacios, A. Villaverde, M. Martínez-Ibañez, M. Casas-Cabanas, F. Aguesse, A. Kvasha, Adv. Energy Mater. 2023, 13, 2301018.
[8] C. Wang, J. Liang, J. T. Kim, X. Sun, Sci. Adv. 2022, 8, eadc9516.
[9] C. X. Bi, M. Zhao, L. P. Hou, Z. X. Chen, X. Q. Zhang, B. Q. Li, H. Yuan, J. Q. Huang, Adv. Sci. 2022, 9, e2103910.
[10] S. Kim, G. Park, S. J. Lee, S. Seo, K. Ryu, C. H. Kim, J. W. Choi, Adv. Mater. 2023, 35, e2206625.
[11] J. Liu, Z. Bao, Y. Cui, E. J. Dufek, J. B. Goodenough, P. Khalifah, Q. Li, B. Y. Liaw, P. Liu, A. Manthiram, Y. S. Meng, V. R. Subramanian, M. F. Toney, V. V. Viswanathan, M. S. Whittingham, J. Xiao, W. Xu, J. Yang, X.-Q. Yang, J.-G. Zhang, Nat. Energy 2019, 4, 180.
[12] P. Shi, X. Q. Zhang, X. Shen, R. Zhang, H. Liu, Q. Zhang, Adv. Mater. Technol. 2019, 5.
[13] Q. Wang, B. Liu, Y. Shen, J. Wu, Z. Zhao, C. Zhong, W. Hu, Adv. Sci. 2021, 8, e2101111.
[14] J. Kang, D. Y. Han, S. Kim, J. Ryu, S. Park, Adv. Mater. 2023, 35, e2203194.
[15] V. Raj, N. P. B. Aetukuri, J. Nanda, Curr. Opin. Solid State Mater. Sci. 2022, 26, 100999.
[16] H. Zhao, W. Y. A. Lam, L. Sheng, L. Wang, P. Bai, Y. Yang, D. Ren, H. Xu, X. He, Adv. Energy Mater. 2022, 12, 2103894.
[17] X. Feng, H. Fang, N. Wu, P. Liu, P. Jena, J. Nanda, D. Mitlin, Joule 2022, 6, 543.
[18] Q. Lv, Y. Jiang, B. Wang, Y. Chen, F. Jin, B. Wu, H. Ren, N. Zhang, R. Xu, Y. Li, T. Zhang, Y. Zhou, D. Wang, H. Liu, S. Dou, Cell Rep. Phys. Sci. 2022, 3, 100706.
[19] C. Wang, C. Wang, M. Li, S. Zhang, C. Zhang, S. Chou, J. Mao, Z. Guo, Mater. Today 2023, 72, 235.
[20] J. Gu, H. Zhong, Z. Chen, J. Shi, Z. Gong, Y. Yang, Chem. Eng. J. 2023, 454, 139923.
[21] H. Liu, Y. Liang, C. Wang, D. Li, X. Yan, C. W. Nan, L. Z. Fan, Adv. Mater. 2023, 35, e2206013.
[22] J. Wang, L. Chen, H. Li, F. Wu, Energy Environ. Mater. 2023, 6, e12613.
[23] J. Kasemchainan, S. Zekoll, D. Spencer Jolly, Z. Ning, G. O. Hartley, J. Marrow, P. G. Bruce, Nat. Mater. 2019, 18, 1105.
[24] S. Randau, D. A. Weber, O. Kötz, R. Koerver, P. Braun, A. Weber, E. Ivers-Tiffée, T. Adermann, J. Kulisch, W. G. Zeier, F. H. Richter, J. Janek, Nat. Energy 2020, 5, 259.
[25] J. Zhang, C. Zheng, L. J. Li, Y. Xia, H. Huang, Y. P. Gan, C. Liang, X. P. He, X. Y. Tao, W. K. Zhang, Adv. Energy Mater. 2020, 10, 1903311.
[26] Q. Zhang, D. Cao, Y. Ma, A. Natan, P. Aurora, H. Zhu, Adv. Mater. 2019, 31, e1901131.
[27] D. H. S. Tan, E. A. Wu, H. Nguyen, Z. Chen, M. A. T. Marple, J. M. Doux, X. F. Wang, H. D. Yang, A. Banerjee, Y. S. Meng, ACS Energy Lett. 2019, 4, 2418.
[28] S. Narayanan, U. Ulissi, J. S. Gibson, Y. A. Chart, R. S. Weatherup, M. Pasta, Nat. Commun. 2022, 13, 7237.
[29] A. Banerjee, X. Wang, C. Fang, E. A. Wu, Y. S. Meng, Chem. Rev. 2020, 120, 6878.
[30] S. Li, S. J. Yang, G. X. Liu, J. K. Hu, Y. L. Liao, X. L. Wang, R. Wen, H. Yuan, J. Q. Huang, Q. Zhang, Adv. Mater. 2023, 36, e2307768.
[31] F. Ren, Z. Liang, W. Zhao, W. Zuo, M. Lin, Y. Wu, X. Yang, Z. Gong, Y. Yang, Energy Environ. Sci. 2023, 16, 2579.
[32] D. Zeng, J. Yao, L. Zhang, R. Xu, S. Wang, X. Yan, C. Yu, L. Wang, Nat. Commun. 2022, 13, 1909.
[33] H. Hao, Y. Liu, S. M. Greene, G. Yang, K. G. Naik, B. S. Vishnugopi, Y. Wang, H. Celio, A. Dolocan, W. Y. Tsai, R. Fang, J. Watt, P. P. Mukherjee, D. J. Siegel, D. Mitlin, Adv. Energy Mater. 2023, 13, 2301338.
[34] Y. Wang, H. Hao, K. G. Naik, B. S. Vishnugopi, C. D. Fincher, Q. Yan, V. Raj, H. Celio, G. Yang, H. Fang, Y. M. Chiang, F. A. Perras, P. Jena, J. Watt, P. P. Mukherjee, D. Mitlin, Adv. Energy Mater. 2024, DOI: 10.1002/aenm.202304530.
[35] Y. Wang, Y. Liu, M. Nguyen, J. Cho, N. Katyal, B. S. Vishnugopi, H. Hao, R. Fang, N. Wu, P. Liu, P. P. Mukherjee, J. Nanda, G. Henkelman, J. Watt, D. Mitlin, Adv. Mater. 2023, 35, e2206762.
[36] B. S. Vishnugopi, E. Kazyak, J. A. Lewis, J. Nanda, M. T. McDowell, N. P. Dasgupta, P. P. Mukherjee, ACS Energy Lett. 2021, 6, 3734.
[37] J. M. Doux, H. Nguyen, D. H. S. Tan, A. Banerjee, X. Wang, E. A. Wu, C. Jo, H. Yang, Y. S. Meng, Adv. Energy Mater. 2019, 10, 1903253.
[38] J. A. Lewis, F. J. Q. Cortes, Y. Liu, J. C. Miers, A. Verma, B. S. Vishnugopi, J. Tippens, D. Prakash, T. S. Marchese, S. Y. Han, C. Lee, P. P. Shetty, H. W. Lee, P. Shevchenko, F. De Carlo, C. Saldana, P. P. Mukherjee, M. T. McDowell, Nat. Mater. 2021, 20, 503.
[39] T. Krauskopf, F. H. Richter, W. G. Zeier, J. Janek, Chem. Rev. 2020, 120, 7745.
[40] T. Krauskopf, H. Hartmann, W. G. Zeier, J. Janek, ACS Appl. Mater. Interfaces 2019, 11, 14463.
[41] R. Weber, M. Genovese, A. J. Louli, S. Hames, C. Martin, I. G. Hill, J. R. Dahn, Nat. Energy 2019, 4, 683.
[42] A. J. Louli, A. Eldesoky, R. Weber, M. Genovese, M. Coon, J. deGooyer, Z. Deng, R. T. White, J. Lee, T. Rodgers, R. Petibon, S. Hy, S. J. H. Cheng, J. R. Dahn, Nat. Energy 2020, 5, 693.
[43] M. Genovese, A. J. Louli, R. Weber, S. Hames, J. R. Dahn, J. Electrochem. Soc. 2018,165, A3321.
[44] S. Chen, J. Zhang, L. Nie, X. Hu, Y. Huang, Y. Yu, W. Liu, Adv. Mater. 2021, 33, e2002325.
[45] C. Heubner, S. Maletti, H. Auer, J. HOttl, K. Voigt, O. Lohrberg, K. Nikolowski, M. Partsch, A. Michaelis, Adv. Funct. Mater. 2021, 31, 2106608.
[46] W. Z. Huang, C. Z. Zhao, P. Wu, H. Yuan, W. E. Feng, Z. Y. Liu, Y. Lu, S. Sun, Z. H. Fu, J. K. Hu, S. J. Yang, J. Q. Huang, Q. Zhang, Adv. Energy Mater. 2022, 12, 2201044.
[47] J. Wen, T. Wang, C. Wang, Y. Dai, Z. Song, X. Liu, Q. Yu, X. Zheng, J. Ma, W. Luo, Y. Huang, Adv. Mater. 2023, 36, e2307732.
[48] Y. Wang, H. Dong, N. Katyal, H. Hao, P. Liu, H. Celio, G. Henkelman, J. Watt, D. Mitlin, Adv. Mater. 2022, 34, e2106005.
[49] B. Neudecker, N. Dudney, J. Bates, J. Electrochem. Soc. 2000, 147, 517.
[50] A. S. Westover, R. L. Sacci, N. Dudney, ACS Energy Lett. 2020, 5, 3860.
[51] D. Cheng, R. Shimizu, J. Weaver, Y. Shirley Meng, Microsc. Microanal. 2021, 27, 3324.
[52] M. J. Wang, E. Carmona, A. Gupta, P. Albertus, J. Sakamoto, Nat. Commun. 2020, 11, 5201.
[53] Y.-G. Lee, S. Fujiki, C. Jung, N. Suzuki, N. Yashiro, R. Omoda, D.-S. Ko, T. Shiratsuchi, T. Sugimoto, S. Ryu, J. H. Ku, T. Watanabe, Y. Park, Y. Aihara, D. Im, I. T. Han, Nat. Energy 2020, 5, 299.
[54] C. Wang, S. Hwang, M. Jiang, J. Liang, Y. Sun, K. Adair, M. Zheng, S. Mukherjee, X. Li, R. Li, H. Huang, S. Zhao, L. Zhang, S. Lu, J. Wang, C. V. Singh, D. Su, X. Sun, Adv. Energy Mater. 2021, 11.
[55] J. Zhou, M. L. Holekevi Chandrappa, S. Tan, S. Wang, C. Wu, H. Nguyen, C. Wang, H. Liu, S. Yu, Q. R. S. Miller, G. Hyun, J. Holoubek, J. Hong, Y. Xiao, C. Soulen, Z. Fan, E. E. Fullerton, C. J. Brooks, C. Wang, R. J. Clement, Y. Yao, E. Hu, S. P. Ong, P. Liu, Nature 2024, 627, 301.
[56] Z. Wang, J. Xia, X. Ji, Y. Liu, J. Zhang, X. He, W. Zhang, H. Wan, C. Wang, Nat. Energy 2024, 9, 251.
[57] R. Guo, K. Zhang, W. Zhao, Z. Hu, S. Li, Y. Zhong, R. Yang, X. Wang, J. Wang, C. Wu, Y. Bai, Energy Material Advances 2023, 4.
[58] H. Wan, Z. Wang, W. Zhang, X. He, C. Wang, Nature 2023, 623, 739.
[59] X. Miao, S. Guan, C. Ma, L. Li, C. W. Nan, Adv Mater 2023, 35, e2206402.
[60] B. Hagenhoff, Microchimica Acta 2000, 132, 259.
[61] J. C. Vickerman, ToF-SIMS: surface analysis by mass spectrometry 2001, 1.
[62] D. H. Tan, Y.-T. Chen, H. Yang, W. Bao, B. Sreenarayanan, J.-M. Doux, W. Li, B. Lu, S.-Y. Ham, B. Sayahpour, Science 2021, 373, 1494.
[63] L. Ye, X. Li, Nature 2021, 593, 218.
[64] J. Y. Kim, S. Jung, S. H. Kang, J. Park, M. J. Lee, D. Jin, D. O. Shin, Y. G. Lee, Y. M. Lee, Adv. Energy Mater. 2021, 12, 2103108.
[65] H. Hao, T. Hutter, B. L. Boyce, J. Watt, P. Liu, D. Mitlin, Chem. Rev. 2022, 122, 8053.
[66] C. Yang, H. Xie, W. Ping, K. Fu, B. Liu, J. Rao, J. Dai, C. Wang, G. Pastel, L. Hu, Adv. Mater. 2019, 31, el 804815.
[67] P. Gao, H. Wu, X. Zhang, H. Jia, J. M. Kim, M. H. Engelhard, C. Niu, Z. Xu, J. G. Zhang, W. Xu, Angew. Chem. Int. Ed. 2021, 60, 16506.
[68] S. Kaboli, P. Noel, D. Clément, H. Demers, A. Paolella, P. Bouchard, M. L. Trudeau, J. B. Goodenough, K. Zaghib, Sci. Adv. 2020, 6, eabd5708.
[69] L. Zhao, W. Li, C. Wu, Q. Ai, L. Guo, Z. Chen, J. Zheng, M. Anderson, H. Guo, J. Lou, Y. Liang, Z. Fan, J. Zhu, Y. Yao, Adv. Energy Mater. 2023, 13, 2300679.
[70] T. Krauskopf, B. Mogwitz, C. Rosenbach, W. G. Zeier, J. Janek, Adv. Energy Mater. 2019, 9, 1902568.
[71] M. Siniscalchi, J. Liu, J. S. Gibson, S. J. Turrell, J. Aspinall, R. S. Weatherup, M. Pasta, S. C. Speller, C. R. M. Grovenor, ACS Energy Lett. 2022, 7, 3593.
[72] Y. Zhang, K. S. R. Chandran, M. Jagannathan, H. Z. Bilheux, J. C. Bilheux, J. Electrochem. Soc. 2017, 164, A28.
[73] A. Kohandehghan, P. Kalisvaart, M. Kupsta, B. Zahiri, B. S. Amirkhiz, Z. Li, E. L. Memarzadeh, L. A. Bendersky, D. Mitlin, J. Mater. Chem. A 2013, 1, 1600.
[74] L. Beaulieu, K. Eberman, R. Turner, L. Krause, J. Dahn, Electrochem. Solid-State Lett. 2001, 4, A137.
[75] B. D. Adams, J. Zheng, X. Ren, W. Xu, J. G. Zhang, Adv. Energy Mater. 2017, 8, 1702097.
[76] J. Sangster, A. Pelton, Journal of phase equilibria 1991, 12, 203.
[77] S. Terlicka, P. Darlak, N. Sobczak, J. J. Sobczak, Materials 2022, 15, 9024.
[78] H. Okamoto, M. E. Schlesinger, E. M. Mueller, in Alloy Phase Diagrams, Vol. 3, ASM International 2016, p. 0.
[79] R. Guo, L. Lu, M. Ouyang, X. Feng, Sci. Rep. 2016, 6, 30248.
[80] L. Guo, D. B. Thornton, M. A. Koronfel, I. E. L. Stephens, M. P. Ryan, J. Phys. Energy 2021, 3, 032015.

1. An electrochemical cell comprising:
a first electrode comprising one or more monovalent and/or multivalent metal;
a solid-state electrolyte comprising the one or more monovalent and/or multivalent metal; and
an intermetallic layer disposed between the first electrode and the solid-state electrolyte, wherein the intermetallic layer comprises the one or more monovalent and/or multivalent metal and one or more metallic elements,
wherein the intermetallic layer is formed in situ or wherein the intermetallic layer is formed ex situ.

2. (canceled)

3. (canceled)

4. The electrochemical cell of claim 1, wherein the one or more metallic elements comprise chalcogens, chalcogenides, transition metals, semiconductors, halogens, cluster cations, cluster anions, polyatomic ions, hydrides, borohydrides, super-atomic cluster anions (SACA), cluster substituted sulfides, intermetallics, including BF₄, BH₄, F, Cl, Br, Te, Se, Bi, Sn, Sb, Pb, Al, or Ge, Ag, Cu₂Te, and/or wherein the one or more monovalent and/or multivalent metal comprises one of Li, Na, K, Zn, Mg, Al, Ca, or a combination thereof.

5. (canceled)

6. The electrochemical cell of claim 1, wherein the intermetallic layer comprises a thermodynamically stable structure, a metastable structure, or a combination of equilibrium and metastable structures and compositions.

7. (canceled)

8. The electrochemical cell of claim 1, wherein the intermetallic layer has a thickness of about 0.1 nanometers to about 500 nanometers.

9. (canceled)

10. The electrochemical cell of claim 1, wherein the electrochemical cell further comprises a second electrode, and wherein when the first electrode is an anode, and the second electrode is a cathode or wherein when the first electrode is a cathode, and the second electrode is an anode.

11. (canceled)

12. The electrochemical cell of claim 10, wherein the anode comprises Li, Na, K, Zn, Mg, Al, Ca, Li alloys, Li intermetallics, Li compounds, Na alloys, Na intermetallics, Na compounds, K alloys, K intermetallics, K compounds or any combination thereof, and wherein the cathode comprises copper, carbon, graphite, sodium, potassium, lithium, magnesium, calcium, aluminum, layered oxides, vanadium-based cathode, sulfur-based cathode, spinels, olivines, or any combination thereof.

13. (canceled)

14. (canceled)

15. The electrochemical cell of claim 1, wherein the solid-state electrolyte comprises at least one of sulfide compounds, LPSCLi, LPSB, LPSF, lithium thiophosphases, lithium thiosulfides, halides, garnet structure oxides, LISICON-type solids, NASICON- or KSICON-type phosphate glass ceramics, perovskite-type and anti-perovskite type compounds, nitrides, oxynitrides, argyrodite-type, or polymer-based electrolytes, or any combination thereof.

16. The electrochemical cell of claim 1, wherein the solid-state electrolyte comprises M₆PS₅Cl, wherein M is the one or more monovalent and/or multivalent metal.

17. The electrochemical cell of claim 16, wherein the electrochemical cell exhibits:
a) a reversible capacity for about 2-5000 or more cycles at about 0.01-10 mA/cm²s and/or
b) a continuous plating of about 0.01-20 mAh/cm² at about 0.01-20 mA/cm²; and/or
c) a coulombic efficiency of greater than about 70% to 100%.

18. (canceled)

19. (canceled)

20. A method of making an electrochemical cell, the method comprising:
a. providing an intermetallic complex disposed on a first substrate comprising one or more monovalent and/or multivalent metal, wherein the intermetallic complex comprises the one or more monovalent and/or multivalent metal of the first substrate, wherein the one or more monovalent and/or multivalent metal comprises one of Li, Na, K, Zn, Mg, Al, Ca, or a combination thereof; and
b. disposing a second substrate onto the intermetallic complex disposed on the first substrate, wherein the intermetallic complex is formed in situ or wherein the intermetallic complex is formed ex situ.

21. (canceled)

22. The method of claim 20, wherein when the intermetallic complex is formed in situ, the method further comprises applying pressure to an intermetallic precursor disposed on the first substrate,
wherein the intermetallic precursor comprises one or more metallic elements disposed on a separator, and
wherein the method further comprises removing the separator before disposing the second substrate.

23. (canceled)

24. (canceled)

25. (canceled)

26. The method of claim 20, wherein the method further comprises disposing a third substrate onto the first substrate or disposing a third substrate onto the second substrate.

27. (canceled)

28. (canceled)

29. The method of claim 22, wherein the one or more metallic elements chalcogens, chalcogenides, transition metals, semiconductors, halogens, cluster cations, cluster anions, polyatomic ions, hydrides, borohydrides, super-atomic cluster anions (SACA), cluster substituted sulfides, intermetallics, including BF₄, BH₄, F, Cl, Br, Te, Se, Bi, Sn, Sb, Pb, Al, or Ge, Ag, Cu₂Te, or a combinations thereof, wherein the one or more metallic elements have a thickness of about 1 nanometer to about 500 nanometers when disposed on the separator.

30. The method of claim 22, wherein the separator is a polypropylene separator, nylon, cellulose base, or any combination thereof.

31. The method of claim 22, wherein the intermetallic precursor comprises about 0.0001 mg/cm² to about 1000 mg/cm² of the one or more metallic elements disposed on the separator.

32. (canceled)

33. The method of claim 31, wherein the intermetallic precursor comprises at least one monolayer of the one or more metallic elements or wherein the intermetallic precursor comprises a plurality of layers of the one or more metallic elements.

34. (canceled)

35. (canceled)

36. The method of claim 26, wherein
the first substrate is a solid-state electrolyte, the second substrate is a cathode, and third substrate is an anode; or wherein
the first substrate is a solid-state electrolyte, the second substrate is an anode, and the third substrate is a cathode, or wherein
the first substrate is an anode, the second substrate is a solid-state electrolyte, and the third substrate is a cathode, or wherein
the first substrate is a cathode, the second substrate is a solid-state electrolyte, and third substrate is an anode.

37.-43. (canceled)

44. The method of claim 36, wherein the cathode comprises copper, carbon, graphite, sodium, potassium, lithium, magnesium, calcium, aluminum, layered oxides, vanadium-based cathode, sulfur-based cathode, spinels, olivines, or any combination thereof.

45. An electrochemical cell, comprising:
a first substrate comprising a conductive metal;
a solid-state electrolyte comprising one or more monovalent and/or multivalent metal; and
an intermetallic bilayer disposed between the first substrate and the solid-state electrolyte, wherein the intermetallic bilayer comprises a first metallic layer comprising a first metal, and a second metallic layer comprising a second metal;
wherein the first metallic layer is adjacent to the first substrate and is disposed between the first substrate and the second metallic layer.

46. The electrochemical cell of claim 45, wherein the conductive metal comprises copper, silver, gold, iron, steel, including stainless steel, platinum, lithium, aluminum, or a combination thereof, wherein the first metal comprises tungsten, and wherein the second metal comprises magnesium, gold, silver, aluminum, platinum, zinc, tin, copper, nickel, titanium, or a combination thereof.

47.-63. (canceled)
